(19) United States
(12) Patent Application Publication
(10) Pub. No.: US 2014/0024795 A1
(43) Pub. Date: Jan. 23, 2014

(54) ALIPHATIC POLYCARBONATE POLYOLS CONTAINING SILYL GROUPS

(71) Applicant: Novomer, Inc., (US)

(72) Inventors: Scott D. Allen, Ithaca, NY (US); Wayne Willkomm, Erie, CO (US); Ray Scott, Blacksburg, VA (US)

(73) Assignee: Novomer, Inc., Ithaca, NY (US)

(21) Appl. No.: 13/870,749

(22) Filed: Apr. 25, 2013

Related U.S. Application Data
(60) Provisional application No. 61/637,889, filed on Apr. 25, 2012.

(51) Int. Cl. C08G 18/38

(52) U.S. Cl. CPC C08G 18/3893
USPC 528/29; 556/420

(57) ABSTRACT

In one aspect, the present invention pertains to novel silyl polyurethane (SPUR) compositions incorporating aliphatic polycarbonate polyols, as well as methods of making, formulating and using these novel materials. Also provided are films and higher polymers made from the novel SPUR compositions, as well as articles coated with, made from, or incorporating these compositions.

### CROSS REFERENCE TO RELATED APPLICATIONS

This application claims priority to U.S. Application Ser. 61/637,889 filed Apr. 25, 2012, the entirety of which is hereby incorporated by reference.

### GOVERNMENT SUPPORT

The invention was made in part with United States Government support under grants DE-FE0002474 awarded by the Department of Energy. The United States Government has certain rights in the invention.

### FIELD OF THE INVENTION

This invention pertains to novel silyl polyurethane (SPUR) compositions incorporating aliphatic polycarbonate polyols, as well as methods of making, formulating and using these novel materials. Also provided are films and higher polymers made from the novel SPUR compositions, as well as articles coated with, made from, or incorporating these compositions.

### SUMMARY OF THE INVENTION

Silane-terminated polyurethane (SPUR) systems have recently emerged as an alternative to polyurethane formulations containing isocyanate functionality which have known toxicity and reactivity hazards. SPUR-based formulations can be used in many industrial applications such as adhesives; glass fiber sizing; caulks, sealents, paints, coatings; foams, elastomers and other applications.

The recognition that carbon dioxide is a potential atmospheric pollutant and that rising levels of atmospheric carbon dioxide can cause global climate change has prompted a search for materials whose production, use, and disposal release less carbon dioxide than current processes. Recently, Novomer has developed a novel process for the synthesis of low molecular weight aliphatic polycarbonate polyols from the metal-catalyzed copolymerization of carbon dioxide with epoxides. These polyols have an improved carbon footprint relative to existing materials and can be used as a polyol component in thermoset formulations.

In one aspect, the present invention encompasses silicon-containing polyurethane compositions comprising aliphatic polycarbonate polyols. In certain embodiments, the inventive compositions comprise, or are derived from prepolymers which are constructed from an aliphatic polycarbonate polyol.

In another aspect, the present invention encompasses adhesives, foams, coatings, elastomers, thermoplastics or composites derived from or containing the inventive polyurethane compositions.

In another aspect, the present invention encompasses silicon-terminated prepolymers having a plurality of epoxide-CO₂-derived polyol segments linked via urethane bonds formed from reaction with polyisocyanate compounds. Such prepolymers are useful for the formulation of compositions which cure by reaction of the siloxy groups and can be used as resins to produce coatings, adhesives, foams, thermoplastics, elastomers and the like.

In certain embodiments, the present invention encompasses silicon-terminated polyurethane chains where the chains comprise a plurality aliphatic polycarbonate polyol segments linked via reaction with a diisocyanate or a related reagent.

In certain embodiments, such polymers are derived by a reaction between a molar excess of aliphatic polycarbonate polyol with one or more diisocyanate reagents to provide a hydroxyl-terminated polyurethane prepolymer which is then end-capped by further reaction with an isocyanate reagent comprising one or more silicon-containing functional groups (for example, including, but not limited to a reagent of formula NCO-Q-Si(R^{1s})ₘ(OR^{2s})₃₋ₘ, where Q, R^{1s}, R^{2s}, and m are as defined above and in the classes and subclasses herein). In certain embodiments, such materials have a formula:

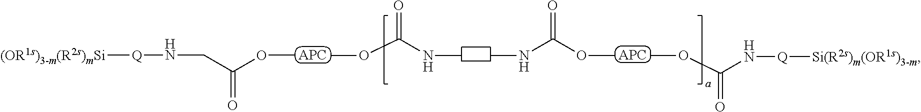

wherein each of R^{1s}, R^{2s}, Q, and m is as defined above and in the classes and subclasses herein;
Q, is a difunctional organic group; and
each

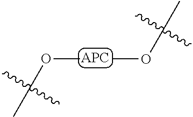

moiety has a formula:

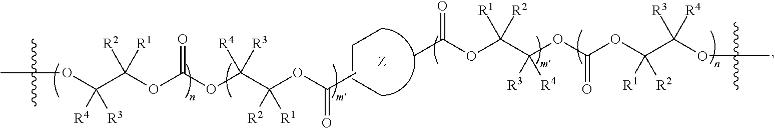

where m′ is independently at each occurrence either 0 or 1, and
each of R¹, R², R³, R⁴, [symbol] and n is as defined above and in the classes and subclasses herein;
each

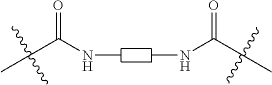

moiety is derived from a corresponding aliphatic, or aromatic diisocyanate

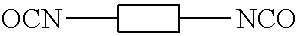

where [symbol] represents the carbon-containing skeleton of a difunctionalal isocyanate; and
α is an integer from 1 to about 50.

In other embodiments, silicon-terminated polyurethane chains can be derived by reacting a molar excess of one or more diisocyanates with polycarbonate polyol to afford isocyanate-terminated prepolymers which can then be end-capped by reaction with a silicon containing reagent containing an isocyanate-reactive functional group such as an amine, alcohol or thiol (for example, including, but not limited to a reagent of formula HNR^{z}-Q-Si(R^{1s})ₘ(OR^{2s})₃₋ₘ, where Q, R^{1s}, R^{2s}, and m are as defined above and in the classes and subclasses herein and R^{z} is as defined below). In certain embodiments, such materials have a formula selected from the group consisting of:

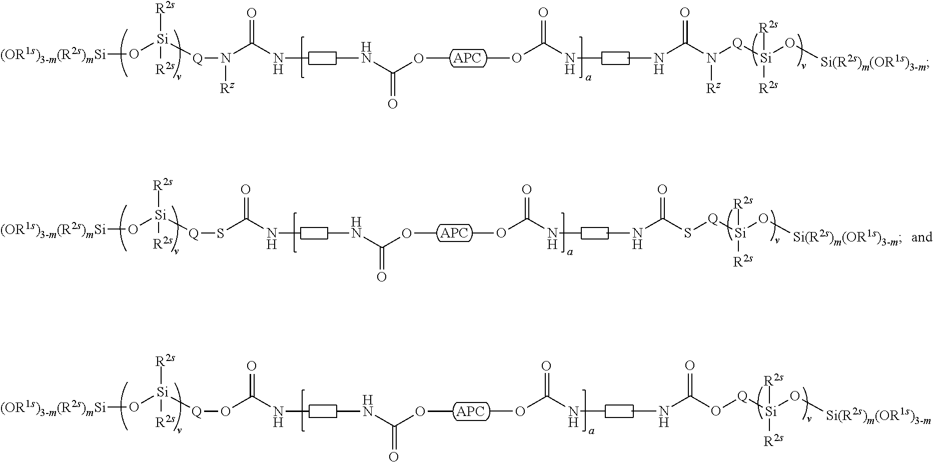

wherein each of

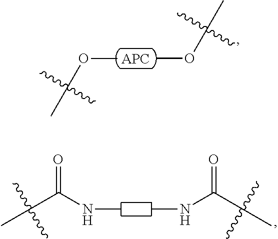

R^{1s}, R^{2s}, Q, m, and v, α is as defined above and in the classes and subclasses herein; and
R^{z} is independently at each occurrence an optionally substituted moiety selected from the group consisting of C₁₋₂₀ alkyl, and C₆₋₁₀ aryl.

In another class of silicon-terminated polymers encompassed by the present invention, two or more aliphatic polycarbonates comprising at least one —OH end group, and at least one chain end terminated with a silicon-containing functional group are linked by reaction with a polyisocyanate to provide polymers having a urethane core and silicon-containing chain ends.

In certain embodiments, such polymers have a formula:

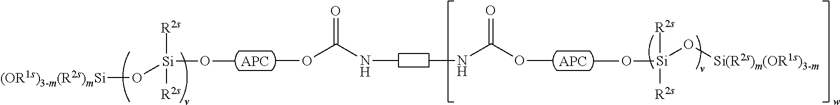

wherein each of

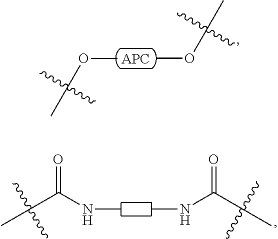

R^{1s}, R^{2s}, m, and v is as defined above and in the classes and subclasses herein; and
w is an integer from 1 to 10.

In certain embodiments, such polymers have a formula:

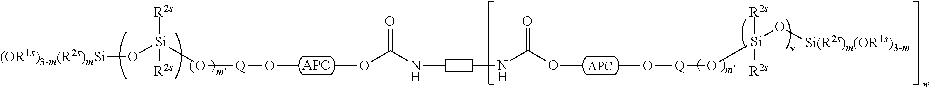

wherein each of

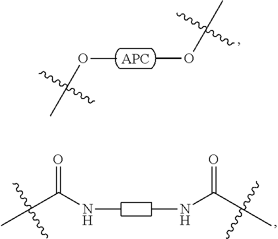

R^{1s}, R^{2s}, m, m′, w, and v is as defined above and in the classes and subclasses herein; and
w is an integer from 1 to 10.

In certain embodiments, prepolymers of the present invention incorporate additional polyols, chain extenders, and the like.

In another aspect, the present invention provides methods of preparing silicon-terminated polymers comprising aliphatic polycarbonates.

In certain embodiments, methods of the present invention comprise the steps of:
a) providing one or more aliphatic polycarbonate polyols of formula;

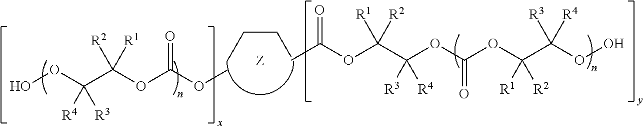

b) contacting the aliphatic polycarbonate polyol with one or more reagents having a plurality of isocyanate groups, optionally in the presence of one or more coreactants capable of reacting with isocyanate groups, where the coreactants are selected from any of those disclosed herein;
c) allowing the polyol to react with the reagent having a plurality of isocyanate groups to form a polyurethane prepolymer; and
d) contacting the resulting polyurethane prepolymer with a reagent comprising one or more silicon-containing functional groups and one or more functional groups reactive toward the polyurethane prepolymer's end groups,
wherein each of R¹, R²R³, R⁴, n, and [symbol] is as defined and described in the classes and subclasses herein;
Y is, at each occurrence, independently —H or the site of attachment to any of the chain-extending moieties described in the classes and subclasses herein; and
x and y are each independently an integer from 0 to 6, where the sum of x and y is between 2 and 6.

In certain embodiments, methods of the present invention comprise the steps of:
a) providing one or more silicon-initiated aliphatic polycarbonates selected from the group consisting of:

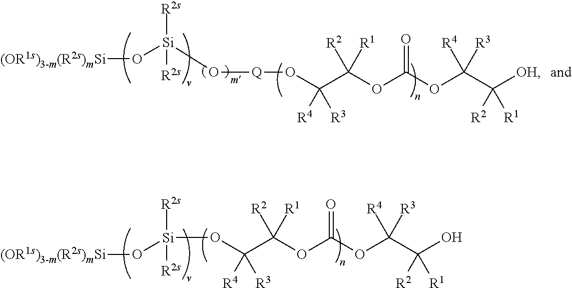

b) contacting the aliphatic polycarbonate with one or more reagents having a plurality of isocyanate groups,
   where R^{1s}, R², R³, R⁴, R^{1s}, R^{2s}, n, m, m′, and v are as defined above and described in the classes and subclasses herein

In certain embodiments, the silicon-initiated aliphatic polycarbonate provided in step (a) of this method is produced by initiating the copolymerization of one or more epoxides and CO₂ in the presence of a chain transfer agent having a formula selected from the group consisting of:

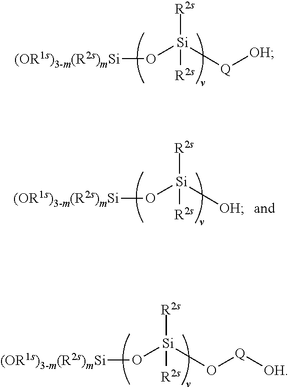

### DEFINITIONS

Definitions of specific functional groups and chemical terms are described in more detail below. For purposes of this invention, the chemical elements are identified in accordance with the Periodic Table of the Elements, CAS version, Handbook of Chemistry and Physics, 75^{th} Ed., inside cover, and specific functional groups are generally defined as described therein. Additionally, general principles of organic chemistry, as well as specific functional moieties and reactivity, are described in Organic Chemistry, Thomas Sorrell, University Science Books, Sausalito, 1999; Smith and March March's Advanced Organic Chemistry, 5^{th} Edition, John Wiley & Sons, Inc., New York, 2001; Larock, Comprehensive Organic Transformations, VCH Publishers, Inc., New York, 1989; Carruthers, Some Modern Methods of Organic Synthesis, 3^{rd} Edition, Cambridge University Press, Cambridge, 1987; the entire contents of each of which are incorporated herein by reference.

Certain compounds of the present invention can comprise one or more asymmetric centers, and thus can exist in various stereoisomeric forms, e.g., enantiomers and/or diastereomers. Thus, inventive compounds and compositions thereof may be in the form of an individual enantiomer, diastereomer or geometric isomer, or may be in the form of a mixture of stereoisomers. In certain embodiments, the compounds of the invention are enantiopure compounds. In certain embodiments, mixtures of enantiomers or diastereomers are provided.

Furthermore, certain compounds, as described herein may have one or more double bonds that can exist as either the Z or E isomer, unless otherwise indicated. The invention additionally encompasses the compounds as individual isomers substantially free of other isomers and alternatively, as mixtures of various isomers, e.g., racemic mixtures of enantiomers. In addition to the above-mentioned compounds per se, this invention also encompasses compositions comprising one or more compounds.

As used herein, the term “isomers” includes any and all geometric isomers and stereoisomers. For example, “isomers” include cis- and trans-isomers, E- and Z-isomers, R- and S-enantiomers, diastereomers, (D)-isomers, (L)-isomers, racemic mixtures thereof, and other mixtures thereof, as falling within the scope of the invention. For instance, a stereoisomer may, in some embodiments, be provided substantially free of one or more corresponding stereoisomers, and may also be referred to as “stereochemically enriched.”

Where a particular enantiomer is preferred, it may, in some embodiments be provided substantially free of the opposite enantiomer, and may also be referred to as “optically enriched.” “Optically enriched,” as used herein, means that the compound or polymer is made up of a significantly greater proportion of one enantiomer. In certain embodiments the compound is made up of at least about 90% by weight of a preferred enantiomer. In other embodiments the compound is made up of at least about 95%, 98%, or 99% by weight of a preferred enantiomer. Preferred enantiomers may be isolated from racemic mixtures by any method known to those skilled in the art, including chiral high pressure liquid chromatography (HPLC) and the formation and crystallization of chiral salts or prepared by asymmetric syntheses. See, for example, Jacques, et al., Enantiomers, Racemates and Resolutions (Wiley Interscience, New York, 1981); Wilen, S. H., et al., Tetrahedron 33:2725 (1977); Eliel, E. L. Stereochemistry of Carbon Compounds (McGraw-Hill, NY, 1962); Wilen, S. H. Tables of Resolving Agents and Optical Resolutions p. 268 (E. L. Eliel, Ed., Univ. of Notre Dame Press, Notre Dame, Ind. 1972).

The term “epoxide”, as used herein, refers to a substituted or unsubstituted oxirane. Such substituted oxiranes include monosubstituted oxiranes, disubstituted oxiranes, trisubstituted oxiranes, and tetrasubstituted oxiranes. Such epoxides may be further optionally substituted as defined herein. In certain embodiments, epoxides comprise a single oxirane moiety. In certain embodiments, epoxides comprise two or more oxirane moieties.

The term “polymer”, as used herein, refers to a molecule of high relative molecular mass, the structure of which comprises the multiple repetition of units derived, actually or conceptually, from molecules of low relative molecular mass. In certain embodiments, a polymer is comprised of substantially alternating units derived from CO₂ and an epoxide (e.g., poly(ethylene carbonate). In certain embodiments, a polymer of the present invention is a copolymer, terpolymer, heteropolymer, block copolymer, or tapered heteropolymer incorporating two or more different epoxide monomers. With respect to the structural depiction of such higher polymers, the convention of showing enchainment of different monomer units or polymer blocks separated by a slash may be used herein:

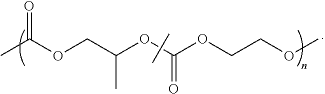

These structures are to be interpreted to encompass copolymers incorporating any ratio of the different monomer units depicted unless otherwise specified. This depiction is also meant to represent random, tapered, block co-polymers, and combinations of any two or more of these and all of these are implied unless otherwise specified.

The terms “halo” and “halogen” as used herein refer to an atom selected from fluorine (fluoro, —F), chlorine (chloro, —Cl), bromine (bromo, —Br), and iodine (iodo, —I).

The term “aliphatic” or “aliphatic group”, as used herein, denotes a hydrocarbon moiety that may be straight-chain (i.e., unbranched), branched, or cyclic (including fused, bridging, and spiro-fused polycyclic) and may be completely saturated or may contain one or more units of unsaturation, but which is not aromatic. Unless otherwise specified, aliphatic groups contain 1-40 carbon atoms. In certain embodiments, aliphatic groups contain 1-20 carbon atoms. In certain embodiments, aliphatic groups contain 3-20 carbon atoms. In certain embodiments, aliphatic groups contain 1-12 carbon atoms.

In certain embodiments, aliphatic groups contain 1-8 carbon atoms. In certain embodiments, aliphatic groups contain 1-6 carbon atoms. In some embodiments, aliphatic groups contain 1-5 carbon atoms, in some embodiments, aliphatic groups contain 1-4 carbon atoms, in some embodiments aliphatic groups contain 1-3 carbon atoms, and in some embodiments aliphatic groups contain 1 or 2 carbon atoms. Suitable aliphatic groups include, but are not limited to, linear or branched, alkyl, alkenyl, and alkynyl groups, and hybrids thereof such as (cycloalkyl)alkyl, (cycloalkenyl)alkyl or (cycloalkyl)alkenyl.

The term “heteroaliphatic,” as used herein, refers to aliphatic groups wherein one or more carbon atoms are independently replaced by one or more atoms selected from the group consisting of oxygen, sulfur, nitrogen, or phosphorus. In certain embodiments, one to six carbon atoms are independently replaced by one or more of oxygen, sulfur, nitrogen, or phosphorus. Heteroaliphatic groups may be substituted or unsubstituted, branched or unbranched, cyclic or acyclic, and include saturated, unsaturated or partially unsaturated groups.

As used herein, the term “bivalent C₁₋₈ (or C₁₋₃) saturated or unsaturated, straight or branched, hydrocarbon chain”, refers to bivalent alkyl, alkenyl, and alkynyl, chains that are straight or branched as defined herein.

The term “unsaturated”, as used herein, means that a moiety has one or more double or triple bonds.

The terms “cycloaliphatic”, “carbocycle”, or “carbocyclic”, used alone or as part of a larger moiety, refer to a saturated or partially unsaturated cyclic aliphatic monocyclic or polycyclic ring systems, as described herein, having from 3 to 12 members, wherein the aliphatic ring system is optionally substituted as defined above and described herein.

Cycloaliphatic groups include, without limitation, cyclopropyl, cyclobutyl, cyclopentyl, cyclopentenyl, cyclohexyl, cyclohexenyl, cycloheptyl, cycloheptenyl, cyclooctyl, cyclooctenyl, norbornyl, adamantyl, and cyclooctadienyl. In some embodiments, the cycloalkyl has 3-6 carbons. The terms “cycloaliphatic”, “carbocycle” or “carbocyclic” also include aliphatic rings that are fused to one or more aromatic or nonaromatic rings, such as decahydronaphthyl or tetrahydronaphthyl, where the radical or point of attachment is on the aliphatic ring. In certain embodiments, the term “3- to 7-membered carbocycle” refers to a 3- to 7-membered saturated or partially unsaturated monocyclic carbocyclic ring. In certain embodiments, the term “3- to 8-membered carbocycle” refers to a 3- to 8-membered saturated or partially unsaturated monocyclic carbocyclic ring. In certain embodiments, the terms “3- to 14-membered carbocycle” and “C₃₋₁₄ carbocycle” refer to a 3- to 8-membered saturated or partially unsaturated monocyclic carbocyclic ring, or a 7- to 14-membered saturated or partially unsaturated polycyclic carbocyclic ring.

The term “alkyl,” as used herein, refers to saturated, straight- or branched-chain hydrocarbon radicals derived from an aliphatic moiety containing between one and six carbon atoms by removal of a single hydrogen atom. Unless otherwise specified, alkyl groups contain 1-12 carbon atoms. In certain embodiments, alkyl groups contain 1-8 carbon atoms. In certain embodiments, alkyl groups contain 1-6 carbon atoms. In some embodiments, alkyl groups contain 1-5 carbon atoms, in some embodiments, alkyl groups contain 1-4 carbon atoms, in some embodiments alkyl groups contain 1-3 carbon atoms, and in some embodiments alkyl groups contain 1-2 carbon atoms. Examples of alkyl radicals include, but are not limited to, methyl, ethyl, n-propyl, isopropyl, n-butyl, iso-butyl, sec-butyl, sec-pentyl, iso-pentyl, tert-butyl, n-pentyl, neopentyl, n-hexyl, sec-hexyl, n-heptyl, n-octyl, n-decyl, n-undecyl, dodecyl, and the like.

The term “alkenyl,” as used herein, denotes a monovalent group derived from a straight- or branched-chain aliphatic moiety having at least one carbon-carbon double bond by the removal of a single hydrogen atom. Unless otherwise specified, alkenyl groups contain 2-12 carbon atoms. In certain embodiments, alkenyl groups contain 2-8 carbon atoms. In certain embodiments, alkenyl groups contain 2-6 carbon atoms. In some embodiments, alkenyl groups contain 2-5 carbon atoms, in some embodiments, alkenyl groups contain 2-4 carbon atoms, in some embodiments alkenyl groups contain 2-3 carbon atoms, and in some embodiments alkenyl groups contain 2 carbon atoms.

Alkenyl groups include, for example, ethenyl, propenyl, butenyl, 1-methyl-2-buten-1-yl, and the like.

The term “alkynyl,” as used herein, refers to a monovalent group derived from a straight- or branched-chain aliphatic moiety having at least one carbon-carbon triple bond by the removal of a single hydrogen atom. Unless otherwise specified, alkynyl groups contain 2-12 carbon atoms. In certain embodiments, alkynyl groups contain 2-8 carbon atoms. In certain embodiments, alkynyl groups contain 2-6 carbon atoms. In some embodiments, alkynyl groups contain 2-5 carbon atoms, in some embodiments, alkynyl groups contain 2-4 carbon atoms, in some embodiments alkynyl groups contain 2-3 carbon atoms, and in some embodiments alkynyl groups contain 2 carbon atoms. Representative alkynyl groups include, but are not limited to, ethynyl, 2-propynyl (propargyl), 1-propynyl, and the like.

The term “alkoxy”, as used herein refers to an alkyl group, as previously defined, attached to the parent molecule through an oxygen atom. Examples of alkoxy, include but are not limited to, methoxy, ethoxy, propoxy, isopropoxy, n-butoxy, tert-butoxy, neopentoxy, and n-hexoxy.

The term “acyl”, as used herein, refers to a carbonyl-containing functionality, e.g., —C(═O)R′, wherein R′ is hydrogen or an optionally substituted aliphatic, heteroaliphatic, heterocyclic, aryl, heteroaryl group, or is a substituted (e.g., with hydrogen or aliphatic, heteroaliphatic, aryl, or heteroaryl moieties) oxygen or nitrogen containing functionality (e.g., forming a carboxylic acid, ester, or amide functionality). The term “acyloxy”, as used here, refers to an acyl group attached to the parent molecule through an oxygen atom.

The term “aryl” used alone or as part of a larger moiety as in “aralkyl”, “aralkoxy”, or “aryloxyalkyl”, refers to monocyclic and polycyclic ring systems having a total of five to 20 ring members, wherein at least one ring in the system is aromatic and wherein each ring in the system contains three to twelve ring members. The term “aryl” may be used interchangeably with the term “aryl ring”. In certain embodiments of the present invention, “aryl” refers to an aromatic ring system which includes, but is not limited to, phenyl, biphenyl, naphthyl, anthracyl and the like, which may bear one or more substituents. Also included within the scope of the term “aryl”, as it is used herein, is a group in which an aromatic ring is fused to one or more additional rings, such as benzofuranyl, indanyl, phthalimidyl, naphthimidyl, phenantriidinyl, or tetrahydronaphthyl, and the like. In certain embodiments, the terms “6- to 10-membered aryl” and “C₆₋₁₀ aryl” refer to a phenyl or an 8- to 10-membered polycyclic aryl ring.

The terms “heteroaryl” and “heteroar-”, used alone or as part of a larger moiety, e.g., “heteroaralkyl”, or “heteroaralkoxy”, refer to groups having 5 to 14 ring atoms, preferably 5, 6, or 9 ring atoms; having 6, 10, or 14 it electrons shared in a cyclic array; and having, in addition to carbon atoms, from one to five heteroatoms. The term “heteroatom” refers to nitrogen, oxygen, or sulfur, and includes any oxidized form of nitrogen or sulfur, and any quaternized form of a basic nitrogen. Heteroaryl groups include, without limitation, thienyl, furanyl, pyrrolyl, imidazolyl, pyrazolyl, triazolyl, tetrazolyl, oxazolyl, isoxazolyl, oxadiazolyl, thiazolyl, isothiazolyl, thiadiazolyl, pyridyl, pyridazinyl, pyrimidinyl, pyrazinyl, indolizinyl, purinyl, naphthyridinyl, benzofuranyl and pteridinyl. The terms “heteroaryl” and “heteroar-”, as used herein, also include groups in which a heteroaromatic ring is fused to one or more aryl, cycloaliphatic, or heterocyclyl rings, where the radical or point of attachment is on the heteroaromatic ring. Nonlimiting examples include indolyl, isoindolyl, benzothienyl, benzofuranyl, dibenzofuranyl, indazolyl, benzimidazolyl, benzthiazolyl, quinolyl, isoquinolyl, cinnolinyl, phthalazinyl, quinazolinyl, quinoxalinyl, 4H-quinolizinyl, carbazolyl, acridinyl, phenazinyl, phenothiazinyl, phenoxazinyl, tetrahydroquinolinyl, tetrahydroisoquinolinyl, and pyrido[2,3-b]-1,4-oxazin-3(4H)-one. A heteroaryl group may be mono- or bicyclic. The term “heteroaryl” may be used interchangeably with the terms “heteroaryl ring”, “heteroaryl group”, or “heteroaromatic”, any of which terms include rings that are optionally substituted. The term “heteroaralkyl” refers to an alkyl group substituted by a heteroaryl, wherein the alkyl and heteroaryl portions independently are optionally substituted. In certain embodiments, the term “5- to 10-membered heteroaryl” refers to a 5- to 6-membered heteroaryl ring having 1 to 3 heteroatoms independently selected from nitrogen, oxygen, or sulfur, or an 8- to 10-membered bicyclic heteroaryl ring having 1 to 4 heteroatoms independently selected from nitrogen, oxygen, or sulfur. In certain embodiments, the term “5- to 12-membered heteroaryl” refers to a 5- to 6-membered heteroaryl ring having 1 to 3 heteroatoms independently selected from nitrogen, oxygen, or sulfur, or an 8- to 12-membered bicyclic heteroaryl ring having 1 to 4 heteroatoms independently selected from nitrogen, oxygen, or sulfur.

As used herein, the terms “heterocycle”, “heterocyclyl”, “heterocyclic radical”, and “heterocyclic ring” are used interchangeably and refer to a stable 5- to 7-membered monocyclic or 7-14-membered polycyclic heterocyclic moiety that is either saturated or partially unsaturated, and having, in addition to carbon atoms, one or more, preferably one to four, heteroatoms, as defined above. When used in reference to a ring atom of a heterocycle, the term “nitrogen” includes a substituted nitrogen. As an example, in a saturated or partially unsaturated ring having 0-3 heteroatoms selected from oxygen, sulfur or nitrogen, the nitrogen may be N (as in 3,4-dihydro-2H-pyrrolyl), NH (as in pyrrolidinyl), or ⁺NR (as in N-substituted pyrrolidinyl). In some embodiments, the term “3- to 7-membered heterocyclic” refers to a 3- to 7-membered saturated or partially unsaturated monocyclic heterocyclic ring having 1 to 2 heteroatoms independently selected from nitrogen, oxygen, or sulfur. In some embodiments, the term “3- to 12-membered heterocyclic” refers to a 3- to 8-membered saturated or partially unsaturated monocyclic heterocyclic ring having 1 to 2 heteroatoms independently selected from nitrogen, oxygen, or sulfur, or a 7- to 12-membered saturated or partially unsaturated polycyclic heterocyclic ring having 1-3 heteroatoms independently selected from nitrogen, oxygen, or sulfur.

A heterocyclic ring can be attached to its pendant group at any heteroatom or carbon atom that results in a stable structure and any of the ring atoms can be optionally substituted. Examples of such saturated or partially unsaturated heterocyclic radicals include, without limitation, tetrahydrofuranyl, tetrahydrothienyl, pyrrolidinyl, pyrrolidonyl, piperidinyl, pyrrolinyl, tetrahydroquinolinyl, tetrahydroisoquinolinyl, decahydroquinolinyl, oxazolidinyl, piperazinyl, dioxanyl, dioxolanyl, diazepinyl, oxazepinyl, thiazepinyl, morpholinyl, and quinuclidinyl. The terms “heterocycle”, “heterocyclyl”, “heterocyclyl ring”, “heterocyclic group”, “heterocyclic moiety”, and “heterocyclic radical”, are used interchangeably herein, and also include groups in which a heterocyclyl ring is fused to one or more aryl, heteroaryl, or cycloaliphatic rings, such as indolinyl, 3H-indolyl, chromanyl, phenanthridinyl, or tetrahydroquinolinyl, where the radical or point of attachment is on the heterocyclyl ring. A heterocyclyl group may be mono- or bicyclic. The term “heterocyclylalkyl” refers to an alkyl group substituted by a heterocyclyl, wherein the alkyl and heterocyclyl portions independently are optionally substituted.

As used herein, the term “partially unsaturated” refers to a ring moiety that includes at least one double or triple bond. The term “partially unsaturated” is intended to encompass rings having multiple sites of unsaturation, but is not intended to include aryl or heteroaryl moieties, as herein defined.

As described herein, compounds of the invention may contain “optionally substituted” moieties. In general, the term “substituted”, whether preceded by the term “optionally” or not, means that one or more hydrogens of the designated moiety are replaced with a suitable substituent. Unless otherwise indicated, an “optionally substituted” group may have a suitable substituent at each substitutable position of the group, and when more than one position in any given structure may be substituted with more than one substituent selected from a specified group, the substituent may be either the same or different at every position. Combinations of substituents envisioned by this invention are preferably those that result in the formation of stable or chemically feasible compounds. The term “stable”, as used herein, refers to compounds that are not substantially altered when subjected to conditions to allow for their production, detection, and, in certain embodiments, their recovery, purification, and use for one or more of the purposes disclosed herein.

Suitable monovalent substituents on a substitutable carbon atom of an “optionally substituted” group are independently halogen; —(CH₂)₀₋₄R^{◯}; —(CH₂)₀₋₄OR^{◯}; —O—(CH₂)₀₋₄C(O)OR^{◯}; —(CH₂)₀₋₄CH(OR^{◯})₂; —(CH₂)₀₋₄SR^{◯}; —(CH₂)₀₋₄Ph, which may be substituted with R^{◯}; —(CH₂)₀₋₄O—(CH₂)₀₋₄Ph which may be substituted with R^{◯}; —CH═CHPh, which may be substituted with R^{◯}; —NO₂; —CN; —N₃; —(CH₂)₀₋₄N(R^{◯})₂; —(CH₂)₀₋₄N(R^{◯})C(O)R^{◯}; —N(R^{◯})C(S)R^{◯}; —(CH₂)₀₋₄N(R^{◯})C(O)NR^{◯}₂; —N(R^{◯})C(S)NR^{◯}₂; —(CH₂)₀₋₄N(R^{◯})C(O)OR^{◯}; —N(R^{◯})N(R^{◯})C(O)R^{◯}; —N(R^{◯})N(R^{◯})C(O)NR^{◯}₂; —N(R^{◯})N(R^{◯})C(O)OR^{◯}; —(CH₂)₀₋₄C(O)R^{◯}; —C(S)R; —(CH₂)₀₋₄C(O)OR; —(CH₂)₀₋₄C(O)N(R^{◯})₂; —(CH₂)₀₋₄C(O)SR^{◯}; —(CH₂)₀₋₄C(O)OSiR^{◯}₃; —(CH₂)₀₋₄OC(O)R^{◯}; —OC(O)(CH₂)₀₋₄SR—, SC(S)SR^{◯}; —(CH₂)₀₋₄SC(O)R; —(CH₂)₀₋₄C(O)NR^{◯}₂; —C(S)NR^{◯}₂; —C(S)SR^{◯}; —SC(S)SR^{◯}, —(CH₂)₀₋₄OC(O)NR^{◯}₂; —C(O)N(OR^{◯})R^{◯}; —C(O)C(O)R^{◯}; —C(O)CH₂C(O)R; —C(NOR)R^{◯}; —(CH₂)₀₋₄SSR; —(CH₂)₀₋₄S(O)₂R^{◯}; —(CH₂)₀₋₄S(O)₂OR^{◯}; —(CH₂)₀₋₄OS(O)₂R^{◯}; —S(O)₂NR^{◯}₂; —(CH₂)₀₋₄S(O)R^{◯}; —N(R^{◯})S(O)₂NR^{◯}₂; —N(R^{◯})S(O)₂R^{◯}; —N(OR^{◯})R^{◯}; —C(NH)NR^{◯}₂; —P(O)₂R^{◯}; —P(O)R^{◯}₂; —OP(O)R^{◯}₂; —OP(O)(OR^{◯})₂; SiR^{◯}₃; —(C₁₋₄ straight or branched alkylene)O—N(R^{◯})₂; or —(C₁₋₄ straight or branched alkylene)C(O)O—N(R^{◯})₂, wherein each R^{◯} may be substituted as defined below and is independently hydrogen, C₁₋₈ aliphatic, —CH₂Ph, —O(CH₂)₀₋₁Ph, or a 5-6-membered saturated, partially unsaturated, or aryl ring having 0-4 heteroatoms independently selected from nitrogen, oxygen, or sulfur, or, notwithstanding the definition above, two independent occurrences of R^{◯}, taken together with their intervening atom(s), form a 3-12-membered saturated, partially unsaturated, or aryl mono- or polycyclic ring having 0-4 heteroatoms independently selected from nitrogen, oxygen, or sulfur, which may be substituted as defined below.

Suitable monovalent substituents on R^{◯} (or the ring formed by taking two independent occurrences of R^{◯} together with their intervening atoms), are independently halogen, —(CH₂)₀₋₂R^{}, -(haloR^{}), —(CH₂)₀₋₂OH, —(CH₂)₀₋₂OR^{}, —(CH₂)₀₋₂CH(OR)₂; —O(haloR^{}), —CN, —N₃, —(CH₂)₀₋₂C(O)R^{}, —(CH₂)₀₋₂C(O)OH, —(CH₂)₀₋₂C(O)OR, —(CH₂)₀₋₄C(O)N(R^{◯}^{})₂; —(CH₂)₀₋₂SR^{}, —(CH₂)₀₋₂SH, —(CH₂)₀₋₂NH₂, —(CH₂)₀₋₂NHR^{}, —(CH₂)₀₋₂NR^{}₁₂, —NO₂, —SiR^{}₃, —OSiR^{}₃, —C(O)SR^{}, —(C₁₋₄ straight or branched alkylene)C(O)OR^{}, or —SSR^{} wherein each R^{} is unsubstituted or where preceded by “halo” is substituted only with one or more halogens, and is independently selected from C₁₋₄ aliphatic, —CH₂Ph, —O(CH₂)₀₋₁Ph, or a 5-6-membered saturated, partially unsaturated, or aryl ring having 0-4 heteroatoms independently selected from nitrogen, oxygen, or sulfur. Suitable divalent substituents on a saturated carbon atom of R^{◯} include ═O and ═S.

Suitable divalent substituents on a saturated carbon atom of an “optionally substituted” group include the following: ═O, ═S, ═NNR*₂, ═NNHC(O)R*, ═NNHC(O)OR*, ═NNHS(O)₂R*, ═NR*, ═NOR*, —O(C(R*₂))₂₋₃O—, or —S(C(R*₂))₂₋₃S—, wherein each independent occurrence of R* is selected from hydrogen, C₁ aliphatic which may be substituted as defined below, or an unsubstituted 5-6-membered saturated, partially unsaturated, or aryl ring having 0-4 heteroatoms independently selected from nitrogen, oxygen, or sulfur. Suitable divalent substituents that are bound to vicinal substitutable carbons of an “optionally substituted” group include: —O(CR*₂)₂₋₃O—, wherein each independent occurrence of R* is selected from hydrogen, C₁ aliphatic which may be substituted as defined below, or an unsubstituted 5-6-membered saturated, partially unsaturated, or aryl ring having 0-4 heteroatoms independently selected from nitrogen, oxygen, or sulfur.

Suitable substituents on the aliphatic group of R* include halogen, —R^{}, -(haloR^{}), —OH, —OR^{}, —O(haloR^{}), —CN, —C(O)OH, —C(O)OR^{}, —NH₂, —NHR^{}, —NR^{}₂, or —NO₂, wherein each R^{} is unsubstituted or where preceded by “halo” is substituted only with one or more halogens, and is independently C₁₋₄ aliphatic, —CH₂Ph, —O(CH₂)₀₋₁Ph, or a 5-6-membered saturated, partially unsaturated, or aryl ring having 0-4 heteroatoms independently selected from nitrogen, oxygen, or sulfur.

Suitable substituents on a substitutable nitrogen of an “optionally substituted” group include —R^{†}, —NR^{†}₂, —C(O)R^{†}, —C(O)OR^{†}, —C(O)C(O)R^{†}, —C(O)CH₂C(O)R^{†}, S(O)₂R^{†}, —S(O)₂NR^{†}₂, —C(S)NR^{†}₂, —C(NH)NR^{†}₂, or —N(R^{†})S(O)₂Rt; wherein each R^{†} is independently hydrogen, C₁₋₆ aliphatic which may be substituted as defined below, unsubstituted —OPh, or an unsubstituted 5-6-membered saturated, partially unsaturated, or aryl ring having 0-4 heteroatoms independently selected from nitrogen, oxygen, or sulfur, or, notwithstanding the definition above, two independent occurrences of R^{†}, taken together with their intervening atom(s) form an unsubstituted 3-12-membered saturated, partially unsaturated, or aryl mono- or bicyclic ring having 0-4 heteroatoms independently selected from nitrogen, oxygen, or sulfur.

Suitable substituents on the aliphatic group of R^{†} are independently halogen, —R^{}, -(haloR^{}), —OH, —OR^{}, —O(haloR^{}), —CN, —C(O)OH, —C(O)OR^{}, —NH₂, —NHR^{s—, —NR}^{}₂, or —NO₂, wherein each R^{◯} is unsubstituted or where preceded by “halo” is substituted only with one or more halogens, and is independently C₁₋₄ aliphatic, —CH₂Ph, —O(CH₂)₀₋₁Ph, or a 5-6-membered saturated, partially unsaturated, or aryl ring having 0-4 heteroatoms independently selected from nitrogen, oxygen, or sulfur.

When substituents are described herein, the term “radical” or “optionally substituted radical” is sometimes used. In this context, “radical” means a moiety or functional group having an available position for attachment to the structure on which the substituent is bound. In general the point of attachment would bear a hydrogen atom if the substituent were an independent neutral molecule rather than a substituent. The terms “radical” or “optionally-substituted radical” in this context are thus interchangeable with “group” or “optionally-substituted group”.

As used herein, the “term head-to-tail” or “HT”, refers to the regiochemistry of adjacent repeating units in a polymer chain. For example, in the context of poly(propylene carbonate) (PPC), the term head-to-tail is based on the three regiochemical possibilities depicted below:

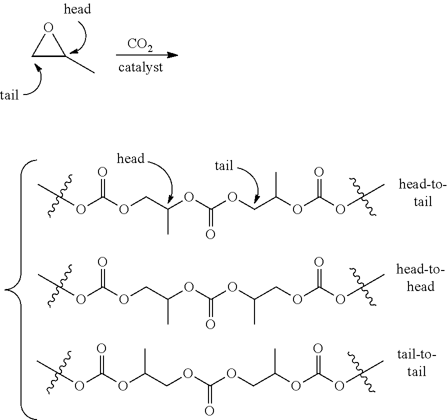

The term head-to-tail ratio (H:T) refers to the proportion of head-to-tail linkages to the sum of all other regiochemical possibilities. With respect to the depiction of polymer structures, while a specific regiochemical orientation of monomer units may be shown in the representations of polymer structures herein, this is not intended to limit the polymer structures to the regiochemical arrangement shown but is to be interpreted to encompass all regiochemical arrangements including that depicted, the opposite regiochemistry, random mixtures, isotactic materials, syndiotactic materials, racemic materials, and/or enantioenriched materials and combinations of any of these unless otherwise specified.

As used herein the term “alkoxylated” means that one or more functional groups on a molecule (usually the functional group is an alcohol, amine, or carboxylic acid, but is not strictly limited to these) has appended to it a hydroxy-terminated alkyl chain.

Alkoxylated compounds may comprise a single alkyl group or they may be oligomeric moieties such as hydroxyl-terminated polyethers. Alkoxylated materials can be derived from the parent compounds by treatment of the functional groups with epoxides.

Unless otherwise specified, “a,” “an,” “the,” and “at least one” are used interchangeably and mean one or more than one.

### DETAILED DESCRIPTION OF CERTAIN EMBODIMENTS

The present invention provides, among other things, novel silicon-terminated polymeric materials. All of these materials comprise aliphatic polycarbonate chains having repeat units conforming to the formula:

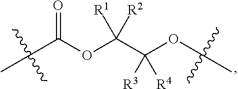

where R¹, R², R³, and R⁴ are, at each occurrence in the polymer chain, independently selected from the group consisting of —H, fluorine, an optionally substituted C₁₋₄₀ aliphatic group, an optionally substituted C₁₋₂₀ heteroaliphatic group, and an optionally substituted aryl group, where any two or more of R¹, R², R³, and R⁴ may optionally be taken together with intervening atoms to form one or more optionally substituted rings optionally containing one or more heteroatoms.

In certain embodiments, the aliphatic polycarbonate chains of the invention incorporate copolymers derived from one or more epoxides and carbon dioxide. In certain embodiments, the copolymers are derived from ethylene oxide, propylene oxide, 1,2 butene oxide, 1,2 hexene oxide, oxides of higer alpha olefins (e.g. C₆₋₄₀ alpha olefins), butadiene monoepoxide, epichlorohydrin, ethers or esters of glycidol, cyclopentene oxide, cyclohexene oxide, 3 vinyl cyclohexene oxide, 3-ethyl cyclohexene oxide, and combinations of any two or more of these.

In certain embodiments, the aliphatic polycarbonate chains of the invention incorporate copolymers derived from propylene oxide. In certain embodiments, the aliphatic polycarbonate chains of the invention incorporate copolymers derived from propylene oxide and one or more additional epoxides. In certain embodiments, the aliphatic polycarbonate chains of the invention incorporate copolymers derived from ethylene oxide. In certain embodiments, the aliphatic polycarbonate chains of the invention incorporate copolymers derived from ethylene oxide and one or more additional epoxides.

In one embodiment, compositions of the present invention comprise polymers of formula:

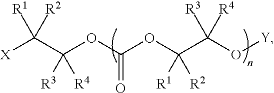

where R¹, R², R³, and R⁴ are, at each occurrence in the polymer chain, independently selected from the group consisting of —H, fluorine, an optionally substituted C₁₋₃₀ aliphatic group, an optionally substituted C₁₋₂₀ heteroaliphatic group, and an optionally substituted C₆₋₁₀ aryl group, where any two or more of R¹, R², R³, and R⁴ may optionally be taken together with intervening atoms to form one or more optionally substituted rings optionally containing one or more heteroatoms;

n is, independently at each occurrence, an integer from about 2 to about 200;

Y comprises a silicon-containing functional group; and

X is the bound form of any nucleophile that can ring-open an epoxide.

In another embodiment, silicon-terminated polymeric materials encompassed by the present invention comprise an aliphatic polycarbonate core with two or more chain ends comprising silicon-containing functional groups. In certain embodiments, such materials have a formula P1.

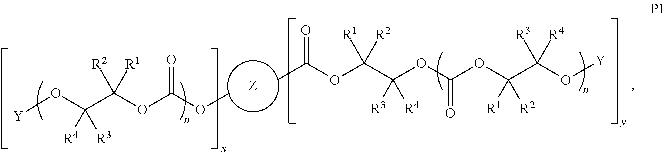

Where each of R¹, R², R³, R⁴, n, and Y are as defined above and in the classes and subclasses herein,
[symbol] is a multivalent moiety; and
x and y are each independently an integer from 0 to 6, where the sum of x and y is between 2 and 6.

Another class of silicon-terminated polymeric materials encompassed by the present invention comprise a plurality of aliphatic polycarbonate segments linked by urethane bonds. These materials are further differentiated by the disposition of the urethane linkages with respect to the polycarbonate segments. A first category comprises repeating polycarbonate segments coupled by urethane linkages, while a second category comprises a central core derived from a polyisocyanate from which a plurality of aliphatic polycarbonate chains radiate. Put another way: in the former, at least a portion of polycarbonate segments are embedded within the polymer backbone with urethane linkages present at each end of the polycarbonate segment, while in the latter each polycarbonate segment comprises a terminus comprising a silicon-containing functional group and a urethane linkage to a central polyisocyanate-derived core:

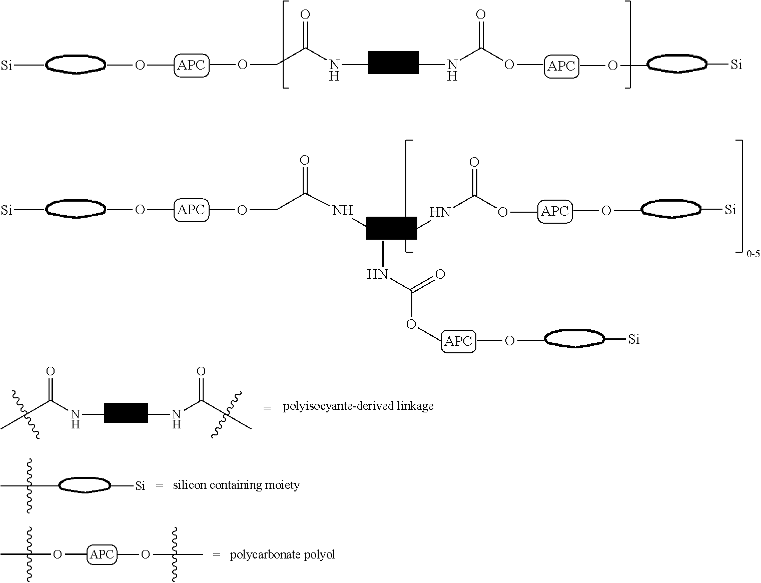

Before more fully describing and exemplifying each of these classes of novel materials, it is important to note that there is a large diversity of precursors useful for their production. In some embodiments, the inventive compositions are the result of a combination of several components each of which may be chosen from a diverse array of possibilities. The combinatorial array arising from such combinations encompasses a vast number of novel compositions. It is impractical to explicitly list every such combination. Therefore, in order to more fully and clearly demonstrate the range of these possibilities and the scope of the present invention, Appendices I-III are provided as part of the specification. Appendix I describes aliphatic polycarbonate polyols that have utility practicing certain embodiments of the invention. Similarly, Appendices II and III describe, respectively, isocyanates and coreactants that have utility for certain embodiments of the invention.

### I. Silyl-Terminated Polycarbonate Compositions

In one aspect, the present invention encompasses novel compositions of matter comprising silyl-terminated aliphatic polycarbonate polymers. In certain embodiments, such materials are useful for the production of higher polymers through the formation of siloxy linkages with themselves, with other multifunctional compounds or with other reactive silane compounds in a formulation.

In certain embodiments, silyl-terminated aliphatic polycarbonate polymers of the present invention have a formula ST-1:

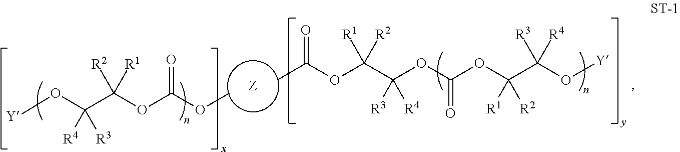

wherein R¹, R², R³, and R⁴ are, at each occurrence in the polymer chain, independently selected from the group consisting of —H, fluorine, an optionally substituted C₁₋₃₀ aliphatic group, and an optionally substituted C₁₋₂₀ heteroaliphatic group, and an optionally substituted C₆₋₁₀ aryl group, where any two or more of R¹, R², R³, and R⁴ may optionally be taken together with intervening atoms to form one or more optionally substituted rings optionally containing one or more heteroatoms and/or one or more sites of unsaturation;
Y′ is, at each occurrence, a moiety comprising at least one urethane linkage and at least one silicon-containing functional group
n is an integer from about 2 to about 100;
[symbol] is a bond or a multivalent moiety; and
x and y are each independently an integer from 0 to 6, where the sum of x and y is between 2 and 6.

In certain embodiments, for polycarbonates of formula ST-1, a silicon-containing functional group in Y′ comprises:

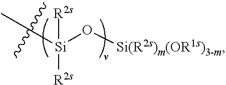

where each R^{1s} is independently H, optionally substituted C₁₋₆ aliphatic, or optionally substituted phenyl;
each R^{2s} is independently a C₁₋₆ aliphatic group,
m is 0, 1, or 2, and
v is 0 or an integer from 1 to about 20;

In certain embodiments, for polycarbonates of formula ST-1, each Y′ comprises a moiety of the formula:

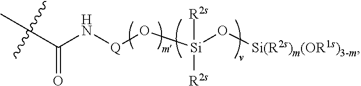

where each of R^{1s}, R^{2s}, m, and v is as defined above and in the classes and subclasses herein,
m′ is 0 or 1, and
Q is an optionally substituted bifunctional C₁₋₂₀ aliphatic or heteroaliphatic group.

In certain embodiments, each Y′ comprises a moiety of the formula:

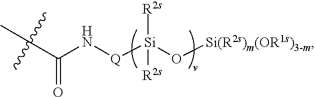

where each of Q, R^{1s}, R^{2s}, m, and v is as defined above and in the classes and subclasses herein.

In certain embodiments, for polycarbonates of formula ST-1, each Y′ comprises a moiety of the formula:

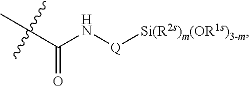

where each of Q, R^{1s}, R^{2s}, and m is as defined above and in the classes and subclasses herein.

In certain embodiments, for polycarbonates of formula ST-1, each Y′ comprises a moiety of the formula:

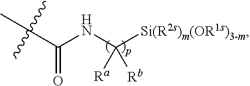

where each of R^{1s}, R^{2s}, and m is as defined above and in the classes and subclasses herein,

each R^{a} and R^{b} are independently selected from the group consisting of: —H, halogen, optionally substituted C₁₋₈ aliphatic, optionally substituted C₁₋₈ heteroaliphatic, —OR^{x}, where two or more R^{a} and/or R^{b} groups (whether on the same or different carbon atoms) may be taken together with intervening atoms to form one or more optionally substituted, optionally unsaturated rings, optionally containing one or more heteroatoms, and where two R^{a} and R^{b} groups on the same carbon atom or on adjacent carbon atoms may optionally be taken together to form an alkene or, if on the same carbon atom, a ketone, and
p is an integer from 1 to 10.

In certain embodiments, for polycarbonates of formula ST-1, each Y′ comprises a moiety of the formula:

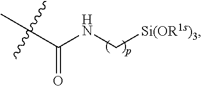

where R^{1s} and p are as defined above and in the classes and subclasses herein.

In certain embodiments, for polycarbonates of formula ST-1, each Y′ group is independently selected from the group consisting of:

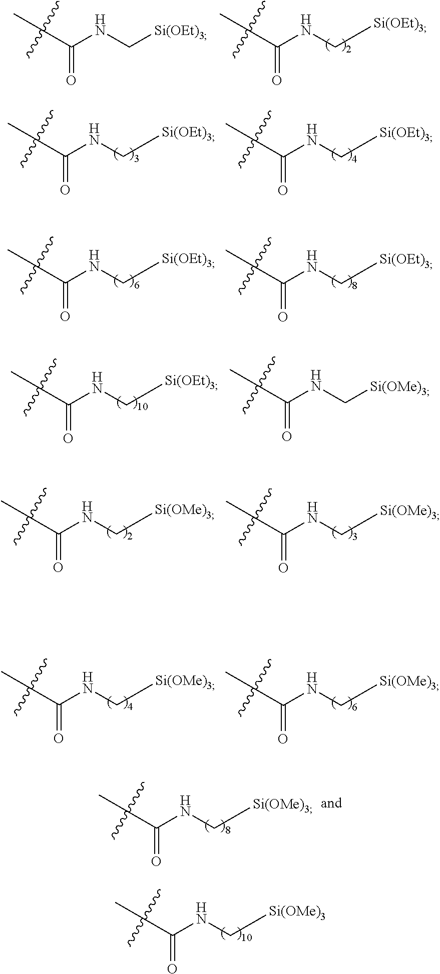

In certain embodiments, for polycarbonates of formula ST-1, each Y′ group is independently selected from the group consisting of:

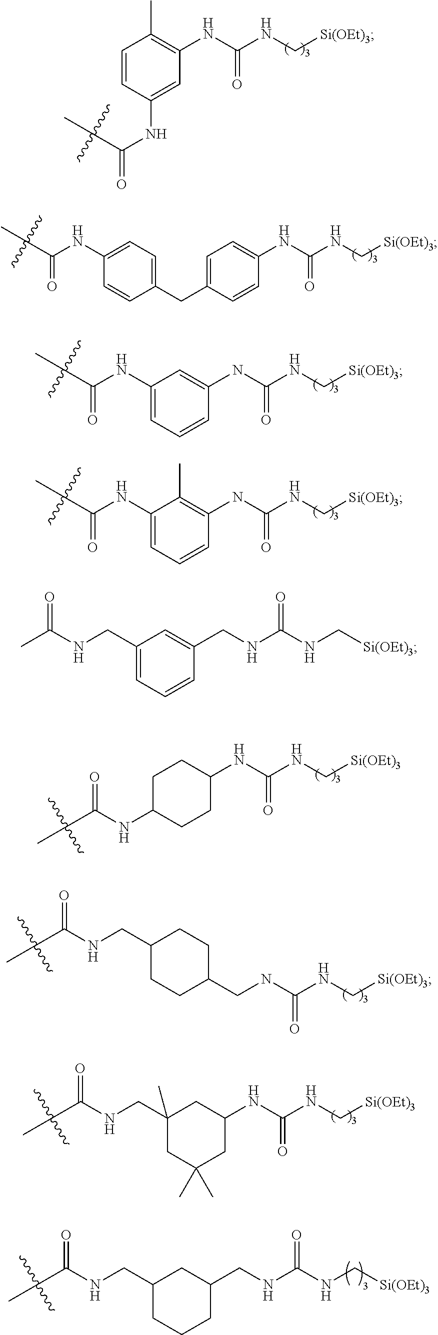

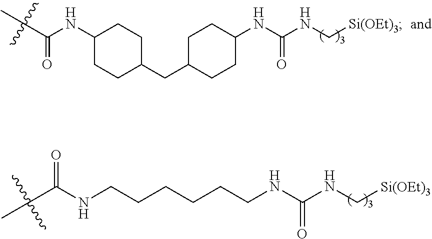

In certain embodiments, for polycarbonates of formula ST-1, each Y′ group is independently selected from the group consisting of:

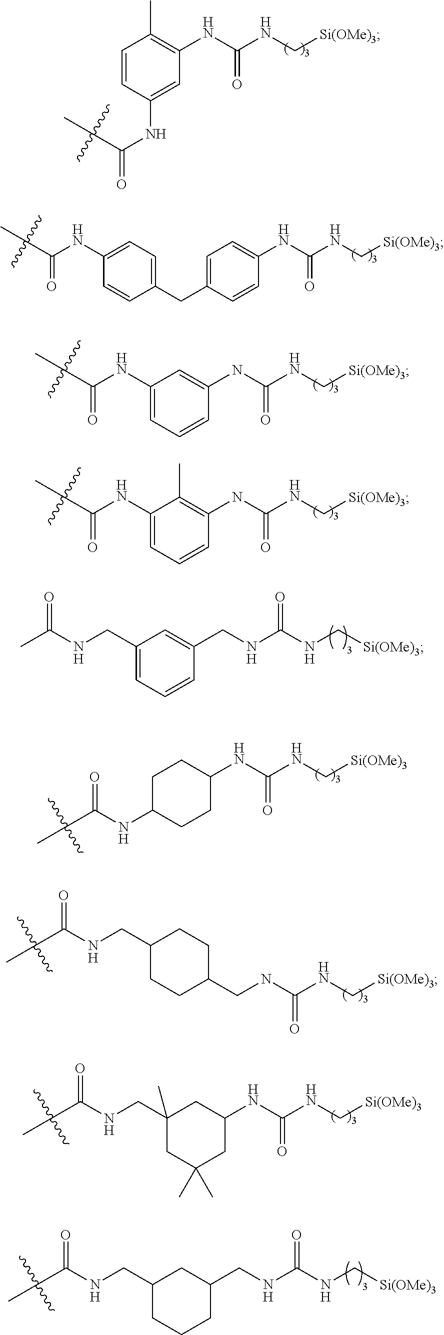

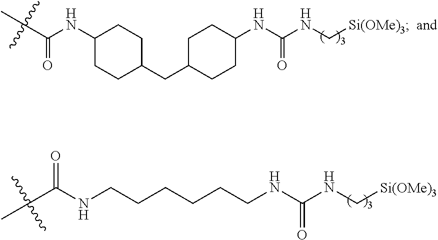

In certain embodiments, for polymers of Formula ST-1, the sum of x and y is 2 (e.g. the polymer is bifunctional). In certain embodiments, x is 2 and y is 0, while in other embodiments, x is 0 and y is 2.

In certain embodiments, silyl-terminated aliphatic polycarbonate polymers described above are derived from a polycarbonate polyol of formula P1-OH by end-capping with a suitable reagent containing a reactive isocyanate and a silicon-containing functional group. In certain embodiments, such reactions conform to the Scheme shown below:

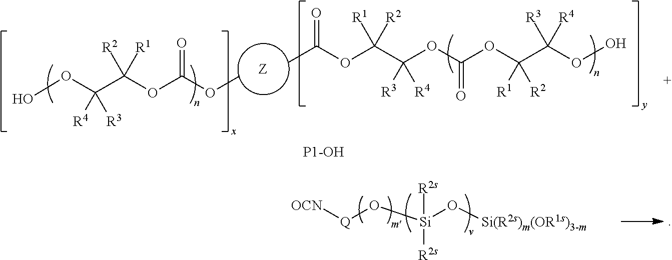

II. Silyl-Terminated Polycarbonate Compositions with Urethane Cores

In another aspect, the present invention encompasses novel compositions of matter comprising silyl-terminated aliphatic polycarbonate polymers containing a urethane core structure. In certain embodiments, such materials are useful for the production of higher polymers through the formation of siloxy linkages with themselves or with other compounds in a formulation.

In certain embodiments, silyl-terminated aliphatic polycarbonate polymers of the present invention have a formula

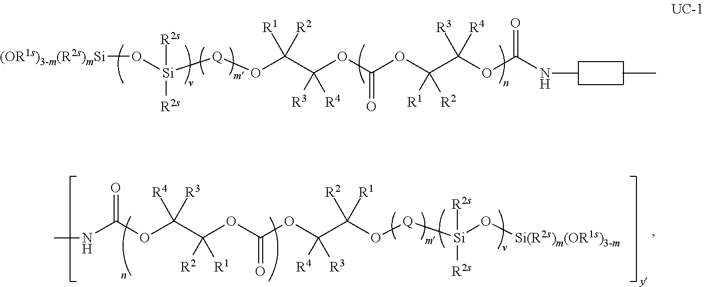

wherein each of Q, R^{1s}, R^{2s}, R¹, R², R³, R⁴, m, and v is as defined above and in the classes and subclasses herein;
m′ is 0 or 1;
the moiety

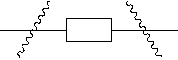

represents a multivalent carbon-containing backbone derived from a polyisocyanate (e.g. if 2,4-TDI were the polyisocyanate used to make a polymer of formula UC-1, then

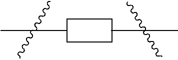

would represent the moiety,

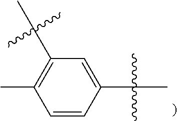 [SMILES: *c1ccc(C)c(*)c1]

such polyisocyanates may be simple isocyanates or polymeric materials (e.g. in the case of an oligomeric diisocyanate, UC-1 would represent an A-B-A triblock copolymer); and
y′ is an integer from 1 to 6.

### III. Silyl-Terminated Polycarbonate Urethane Prepolymers

As mentioned above, in one aspect, the present invention encompasses silicon-terminated prepolymers incorporating a plurality of epoxide-CO₂-derived polyol segments connected by urethane linkages. In certain embodiments, these materials are substantially linear oligomers comprising two or more polyol segments.

In certain embodiments, the invention encompasses siloxy-terminated prepolymers having a formula PH-1:

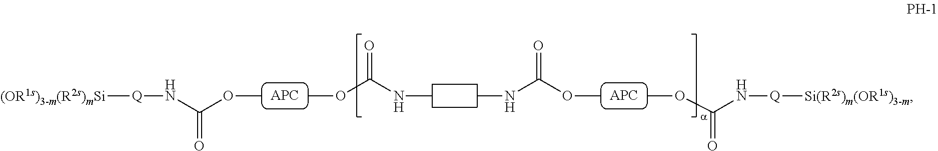

wherein R^{1s} is independently at each occurrence selected from the group consisting of: —H, C₁₋₆ aliphatic, and optionally substituted phenyl;
R^{2s} is, at each occurrence, a C₁₋₆ aliphatic group and each R^{2s} may be the same or different;
Q, is a difunctional organic group; and
m is 0, 1, or 2;
α is an integer from 1 to about 50;
each

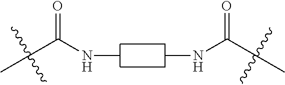

moiety is derived from a corresponding aliphatic, or aromatic diisocyanate

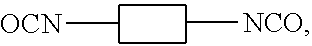

where [symbol] represents the carbon-containing skeleton of a difunctionalal isocyanate;
each

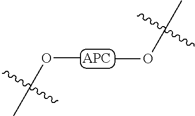

moiety has a formula:

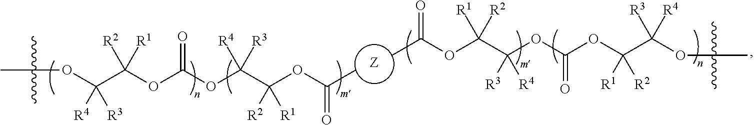

where m∝ is independently at each occurrence either 0 or 1,
R¹, R², R³, and R⁴ are, at each occurrence in the polymer chain, independently selected from the group consisting of —H, fluorine, an optionally substituted C₁₋₃₀ aliphatic group, an optionally substituted C₁₋₂₀ heteroaliphatic group, and an optionally substituted C₆₋₁₀ aryl group, where any two or more of R¹, R², R³, and R⁴ may optionally be taken together with intervening atoms to form one or more optionally substituted rings optionally containing one or more heteroatoms;
   n is, independently at each occurrence, an integer from about 2 to about 200; and
   [symbol] is a bond or a multivalent moiety.

In certain embodiments, compounds of formula PH-1, can be produced by treating a hydroxyl-terminated polyurethane prepolymer with a reagent comprising an isocyanate and one or more silicon-containing functional groups. In certain embodiments, materials of this class are formed by reaction of a hydroxyl-terminated prepolymer of formula:

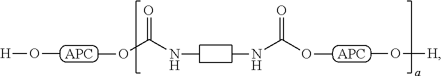

with a silyl isocyanate of formula

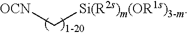

In certain embodiments, the silyl isocyanate is selected from (MeO)₃Si—CH₂CH₂CH₂—OCN and (EtO)₃Si—CH₂CH₂CH₂—OCN.

Suitable hydroxyl-terminated prepolymers can be synthesized by reacting an excess of polycarbonate polyol with a limiting amount of a diisocyanate. In certain embodiments, such a method conforms to Scheme 2:

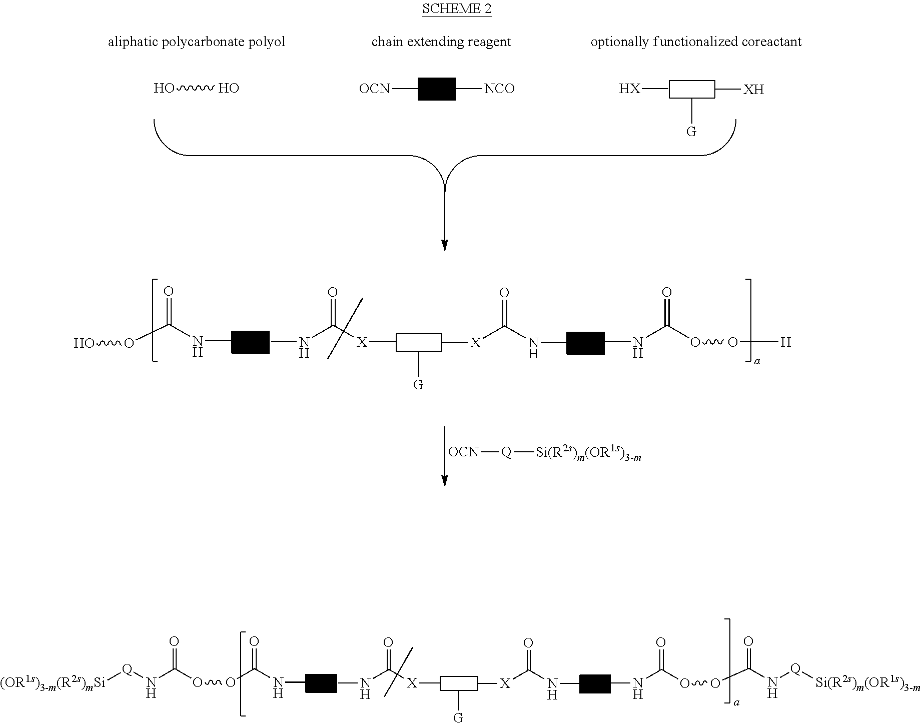

With respect to the optional coreactant in Scheme 2, each —XH represents a functional group on the coreactant capable of reacting with an isocyanate group (for example —OH, —NHR, —SH, etc.), and -G represents an optionally present hydrophilic functional group, a cross-linkable functional group or a precursor thereof. Such -G groups may be incorporated to facilitate cross-linking, aid in formation of aqueous dispersions, or modification of the physical properties of the polymers. The coreactant itself may be any of those described herein or in Appendix III.

As depicted in Scheme 2, the reaction of the chain extending reagent

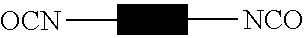

with the —OH groups of the aliphatic polycarbonate polyol and, if present, the —XH groups on the coreactant, leads to an oligomeric prepolymer composition having a plurality of segments joined by urethane (carbamate), urea, or thiocarbamate linkages.

Each prepolymer chain resulting from this reaction may contain a variable number of polyol segments and incorporate a variable number of coreactants. The compositional abundance and average chain length of the prepolymers can be controlled using methods known in the art such as by changing the stoichiometry of the reagents and/or by modifying the reaction conditions employed. Scheme 2 therefore represents a simplification and it is to be understood that the prepolymer compositions described herein may contain a complex mixture of random copolymers comprising a statistical distribution of a vast number of chain compositions.

In other embodiments, the invention encompasses siloxy-terminated prepolymers having a formula selected from the group consisting of:

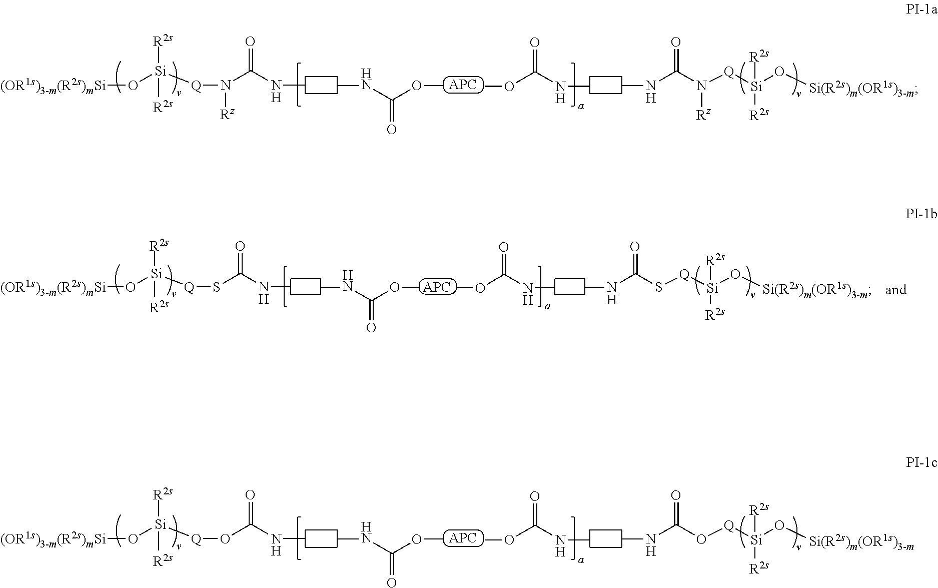

wherein each of

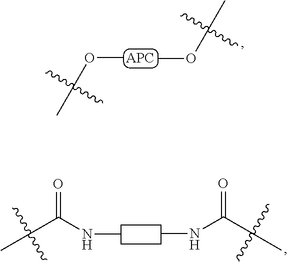

R^{1s}, R^{2s}, Q, m, v and α is as defined above and in the classes and subclasses herein; and
R^{z} is independently at each occurrence an optionally substituted moiety selected from the group consisting of C₁₋₂₀ alkyl, and C₆₋₁₀ aryl.

In certain embodiments, compounds of formula PI-1a through PI-1c, can be produced by treating an isocyanate-terminated polyurethane prepolymer with a reagent comprising a functional group reactive toward isocyanates and one or more silicon-containing functional groups. Suitable isocyanate-terminated prepolymers can be synthesized by reacting an excess of a diisocyanate with a limiting amount of one or more polycarbonate polyols as shown in more detail below.

In certain embodiments, the reagent comprising a functional group reactive toward isocyanates and one or more silicon-containing functional groups with which the isocyanate-terminated prepolymer is reacted comprises an alcohol, a thiol, or an amine compound which also has a silyl functional group. In certain embodiments, the reagent comprising a functional group reactive toward isocyanates and one or more silicon-containing functional groups with which the isocyanate-terminated prepolymer is reacted comprises a thiol or an amine compound which also has a silyl functional group.

In certain embodiments, a reagent comprising a functional group reactive toward isocyanates and one or more silicon-containing functional groups include mercaptosilanes such as 2-mercaptoethyl trimethoxysilane, 3-mercaptopropyl trimethoxysilane, 2-mercaptopropyl triethoxysilane, 3-mercaptopropyl triethoxysilane, 2-mercaptoethyl tripropoxysilane, 2-mercaptoethyl tri sec-butoxysilane, 3-mercaptopropyl tri-t-butoxysilane, 3-mercaptopropyl triisopropoxysilane, 3-mercaptopropyl trioctoxysilane, 2-mercaptoethyl tri-2′-ethylhexoxysilane, 2-mercaptoethyl dimethoxy ethoxysilane, 3-mercaptopropyl methoxyethoxypropoxysilane, 3-mercaptopropyl dimethoxy methylsilane, 3-mercaptopropyl methoxy dimethylsilane, 3-mercaptopropyl ethoxy dimethylsilane, 3-mercaptopropyl diethoxy methylsilane, 3-mercaptopropyl cyclohexoxy dimethyl silane, 4-mercaptobutyl trimethoxysilane, 3-mercapto-3-methylpropyltrimethoxysilane, 3-mercapto-3-methylpropyl-tripropoxysilane, 3-mercapto-3-ethylpropyl-dimethoxy methylsilane, 3-mercapto-2-methylpropyl trimethoxysilane, 3-mercapto-2-methylpropyl dimethoxyphenylsilane, 3-mercaptocyclohexyl-trimethoxysilane, 12-mercaptododecyl trimethoxy silane, 12-mercaptododecyl-triethoxy silane, 18-mercaptooctadecyl trimethoxysilane, 18-mercaptooctadecyl methoxydimethylsilane, 2-mercapto-2-methylethyltripropoxysilane, 2-mercapto-2-methylethyl-trioctoxysilane, 2-mercaptophenyl trimethoxysilane, 2-mercaptophenyl triethoxysilane, 2-mercaptotolyl trimethoxysilane, 2-mercaptotolyl triethoxysilane, 1-mercaptomethyltolyl trimethoxysilane, 1-mercaptomethyltolyltri ethoxysilane, 2-mercaptoethylphenyl trimethoxysilane, 2-mercaptoethylphenyl triethoxysilane, 2-mercaptoethyltolyl trimethoxysilane, 2-mercaptoethyltolyl triethoxysilane, 3-mercaptopropylphenyl trimethoxysilane and, 3-mercaptopropylphenyl triethoxysilane.

In certain embodiments, a reagent comprising a functional group reactive toward isocyanates and one or more silicon-containing functional groups include aminosilanes 3-aminopropyltrimethoxysilane, 3-aminopropyltriethoxysilane, 4-aminobutyltriethoxysilane, N-methyl-3-amino-2-methylpropyltrimethoxysilane, N-ethyl-3-amino-2-methylpropyltrimethoxysilane, N-ethyl-3-amino-2 methylpropyldiethoxymethyl silane, N-ethyl-3-amino-2 methylpropyltriethoxysilane, N-ethyl-3-amino-2-methylpropylmethyldimethoxysilane, N-butyl-3-amino-2-methylpropyltrimethoxysilane, 3-(N-methyl-2-amino-1 methyl-1-ethoxy)-propyltrimethoxysilane, N-ethyl-4 amino-3,3-dimethyl-butyldimethoxymethyl silane, N-ethyl 4-amino-3,3-dimethylbutyltrimethoxy-silane, N-(cyclohexyl)-3-a minopropyltrimethoxysilane, N-(2-aminoethyl)-3-aminopropyltrimethoxysilane, N-(2-aminoethyl)-3-aminopropyltriethoxy-silane, N-(2-aminoethyl)-3 aminopropylmethyldimethoxysilane, aminopropyltriethoxysilane, bis-(3-trimethoxysilyl-2-methylpropyl)amine and N-(3′-trimethoxysilylpropyl)-3-amino-2-methylpropyltrimethoxysilane.

As mentioned above, in certain embodiments this invention encompasses novel silyl terminated prepolymers containing aliphatic polycarbonate polyol segments. In certain embodiments, these prepolymers are derived from isocyanate-terminated prepolymers that are the result of reaction of the aliphatic polycarbonate polyols with di- or poly-isocyanates, optionally in the presence of one or more coreactants. This section shows in more detail some of the isocyanate-terminated prepolymers useful for the production of such silyl-terminated materials (e.g. through reaction with a silyl amino or silyl thiol compound as shown above).

The formation of prepolymers is shown conceptually in Scheme 3 below:

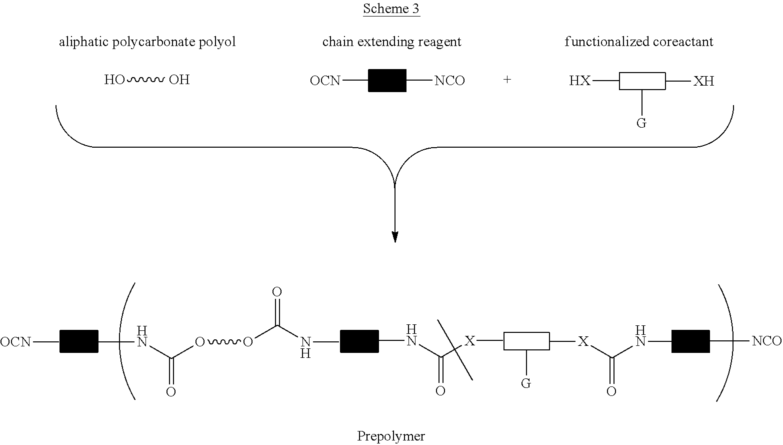

In Scheme 3, each —XH represents a functional group on the coreactant capable of reacting with an isocyanate group (for example —OH, —NHR, —SH, etc.), and -G represents an optionally present hydrophilic functional group, a cross-linkable functional group or a precursor thereof. Such -G groups may be incorporated to facilitate cross-linking, aid in formation of aqueous dispersions, or modification of the physical properties of the polymers.

As depicted in Scheme 3, the reaction of the chain extending reagent

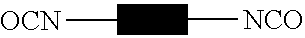

with the —OH groups of the aliphatic polycarbonate polyol and, if present, the —XH groups on the coreactant, leads to an oligomeric prepolymer composition having a plurality of segments joined by urethane (carbamate) linkages. Each prepolymer chain resulting from this reaction may contain a variable number of polyol segments and incorporate a variable number of coreactants. The compositional abundance and average chain length of the prepolymers can be controlled using methods known in the art such as by changing the stoichiometry of the reagents and/or by modifying the reaction conditions employed. Scheme 3 therefore represents a simplification and it is to be understood that the prepolymer compositions described herein may contain a complex mixture of random copolymers comprising a statistical distribution of a vast number of chain compositions.

While Scheme 3 shows formation of a linear prepolymer, the present invention also encompasses branched and crosslinked prepolymers. These materials result when any of the reactants involved comprises three or more reactive sites (for example a branched polyol, a triisocyanate, or a triol coreactant would all lead to branched structures). The degree of branching or cross-linking in the prepolymers can be controlled using methods known in the art, for example by varying the quantities and identities of the tri- or higher-functional reactants included in the prepolymer and/or by modifying the reaction conditions employed during the prepolymer formation.

In certain embodiments, a prepolymer of the present invention comprises essentially linear oligomers of straight-chain aliphatic polycarbonate polyols (e.g. polyols having two —OH end groups such as those of formula P1 where x+y=2) and one or more diisocyanates, where the prepolymer optionally contains segments derived from one or more coreactants having two functional groups capable of reaction with an isocyanate. In certain embodiments, such linear oligomers are represented by structure o1:

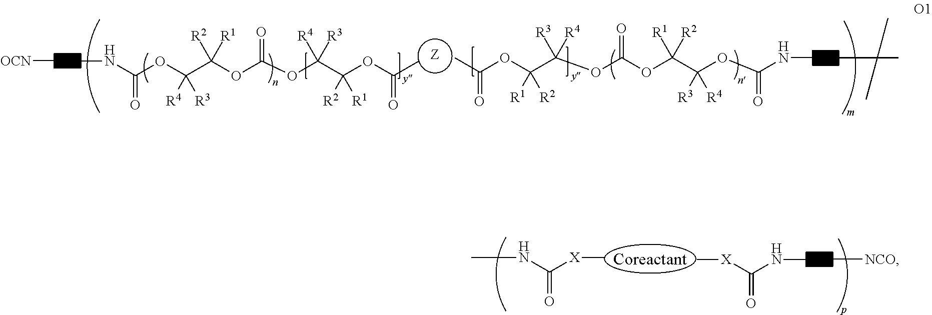

wherein each of R¹, R², R³, R⁴, [symbol] , and n′ is as defined above and described in classes and subclasses herein,
[symbol] represents the carbon skeleton of any of the diisocyanates defined above and described in classes and subclasses herein,
[symbol] represents the carbon skeleton of any of the coreactants defined above and described in classes and subclasses herein,
—X— is —O—, —NR—, or —S—;
y″ is, independently at each occurrence, 0 or 1;
m is an integer greater than zero, and
p is zero or greater.

In certain embodiments, in prepolymers of formula O1, each y″ is zero (e.g. the aliphatic polycarbonate polyol is one formed from a diol chain transfer agent as described for polyols of formula P2 above). In other embodiments, in prepolymers of formula O1, one y″ is zero and the other y″ is one (e.g. the aliphatic polycarbonate polyol is one formed from a hydroxyacid chain transfer agent as described for polyols of formula P6 herein). In certain embodiments, in prepolymers of formula O1, each y″ is one (e.g. the aliphatic polycarbonate polyol is one formed from a dicarboxylic acid chain transfer agent as described for polyols of formula P8 above).

In certain embodiments, in prepolymers of formula O1, each —X— is an oxygen atom (e.g. where a coreactant comprises a dihydric alcohol). In other embodiments, each —X— is an —NR— group (e.g. where a coreactant comprises a diamine). In certain embodiments, the —X— groups present represent a mixture of oxygen and nitrogen atoms.

In certain embodiments, the prepolymer comprises branched or cross-linked oligomers of a difunctional aliphatic polycarbonate polyol and a polyisocyanate having more than two isocyanate groups, where the prepolymer optionally contains segments derived from one or more difunctional coreactants. In certain embodiments, such branched oligomers comprise compounds represented by structure O2:

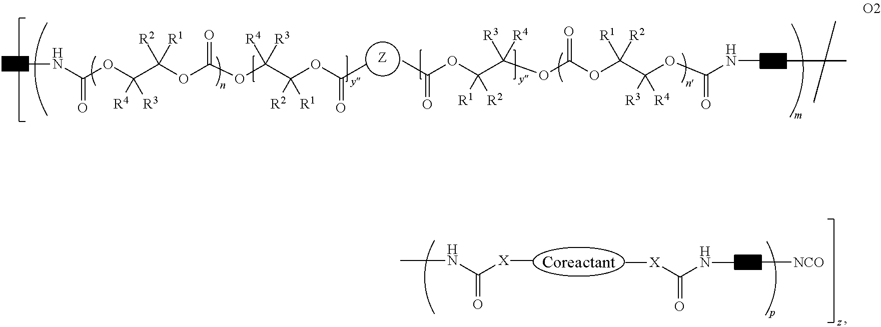

wherein each of R, R¹, R², R³, R⁴, X, [symbol] , [symbol] , [symbol] , and m, n, n′, p, and y″ is as defined above and described in classes and subclasses herein, and z is an integer greater than 2.

In certain embodiments, the prepolymer comprises branched or cross-linked oligomers of a branched aliphatic polycarbonate polyol having more than two —OH end groups and a polyisocyanate having at least two isocyanate groups, where the prepolymer optionally contains segments derived from one or more difunctional coreactants. In certain embodiments, such branched oligomers comprise compounds represented by structure O3:

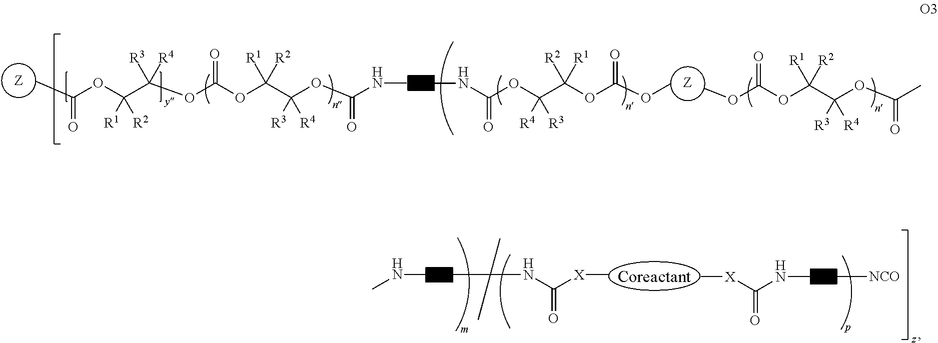

wherein each of R¹, R², R³, R⁴, X, [symbol] , [symbol] , [symbol] , and m, n, p, z, and y″ is as defined above and described in classes and subclasses herein, and n″ is at each occurrence, independently an integer from about 2 to about 100, and may be the same as or different from n or n′.

In certain embodiments, the prepolymer comprises branched or cross-linked oligomers of an aliphatic polycarbonate polyol, a polyisocyanate having at least two isocyanate groups, and one or more coreactants having more than two function groups reactive toward isocyanates. In certain embodiments, such branched oligomers comprise compounds represented by structure O4:

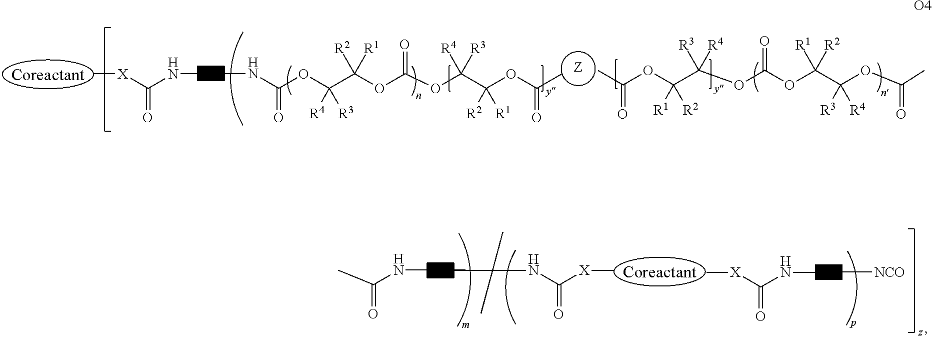

wherein each of R¹, R², R³, R⁴, X, [symbol] , [symbol] , [symbol] , and m, n, n′, p, z, and y″ is as defined above and described in classes and subclasses herein.

In certain embodiments, the prepolymer comprises complex branched oligomers of formula O5 derived from an aliphatic polycarbonate polyol having more than two hydroxyl groups and a polyisocyanate having more than two isocyanate groups, where the prepolymer optionally contains segments derived from one or more difunctional coreactants. In certain embodiments, the prepolymer comprises complex branched oligomers of formula O6 comprising an aliphatic polycarbonate polyol having more than two hydroxyl groups, a diisocyanate and a polyfunctional coreactant having more than two functional groups reactive toward isocyanates. In certain embodiments, the prepolymer comprises complex branched oligomers of formula O7 comprising an aliphatic polycarbonate polyol, a polyisocyanate having more than two isocyanate groups, and a polyfunctional coreactant having more than two functional groups reactive toward isocyanates. In certain embodiments, the prepolymer comprises complex branched oligomers of formula O8 comprising an aliphatic polycarbonate polyol having more than two hydroxyl groups, a polyisocyanate having more than two isocyanate groups, and a polyfunctional coreactant having more than two functional groups reactive toward isocyanates.

In certain embodiments, prepolymers comprise mixtures containing linear oligomers of formula O1 along with smaller amounts of any one or more branched oligomers of formulae O2 through O8. In certain embodiments, prepolymers comprise linear oligomers of formula O1 with essentially no cross-linking or branching.

In certain embodiments, for prepolymers of formulae O1 through O8, the prepolymer comprises aliphatic polycarbonate segments derived from any of the polyols of formulae P2a through P2r-a as defined herein and described in classes and subclasses herein, or from mixtures of any two or more of these. In certain embodiments, for prepolymers of formulae O1 through O8, the prepolymer comprises aliphatic polycarbonate segments derived from any of the polyols of formulae Q1 through Q4 as defined herein and described in classes and subclasses herein, or from mixtures of any two or more of these.

In certain embodiments, for prepolymers of formulae O5, O6, and O8, the prepolymer further comprises aliphatic polycarbonate segments derived from any of the polyols of formulae P3, P4, or P5 as defined herein and described in classes and subclasses herein, or from mixtures of any two or more of these.

In certain embodiments, for prepolymers of formulae O1 through O8, the prepolymer further comprises segments derived from any one or more of the coreactants described hereinabove. In certain embodiments, a coreactant comprises an alcohol (e.g. at least one —X— in any of structures O1-O4 is —O—). In certain embodiments, for prepolymers of formulae O1 through O8, the prepolymer comprises coreactant segments having one or more hydrophilic functional groups. In certain embodiments, such hydrophilic functional groups are precursors to anionic groups. In certain embodiments, the precursors to anionic groups present on coreactant segments are selected from the group consisting of: carboxylic acids, esters, anhydrides, sulfonic acids, sulfamic acids, phosphates.

In certain embodiments, for prepolymers of formulae O1 through O8, the prepolymer comprises coreactant segments having one or more carboxylic acid groups. In certain embodiments, such coreactant segments are derived from carboxylic acid diols. In certain embodiments, such coreactant segments are derived from a bis(hydroxylalkyl) alkanoic acid. In certain embodiments, such coreactant segments are derived from a bis(hydroxylmethyl) alkanoic acid. In certain embodiments, such coreactant segments are derived from a compound selected from the group consisting of DMPA; DMBA, tartaric acid, and 4,4′-bis(hydroxyphenyl) valeric acid. In certain embodiments, prepolymers of formulae O1 through O8, contain coreactant segments derived from DMPA. In certain embodiments, prepolymers of formulae O1 through O8, contain coreactant segments derived from DMBA.

In certain embodiments, for prepolymers of formulae O1 through O8, the prepolymer comprises coreactant segments bearing one or more carboxylate salts. In certain embodiments, a coreactant segment comprising a carboxylate salt is derived from any of the carboxylic acid-containing coreactant segments described above by treating them with a base. In certain embodiments the base comprises a metal salt. In other embodiments, the base comprises an amine.

In certain embodiments, for prepolymers of formulae O1 through O8, the prepolymer comprises coreactant segments having one or more amino groups. In certain embodiments, such coreactant segments are derived from amine diols. In certain embodiments, such coreactant segments are derived from a diol containing a tertiary amino group. In certain embodiments, such coreactant segments are derived from an amino diol selected from the group consisting of: diethanolamine (DEA), N-methyldiethanolamine (MDEA), N-ethyldiethanolamine (EDEA), N-butyldiethanolamine (BDEA), N,N-bis(hydroxyethyl)-α-amino pyridine, dipropanolamine, diisopropanolamine (DIPA), N-methyldiisopropanolamine, Diisopropanol-p-toluidine, N,N-Bis(hydroxyethyl)-3-chloroaniline, 3-diethylaminopropane-1,2-diol, 3-dimethylaminopropane-1,2-diol and N-hydroxyethylpiperidine. In certain embodiments, prepolymers of formulae O1 through O8, contain coreactant segments derived from DEA. In certain embodiments, prepolymers of formulae O1 through O8, contain coreactant segments derived from MDEA. In certain embodiments, prepolymers of formulae O1 through O8, contain coreactant segments derived from EDEA. In certain embodiments, prepolymers of formulae O1 through O8, contain coreactant segments derived from BDEA. In certain embodiments, prepolymers of formulae O1 through O8, contain coreactant segments derived from DIPA.

In certain embodiments, for prepolymers of formulae O1 through O8, the prepolymer comprises coreactant segments having one or more quaternary amino groups. In certain embodiments, a coreactant segment comprising a quaternary amino group is derived from any of the amine-containing coreactant segments described above by creating an acid salt or quaternized derivative of any of the amine-containing coreactant segments described in the previous paragraph.

In certain embodiments, for prepolymers of formulae O1 through O8, the prepolymer comprises coreactant segments derived from hydrophilic polyether polyols. In certain embodiments, such hydrophilic polyether polyols are oligomers of ethylene oxide and/or propylene oxide. In certain embodiments, the hydrophilic polyether polyols are rich in EO repeat units.

In certain embodiments, the prepolymers contain a plurality of different coreactant segments derived from two or more different coreactants including mixtures of two or more of any of the coreactants above and described in the classes and subclasses herein.

In certain embodiments, where the prepolymers contain segments derived from coreactants, the molar ratio of aliphatic polycarbonate segments to coreactant segments in the prepolymer composition varies from about 10,000:1 to about 1:1. In certain embodiments, the molar ratio of aliphatic polycarbonate segments to coreactant segments varies from about 5,000:1 to about 5:1. In certain embodiments, the molar ratio of aliphatic polycarbonate segments to coreactant segments varies from about 1,000:1 to about 10:1. In certain embodiments, the molar ratio of aliphatic polycarbonate segments to coreactant segments varies from about 500:1 to about 10:1. In certain embodiments, the molar ratio of aliphatic polycarbonate segments to coreactant segments varies from about 500:1 to about 20:1. In certain embodiments, the molar ratio of aliphatic polycarbonate segments to coreactant segments varies from about 200:1 to about 50:1. In certain embodiments, the molar ratio of aliphatic polycarbonate segments to coreactant segments is about 200:1, about 100:1, about 50:1, about 30:1, about 20:1, about 10:1 or about 5:1. In some embodiments, a prepolymer may contain more than one type of coreactant segment, in which case the ratios above may be taken to describe the ratio of the polycarbonate segments to any single coreactant segment.

In certain embodiments, for prepolymers of formulae O1 through O8, urethane linkages in the prepolymer are derived from aliphatic diisocyanates, aromatic diisocyanates, oligomeric diisocyanates, or difunctional isocyanate prepolymers.

In certain embodiments, for prepolymers of formulae O1 through O8, the prepolymer comprises urethane linkages derived from one or more aliphatic diisocyanates. In certain embodiments, the prepolymer comprises urethane linkages derived from diisocyanates selected from the group consisting of: HDI, IPDI, H₁₂MDI, H6-XDI, TMDI, 1,4-cyclohexyl diisocyanate, 1,4-tetramethylene diisocyanate, trimethylhexane diisocyanate, and mixtures of any two or more of these. In certain embodiments, the prepolymer comprises urethane linkages derived from diisocyanates selected from the group consisting of: HDI, IPDI, H₁₂MDI and mixtures of two or more of these. In certain embodiments, the prepolymer comprises urethane linkages derived from HDI. In certain embodiments, the prepolymer comprises urethane linkages derived from IPDI. In certain embodiments, the prepolymer comprises urethane linkages derived from H₁₂MDI. In certain embodiments, the prepolymer comprises urethane linkages derived from H6-XDI. In certain embodiments, the prepolymer comprises urethane linkages derived from TMDI. In certain embodiments, the prepolymer comprises urethane linkages derived from oligomers or derivatives of any of the above aliphatic isocyanates. In certain embodiments, the prepolymer comprises urethane linkages derived from biurets of any of the above aliphatic isocyanates.

In certain embodiments, for prepolymers of formulae O1 through O8, the prepolymer comprises urethane linkages derived from one or more aromatic diisocyanates. In certain embodiments, the prepolymer comprises urethane linkages derived from diisocyanates selected from the group consisting of: 2,4-TDI, 2,6-TDI, MDI, XDI, TMXDI, and mixtures of any two or more of these. In certain embodiments, the prepolymer comprises urethane linkages derived from TDI or MDI. In certain embodiments, the prepolymer comprises urethane linkages derived from TDI. In certain embodiments, the prepolymer comprises urethane linkages derived from 2,4-TDI. In certain embodiments, the prepolymer comprises urethane linkages derived from 2,6-TDI. In certain embodiments, the prepolymer comprises urethane linkages derived from H6-XDI. In certain embodiments, the prepolymer comprises urethane linkages derived from MDI. In certain embodiments, the prepolymer comprises urethane linkages derived from XDI. In certain embodiments, the prepolymer comprises urethane linkages derived from TMXDI. In certain embodiments, the prepolymer comprises urethane linkages derived from oligomers or derivatives of any of the above aromatic isocyanates. In certain embodiments, the prepolymer comprises urethane linkages derived from biurets of any of the above aromatic isocyanates.

In certain embodiments, for prepolymers of formulae O1 through O8, the prepolymer comprises covalently-linked isocyanate groups. Compositions having this property may be produced using methods known in the art. In particular, control of the molar ratios of the reagents during prepolymer formation such that there is a molar excess of the polyfunctional isocyanate relative to the isocyanate-reactive groups on the aliphatic polycarbonate polyol and coreactants (if any) will favor oligomers where the chain ends are capped with an isocyanate resulting from partial reaction of a polyisocyanate molecule.

In certain embodiments, a majority of chain ends in prepolymers of the present invention comprise isocyanate groups. In certain embodiments, at least 60%, at least 70%, at least 80%, at least 85% or at least 90% of chain ends comprise isocyanate groups. In certain embodiments, at least 92%, at least 95%, at least 96%, at least 97% or at least 98% of chain ends comprise isocyanate groups. In certain embodiments, at least 99% of chain ends comprise isocyanate groups. In certain embodiments, essentially all of the chain ends in prepolymers of the present invention comprise isocyanate groups.

In certain embodiments, the present invention provides novel compositions of matter comprising prepolymers of formula O1 comprising poly(propylene carbonate) (PPC) segments. In certain embodiments, prepolymers of formula O1 contain segments of formula O1-a1

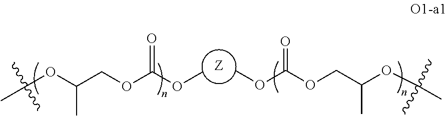

wherein each of [symbol] , —Y, and n is as defined above and described in classes and subclasses herein.

In certain embodiments, the present invention provides novel compositions of matter comprising prepolymers of formula O1 comprising poly(ethylene carbonate) (PEC) segments. In certain embodiments, such prepolymers contain segments of formula O1-a2

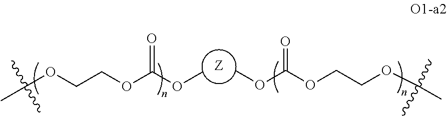

wherein each of [symbol] Y, and n is as defined above and described in classes and subclasses herein.

In certain embodiments, prepolymers of formula O1 contain segments derived from polyols of formula Q1, Q2, Q3, or Q4, as defined herein and described in the classes and subclasses herein, or from mixtures of any two or more of these.

In certain embodiments, the present invention provides novel compositions of matter comprising prepolymers of formula O1, where the polyol segments are derived from one or more aliphatic polycarbonate polyol compositions selected from the group consisting of:
Poly(propylene carbonate) of formula Q1 having an average molecular weight number of between about 500 g/mol and about 3,000 g/mol (e.g. each n is between about 3 and about 15), a polydisperisty index less than about 1.25, at least 95% carbonate linkages, and at least 98%—OH end groups;
Poly(propylene carbonate) of formula Q1 having an average molecular weight number of about 500 g/mol (e.g. n is on average between about 3.5 and about 4.5), a polydisperisty index less than about 1.25, at least 95% carbonate linkages, and at least 98%—OH end groups;
Poly(propylene carbonate) of formula Q1 having an average molecular weight number of about 1,000 g/mol (e.g. n is on average between about 3.5 and about 4.5), a polydisperisty index less than about 1.25, at least 95% carbonate linkages, and at least 98%—OH end groups;
Poly(propylene carbonate) of formula Q1 having an average molecular weight number of about 2,000 g/mol (e.g. n is on average between about 8 and about 9.5), a polydisperisty index less than about 1.25, at least 95% carbonate linkages, and at least 98%—OH end groups;
Poly(propylene carbonate) of formula Q1 having an average molecular weight number of about 3,000 g/mol (e.g. n is on average between about 13 and about 15), a polydisperisty index less than about 1.25, at least 95% carbonate linkages, and at least 98%—OH end groups;
Poly(propylene carbonate) of formula Q2 having an average molecular weight number of between about 500 g/mol and about 3,000 g/mol (e.g. each n is between about 3 and about 15), a polydisperisty index less than about 1.25, at least 95% carbonate linkages, and at least 98%—OH end groups;
Poly(propylene carbonate) of formula Q2 having an average molecular weight number of about 500 g/mol (e.g. n is on average between about 3.5 and about 4.5), a polydisperisty index less than about 1.25, at least 95% carbonate linkages, and at least 98%—OH end groups;
Poly(propylene carbonate) of formula Q2 having an average molecular weight number of about 1,000 g/mol (e.g. n is on average between about 3.5 and about 4.5), a polydisperisty index less than about 1.25, at least 95% carbonate linkages, and at least 98%—OH end groups;
Poly(propylene carbonate) of formula Q2 having an average molecular weight number of about 2,000 g/mol (e.g. n is on average between about 8 and about 9.5), a polydisperisty index less than about 1.25, at least 95% carbonate linkages, and at least 98%—OH end groups;
Poly(propylene carbonate) of formula Q2 having an average molecular weight number of about 3,000 g/mol (e.g. n is on average between about 13 and about 15), a polydisperisty index less than about 1.25, at least 95% carbonate linkages, and at least 98%—OH end groups;
Poly(ethylene carbonate) of formula Q3 having an average molecular weight number of between about 500 g/mol and about 3,000 g/mol (e.g. each n is between about 4 and about 16), a polydisperisty index less than about 1.25, at least 85% carbonate linkages, and at least 98%—OH end groups;
Poly(ethylene carbonate) of formula Q3 having an average molecular weight number of about 500 g/mol (e.g. n is on average between about 4 and about 5), a polydisperisty index less than about 1.25, at least 85% carbonate linkages, and at least 98%—OH end groups;
Poly(ethylene carbonate) of formula Q3 having an average molecular weight number of about 1,000 g/mol (e.g. n is on average between about 4 and about 5), a polydisperisty index less than about 1.25, at least 85% carbonate linkages, and at least 98%—OH end groups;
Poly(ethylene carbonate) of formula Q3 having an average molecular weight number of about 2,000 g/mol (e.g. n is on average between about 10 and about 11), a polydisperisty index less than about 1.25, at least 85% carbonate linkages, and at least 98%—OH end groups;
Poly(ethylene carbonate) of formula Q3 having an average molecular weight number of about 3,000 g/mol (e.g. n is on average between about 15 and about 17), a polydisperisty index less than about 1.25, at least 85% carbonate linkages, and at least 98%—OH end groups;
Poly(ethylene carbonate) of formula Q4 having an average molecular weight number of between about 500 g/mol and about 3,000 g/mol (e.g. each n is between about 4 and about 16), a polydisperisty index less than about 1.25, at least 85% carbonate linkages, and at least 98%—OH end groups;
Poly(ethylene carbonate) of formula Q4 having an average molecular weight number of about 500 g/mol (e.g. n is on average between about 4 and about 5), a polydisperisty index less than about 1.25, at least 85% carbonate linkages, and at least 98%—OH end groups;
Poly(ethylene carbonate) of formula Q4 having an average molecular weight number of about 1,000 g/mol (e.g. n is on average between about 4 and about 5), a polydisperisty index less than about 1.25, at least 85% carbonate linkages, and at least 98%—OH end groups;
Poly(ethylene carbonate) of formula Q4 having an average molecular weight number of about 2,000 g/mol (e.g. n is on average between about 10 and about 11), a polydisperisty index less than about 1.25, at least 85% carbonate linkages, and at least 98%—OH end groups; and
Poly(ethylene carbonate) of formula Q4 having an average molecular weight number of about 3,000 g/mol (e.g. n is on average between about 15 and about 17), a polydisperisty index less than about 1.25, at least 85% carbonate linkages, and at least 98%—OH end groups.

In certain embodiments, the present invention provides prepolymers of formula O1 comprising PPC segments in combination with coreactant segments derived from carboxylic acid diols. In certain embodiments, such prepolymers comprise fragments having a structure O1-b1:

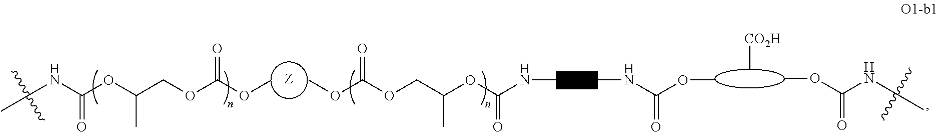

wherein each of n, and [symbol] , [symbol] , [symbol] , is as defined above and described in classes and subclasses herein.

In certain embodiments, the present invention provides prepolymers of formula O1 comprising PPC segments in combination with coreactant segments derived from 2,2′ dimethylolpropionic acid, (DMPA) In certain embodiments, such prepolymers comprise fragments having a structure O1-b2:

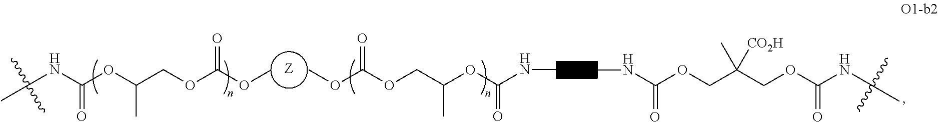

wherein each of n, [symbol] and [symbol] is as defined above and described in classes and subclasses herein.

In certain embodiments, the present invention provides prepolymers of formula O1 comprising PPC segments in combination with coreactant segments derived from 2,2-bis(hydroxymethyl) butanoic acid (DMBA). In certain embodiments, such prepolymers comprise fragments having a structure O1-b3:

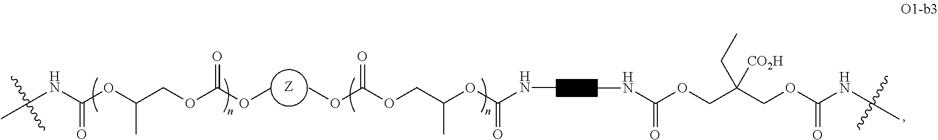

wherein each of n, [symbol] and [symbol] is as defined above and described in classes and subclasses herein.

In certain embodiments, the present invention provides prepolymers of formula O1 comprising PPC segments in combination with coreactant segments derived from carboxylic acid diols, and urethane linkages derived from aliphatic isocyanates. In certain embodiments, the present invention provides prepolymers of formula O1 comprising PPC segments in combination with coreactant segments derived from carboxylic acid diols, and urethane linkages derived from one or more aliphatic isocyanates selected from the group consisting of: HDI, IPDI, H₁₂MDI, H6-XDI, TMDI, 1,4-cyclohexyl diisocyanate, 1,4-tetramethylene diisocyanate, and trimethylhexane diisocyanate.

In certain embodiments, the present invention provides prepolymers of formula O1 comprising fragments having any of structures O1-b4 through O1-b8, wherein each of n and is as defined above and described in classes and subclasses herein.

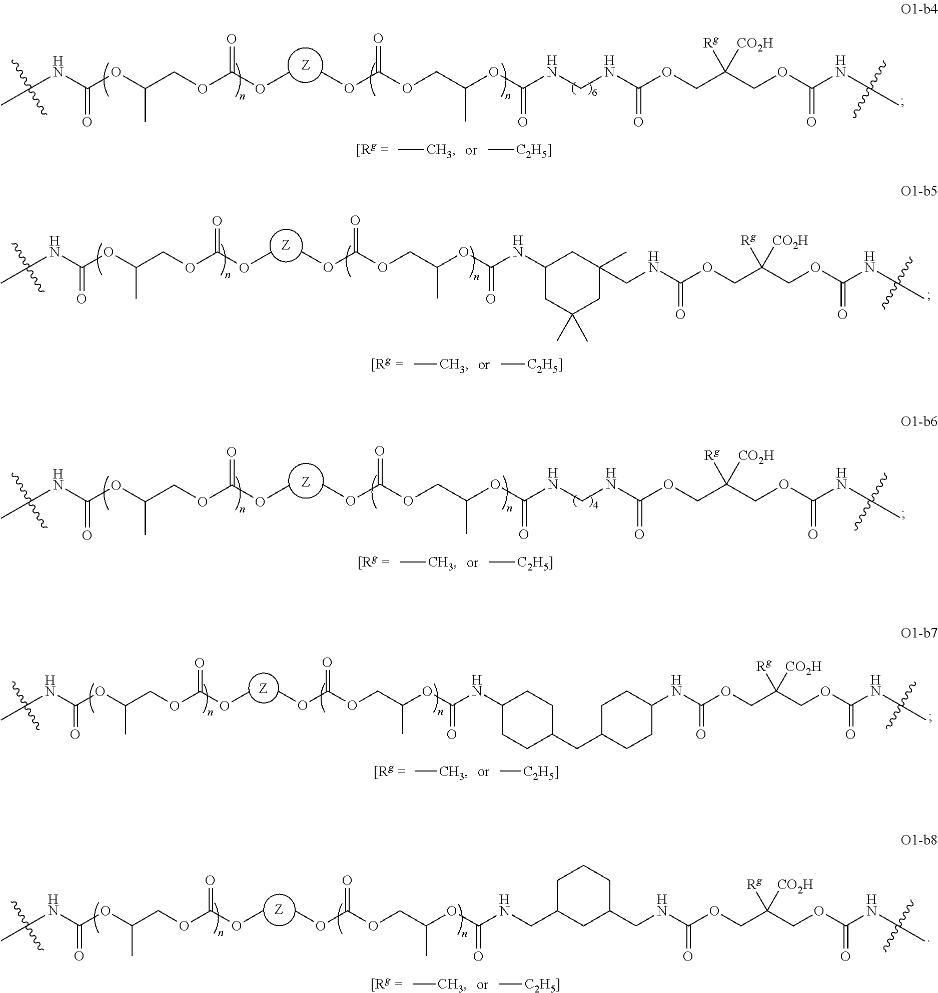

In certain embodiments, the present invention provides prepolymers of formula O1 comprising PPC segments in combination with coreactant segments derived from carboxylic acid diols, and urethane linkages derived from aromatic isocyanates. In certain embodiments, the present invention provides prepolymers of formula O1 comprising PPC segments in combination with coreactant segments derived from carboxylic acid diols, and urethane linkages derived from one or more aromatic isocyanates selected from the group consisting of: TDI, MDI, XDI, and TMXDI.

In certain embodiments, the present invention provides prepolymers of formula O1 comprising fragments having any of structures O1-b8′ through O1-b12, wherein each of n and is as defined above and described in classes and subclasses herein.

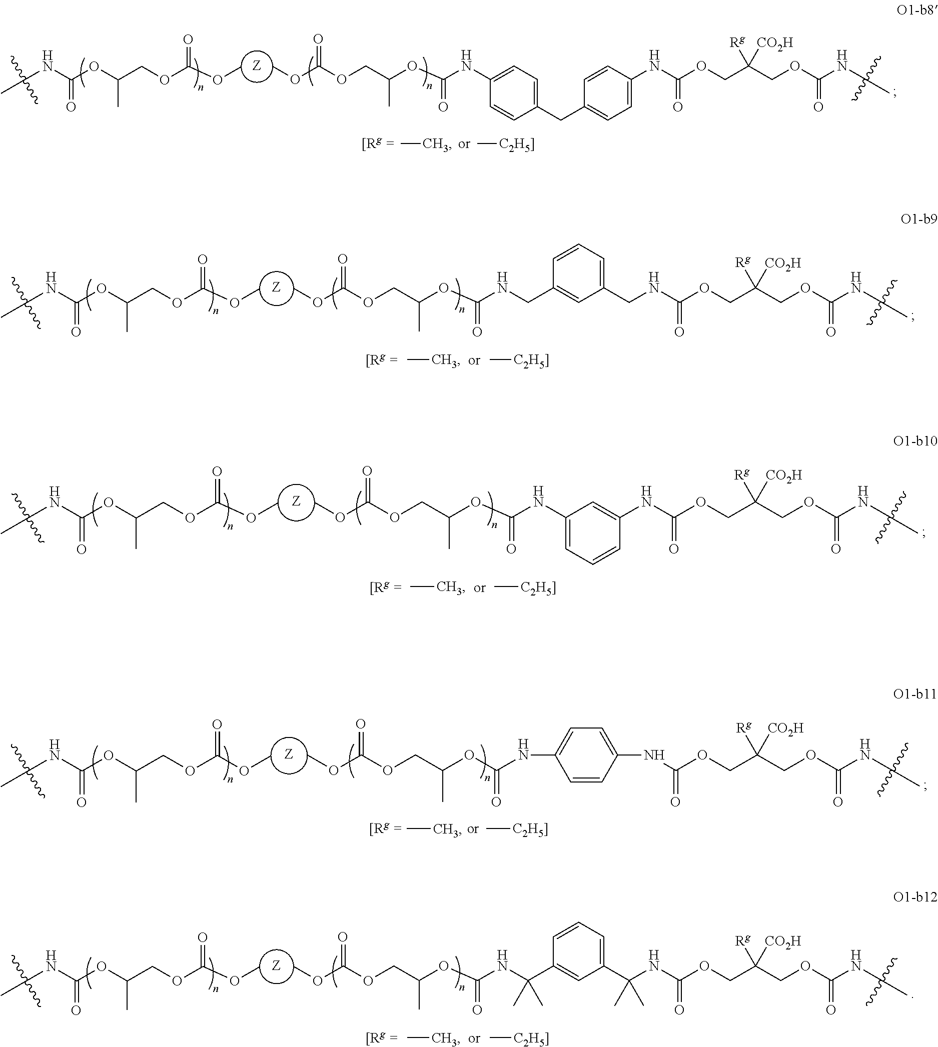

In certain embodiments, the present invention provides prepolymers of formula O1 comprising PEC segments in combination with coreactant segments derived from carboxylic acid diols. In certain embodiments, such prepolymers comprise fragments having any of structures O1-b1 through O1-b12, where the PPC segments are substituted for PEC, or PPC-co-PEC segments: such compounds may be designated O1-b13 through O1-b25 where the non-polycarbonate segments of O1-b13 correspond to those in O1-b1, those in O1-b14 correspond to O1-b2, and so on.

In certain embodiments, the present invention provides prepolymers analogous to those depicted in formulae O1-a1 through O1-b25 but comprising polycarbonate polyol segments derived from chain transfer agents having one or more carboxylic acid groups.

The specific structures of these compounds can be ascertained by substituting some or all of the polycarbonate-polyol-derived segments in compounds O1-al through O1-b25 with poly(propylene carbonate) or poly(ethylene carbonate) conforming to structures P6 or P8.

In certain embodiments, the present invention provides prepolymers comprising carboxylate salts derived from neutralization of the pendant carboxyl groups to convert the carboxyl groups to carboxylate anions, thus having a water-dispersibility enhancing effect. Suitable neutralizing agents include tertiary amines, metal hydroxides, ammonium hydroxide, phosphines, and other agents well known to those skilled in the art. Tertiary amines and ammonium hydroxide are preferred, such as triethyl amine (TEA), dimethyl ethanolamine (DMEA), N-methyl morpholine, and the like, and mixtures thereof. It is recognized that primary or secondary amines may be used in place of tertiary amines, if they are sufficiently hindered to avoid interfering with the chain extension process. In certain embodiments, the present invention provides prepolymers comprising carboxylate salts derived from any of the fragments of formulae O1-b1 through O1-b25. In certain embodiments such carboxylate salts are alkali earth metal salts. In certain embodiments, such salts are sodium salts. In certain embodiments, such salts are ammonium salts.

In certain embodiments, the present invention provides prepolymers of formula O1 comprising PPC segments in combination with coreactant segments derived from amino diols. In certain embodiments, such prepolymers comprise fragments having a structure O1-c1:

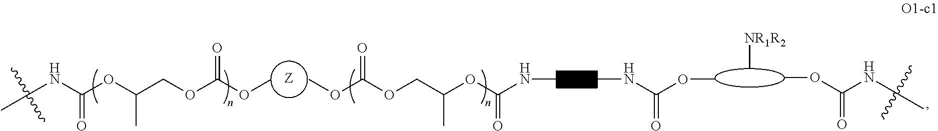

wherein each of n, [symbol] [symbol] and [symbol] is as defined above and described in classes and subclasses herein, and
at each occurrence R₁ and R₂ is independently selected from the group consisting of: optionally substituted C₁₋₆ aliphatic; optionally substituted aryl, and a substituted carbamoyl group, where R₁ and R₂ may be optionally taken together with intervening atoms to form one or more optionally substituted saturated or unsaturated rings optionally containing one or more additional heteroatoms, and where R₁ and R₂ may constitute part of the oligomeric chain (e.g. as in the case of hydroxyl alkyl amine-derived materials).

In certain embodiments, where prepolymers comprise fragments having a structure O1-c1, the amine-bearing segment is derived from an amino diol selected from the group consisting of: diethanolamine (DEA), N-methyldiethanolamine (MDEA), N-ethyldiethanolamine (EDEA), N-butyldiethanolamine (BDEA), N,N-bis(hydroxyethyl)-α-amino pyridine, dipropanolamine, diisopropanolamine (DIPA), N-methyldiisopropanolamine, Diisopropanol-p-toluidine, N,N-Bis(hydroxyethyl)-3-chloroaniline, 3-diethylaminopropane-1,2-diol, 3-dimethylaminopropane-1,2-diol.

In certain embodiments, such prepolymers comprise fragments having a structure O1-c2:

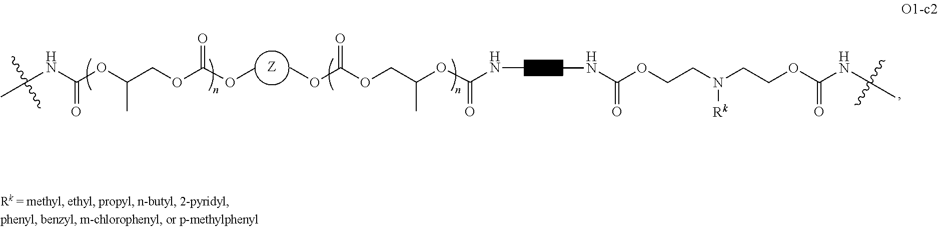

wherein each of n, [symbol] and [symbol] is as defined above and described in classes and subclasses herein.

In certain embodiments, such prepolymers comprise fragments having a structure O1-c3:

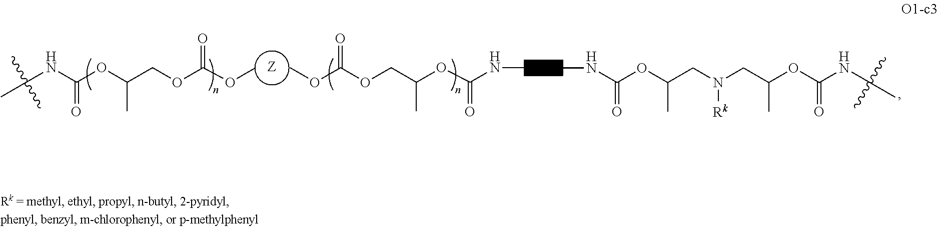

wherein each of n, [symbol] , and [symbol] is as defined above and described in classes and subclasses herein.

In certain embodiments, such prepolymers comprise fragments having a structure O1-c4:

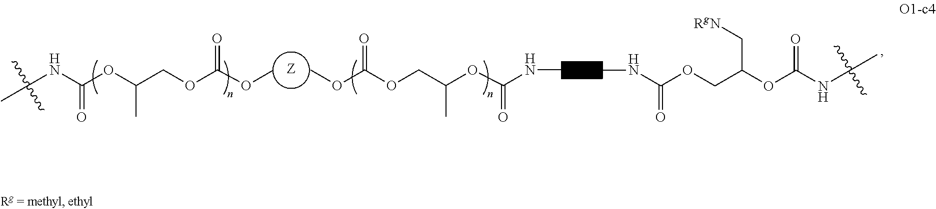

wherein each of n, [symbol] , and [symbol] is as defined above and described in classes and subclasses herein.

In certain embodiments, the present invention encompasses compounds of structure O1-c1, comprising any of the urethane linkages shown in structures O1-b4 through O1-b12 these fragment structures may be referred to as fragments O1-c5 through O1-c13, where the non coreactant segments in O1-c5 correspond to those in O1-b4, those in O1-c6 correspond to O1-b5, and so forth.

In certain embodiments, the present invention provides prepolymers of formula O1 comprising PEC segments in combination with coreactant segments derived from carboxylic acid diols. In certain embodiments, such prepolymers comprise fragments having any of structures O1-c1 through O1-c13, where the PPC segments are substituted for PEC, or PPC-co-PEC segments.

In certain embodiments, the present invention provides prepolymers comprising ammonium salts derived from any of the fragments of formulae O1-c1 through O1-c13 (or from their PEC counterparts). In certain embodiments such ammonium salts are quaternized ammonium salts formed by treating the amine with alkylating agents such as alkyl halides (e.g. methyl iodide, bromomethane, benzyl chloride, or allyl chloride), alkyl sulfates (e.g. methyl sulfate or ethyl sulfate) and the like. In certain embodiments, such salts are formed by protonating the amine with a strong acid.

In certain embodiments, the present invention provides prepolymers analogous to those depicted in formulae O1-c1 through O1-c13 but comprising polycarbonate polyol segments derived from chain transfer agents having one or more carboxylic acid groups.

The specific structures of these compounds can be ascertained by substituting some or all of the polycarbonate-polyol-derived segments in compounds O1-c1 through O1-c13 with poly(propylene carbonate) or poly(ethylene carbonate) conforming to structures P6 or P8.

In certain embodiments, the present invention encompasses solutions of any of the above-described prepolymers. In certain embodiments, such solutions comprise one or more non-protic polar organic solvents. In some embodiments the solvent comprises a ketone. In certain embodiments, the solvent comprises acetone or 2-butanone. In other embodiments, the solvent comprises an amide. In certain embodiments the solvent comprises N-methylpyrrolidone (NMP).

A. Aqueous Dispersions and Higher Polymers

In certain embodiments, the present invention encompasses aqueous dispersions comprising any of the above-described silyl-terminated prepolymers. In certain embodiments, such aqueous dispersions comprise emulsions of the prepolymers in substantially unmodified form, while in other embodiments, the aqueous dispersions contain higher polymers formed by the reaction of the silyl groups present on the prepolymers. If such higher polymers are present, they may be formed in situ by inclusion of suitable catalysts, or chain-extending reagents during or after formation of the dispersion, or they may be formed prior to dispersion.

In some embodiments, the higher polymers are formed by chain extension with suitable chain-extending agents. Suitable chain-extending agents typically contain hydroxyl groups that can displace alkoxy groups on the silyl groups of the inventive compositions, or other siloxy groups that can cross-link with the reactive compositions under the influence of a suitable catalyst.

### IV. Coatings, Adhesives and Articles of Manufacture

In another aspect, the present invention encompasses coatings and adhesives containing or derived from the novel materials described hereinabove. The invention encompasses both the formulated coatings and adhesives as applied, and the cured coatings and adhesives.

In certain embodiments, the polyurethane dispersions of the present invention are suitable for use as protective coatings. The polyurethane coatings of this invention which contain the aliphatic polycarbonates as described above have certain advantages over existing materials. In certain embodiments, the coatings have unexpected and excellent hardness. As such, these coatings can be useful to protect materials such as wood, metal, stone, masonry, plastic, composites, fabrics, and the like. In certain embodiments, the coatings have excellent UV stability. As such, these coatings can be useful to protect materials such as wood, metal, stone, masonry, plastic, composites, fabrics, and the like. In certain embodiments, the present invention encompasses such coatings and coated articles.

In other embodiments, the polyurethane dispersions of the present invention are suitable for use as adhesives. In certain embodiments, the present invention encompasses polyurethane adhesives containing any of the polyurethane dispersions or prepolymers described hereinabove, as well as articles of manufacture in which parts are joined using the novel adhesives.

### V. Methods of Making

In another aspect, the present invention encompasses methods of making the compositions described above.

In certain embodiments, methods of the present invention include the steps of:
a) providing an aliphatic polycarbonate polyol of formula P1,

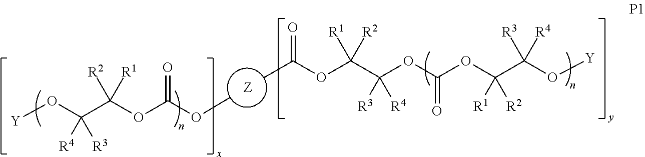

wherein, R¹, R², R³, R⁴, Y, n, [symbol] , x and y are at each occurrence as defined above and described in the classes and subclasses herein,
b) contacting the aliphatic polycarbonate polyol with one or more reagents having a plurality of isocyanate groups, optionally in the presence of one or more coreactants capable of reacting with isocyanate groups, where the coreactants are selected from any of those disclosed hereinabove and in Appendix II;
c) allowing the polyol to react with the reagent having a plurality of isocyanate groups to form a prepolymer; and
d) treating the prepolymer with a reagent containing the combination of i) a siloxy group and ii) a functional group reactive toward the prepolymer chain ends, such that the chain ends become end-capped with a new moiety comprising a siloxy group.

In certain embodiments, the prepolymer formed in step (c) has hydroxyl end groups and the reagent provided in step (d) comprises an isocyanate group. In certain embodiments, such reagents have a formula OCN—(CH₂)_{z}—Si(OR)₃, where z is an integer from 2 to 20 and R is a C₁₋₆ aliphatic group. In certain embodiments, the reagent in step (d) is selected from the group consisting of OCN—CH₂CH₂CH₂Si(OMe)₃ and OCN—CH₂CH₂CH₂Si(OEt)₃.

In other embodiments, the reagent in step (d) is selected from the group consisting of:

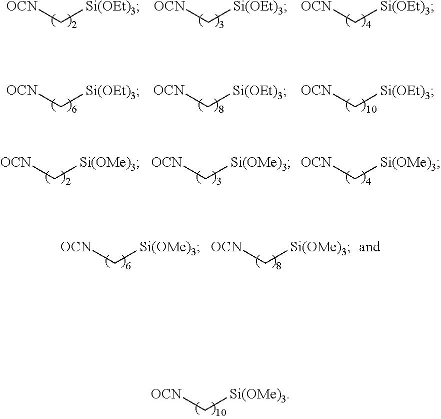

In other embodiments, the reagent in step (d) is selected from the group consisting of:

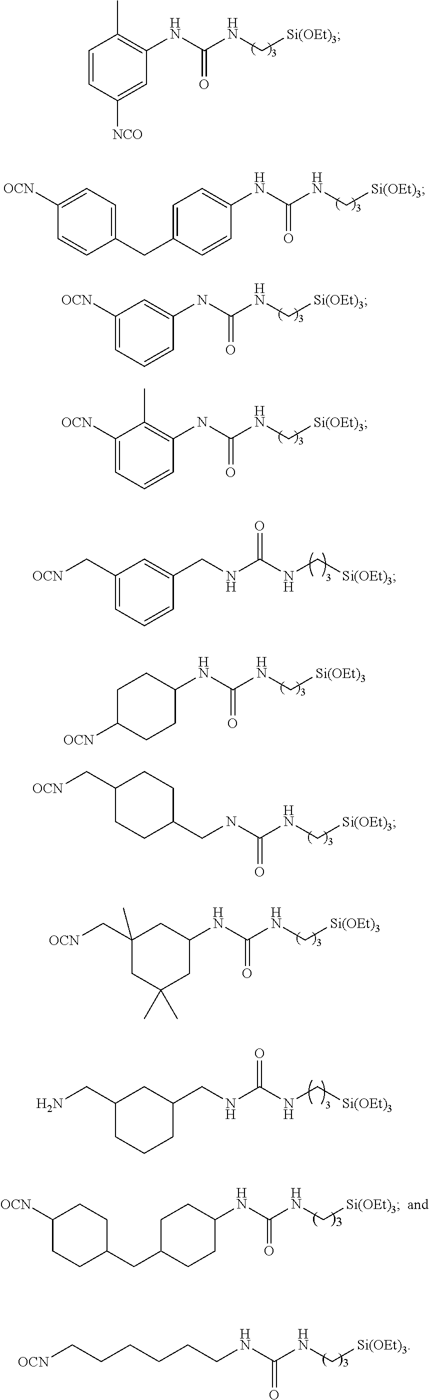

In other embodiments, the reagent in step (d) is selected from the group consisting of:

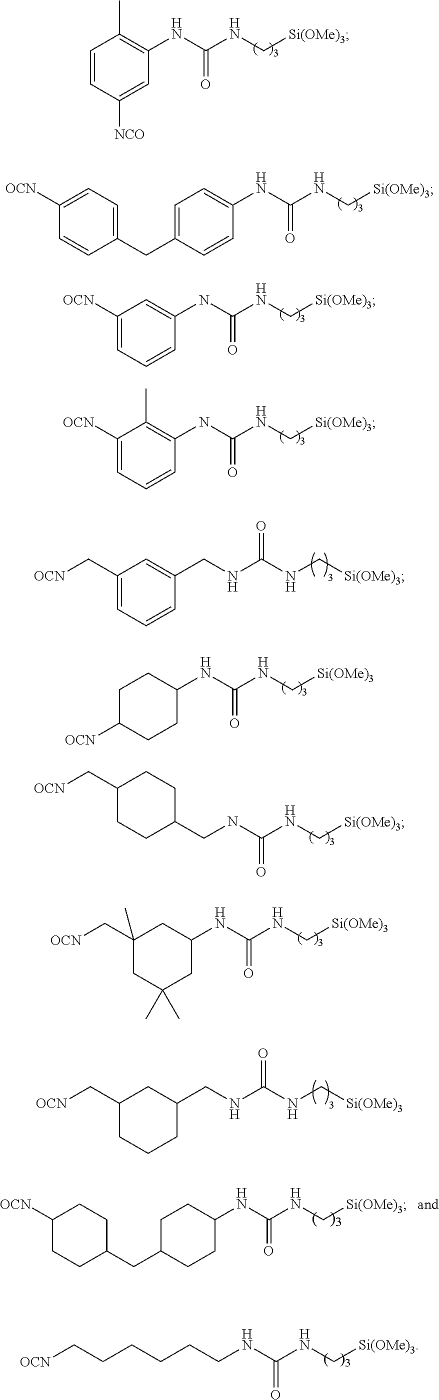

In certain embodiments, the prepolymer formed in step (c) has isocyanate end groups and the reagent used in step (d) comprises the combination of an amine or a thiol group and a siloxy group. In certain embodiments, the reagent in step (d) comprises a mercaptosilane. In certain embodiments, a reagent is selected from the group consisting of: such as 2-mercaptoethyl trimethoxysilane, 3-mercaptopropyl trimethoxysilane, 2-mercaptopropyl triethoxysilane, 3-mercaptopropyl triethoxysilane, 2-mercaptoethyl tripropoxysilane, 2-mercaptoethyl tri sec-butoxysilane, 3-mercaptopropyl tri-t-butoxysilane, 3-mercaptopropyl triisopropoxysilane, 3-mercaptopropyl trioctoxysilane, 2-mercaptoethyl tri-2′-ethylhexoxysilane, 2-mercaptoethyl dimethoxy ethoxysilane, 3-mercaptopropyl methoxyethoxypropoxysilane, 3-mercaptopropyl dimethoxy methylsilane, 3-mercaptopropyl methoxy dimethylsilane, 3-mercaptopropyl ethoxy dimethylsilane, 3-mercaptopropyl diethoxy methylsilane, 3-mercaptopropyl cyclohexoxy dimethyl silane, 4-mercaptobutyl trimethoxysilane, 3-mercapto-3-methylpropyltrimethoxysilane, 3-mercapto-3-methylpropyl-tripropoxysilane, 3-mercapto-3-ethylpropyl-dimethoxy methylsilane, 3-mercapto-2-methylpropyl trimethoxysilane, 3-mercapto-2-methylpropyl dimethoxyphenylsilane, 3-mercaptocyclohexyl-trimethoxysilane, 12-mercaptododecyl trimethoxy silane, 12-mercaptododecyl-triethoxy silane, 18-mercaptooctadecyl trimethoxysilane, 18-mercaptooctadecyl methoxydimethylsilane, 2-mercapto-2-methylethyltripropoxysilane, 2-mercapto-2-methylethyl-trioctoxysilane, 2-mercaptophenyl trimethoxysilane, 2-mercaptophenyl triethoxysilane, 2-mercaptotolyl trimethoxysilane, 2-mercaptotolyl triethoxysilane, 1-mercaptomethyltolyl trimethoxysilane, 1-mercaptomethyltolyltri ethoxysilane, 2-mercaptoethylphenyl trimethoxysilane, 2-mercaptoethylphenyl triethoxysilane, 2-mercaptoethyltolyl trimethoxysilane, 2-mercaptoethyltolyl triethoxysilane, 3-mercaptopropylphenyl trimethoxysilane and, 3-mercaptopropylphenyl triethoxysilane.

In certain embodiments, where the prepolymer formed in step (c) has isocyanate end groups, the reagent used in step (d) comprises an aminosilane. In certain embodiments, the reagent is selected from the group consisting of: 3-aminopropyltrimethoxysilane, 3-aminopropyltriethoxysilane, 4-aminobutyltriethoxysilane, N-methyl-3-amino-2-methylpropyltrimethoxysilane, N-ethyl-3-amino-2-methylpropyltrimethoxysilane, N-ethyl-3-amino-2 methylpropyldiethoxymethyl silane, N-ethyl-3-amino-2 methylpropyltriethoxysilane, N-ethyl-3-amino-2-methylpropylmethyldimethoxysilane, N-butyl-3-amino-2-methylpropyltrimethoxysilane, 3-(N-methyl-2-amino-1 methyl-1-ethoxy)-propyltrimethoxysilane, N-ethyl-4 amino-3,3-dimethyl-butyldimethoxymethyl silane, N-ethyl 4-amino-3,3-dimethylbutyltrimethoxy-silane, N-(cyclohexyl)-3-a minopropyltrimethoxysilane, N-(2-aminoethyl)-3-aminopropyltrimethoxysilane, N-(2-aminoethyl)-3-aminopropyltriethoxy-silane, N-(2-aminoethyl)-3 aminopropylmethyldimethoxysilane, aminopropyltriethoxysilane, bis-(3-trimethoxysilyl-2-methylpropyl)amine and N-(3′-trimethoxysilylpropyl)-3-amino-2-methylpropyltrimethoxysilane.

In certain embodiments of the methods, the aliphatic polycarbonate polyol provided in step (a), the reagents having a plurality of isocyanate groups provided in step (b), and the optional coreactants utilized in step (b) are independently selected from any of the specific embodiments of those materials defined above and in the Appendices and described in the classes and subclasses herein.

In certain embodiments, the aliphatic polycarbonate polyol provided in step (a) is selected from the group consisting of P2, P3, P4, P5, P6, P7, P8 and mixtures of two or more of these, where P2-P8 are as defined above and described in the classes and subclasses herein.

In certain embodiments, the aliphatic polycarbonate polyol provided in step (a) is selected from the group consisting of compounds P2a through P2r-a where each P2 compound is as defined above and described in the classes and subclasses herein.

In certain embodiments, the aliphatic polycarbonate polyol provided in step (a) is selected from the group consisting of Q1, Q2, Q3, Q4, and mixtures of any of these.

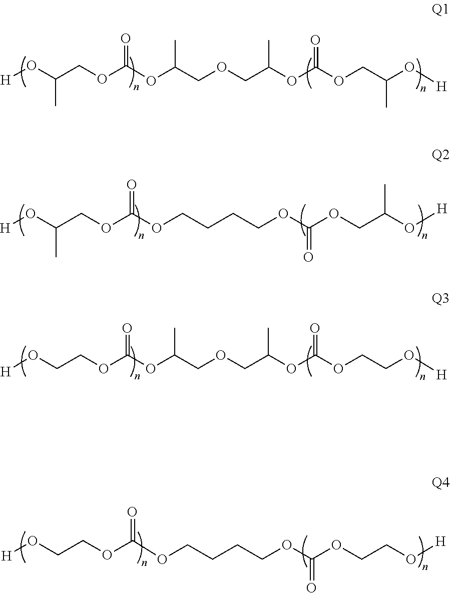

In certain embodiments, the aliphatic polycarbonate polyol provided in step (a) is selected from the group consisting of:
Poly(propylene carbonate) of formula Q1 having an average molecular weight number of between about 500 g/mol and about 3,000 g/mol (e.g. each n is between about 3 and about 15), a polydisperisty index less than about 1.25, at least 95% carbonate linkages, and at least 98%—OH end groups;
Poly(propylene carbonate) of formula Q1 having an average molecular weight number of about 500 g/mol (e.g. n is on average between about 3.5 and about 4.5), a polydisperisty index less than about 1.25, at least 95% carbonate linkages, and at least 98%—OH end groups;
Poly(propylene carbonate) of formula Q1 having an average molecular weight number of about 1,000 g/mol (e.g. n is on average between about 3.5 and about 4.5), a polydisperisty index less than about 1.25, at least 95% carbonate linkages, and at least 98%—OH end groups;
Poly(propylene carbonate) of formula Q1 having an average molecular weight number of about 2,000 g/mol (e.g. n is on average between about 8 and about 9.5), a polydisperisty index less than about 1.25, at least 95% carbonate linkages, and at least 98%—OH end groups;
Poly(propylene carbonate) of formula Q1 having an average molecular weight number of about 3,000 g/mol (e.g. n is on average between about 13 and about 15), a polydisperisty index less than about 1.25, at least 95% carbonate linkages, and at least 98%—OH end groups;
Poly(propylene carbonate) of formula Q2 having an average molecular weight number of between about 500 g/mol and about 3,000 g/mol (e.g. each n is between about 3 and about 15), a polydisperisty index less than about 1.25, at least 95% carbonate linkages, and at least 98%—OH end groups;
Poly(propylene carbonate) of formula Q2 having an average molecular weight number of about 500 g/mol (e.g. n is on average between about 3.5 and about 4.5), a polydisperisty index less than about 1.25, at least 95% carbonate linkages, and at least 98%—OH end groups;
Poly(propylene carbonate) of formula Q2 having an average molecular weight number of about 1,000 g/mol (e.g. n is on average between about 3.5 and about 4.5), a polydisperisty index less than about 1.25, at least 95% carbonate linkages, and at least 98%—OH end groups;
Poly(propylene carbonate) of formula Q2 having an average molecular weight number of about 2,000 g/mol (e.g. n is on average between about 8 and about 9.5), a polydisperisty index less than about 1.25, at least 95% carbonate linkages, and at least 98%—OH end groups;
Poly(propylene carbonate) of formula Q2 having an average molecular weight number of about 3,000 g/mol (e.g. n is on average between about 13 and about 15), a polydisperisty index less than about 1.25, at least 95% carbonate linkages, and at least 98%—OH end groups;
Poly(ethylene carbonate) of formula Q3 having an average molecular weight number of between about 500 g/mol and about 3,000 g/mol (e.g. each n is between about 4 and about 16), a polydisperisty index less than about 1.25, at least 95% carbonate linkages, and at least 98%—OH end groups;
Poly(ethylene carbonate) of formula Q3 having an average molecular weight number of about 500 g/mol (e.g. n is on average between about 4 and about 5), a polydisperisty index less than about 1.25, at least 85% carbonate linkages, and at least 98%—OH end groups;
Poly(ethylene carbonate) of formula Q3 having an average molecular weight number of about 1,000 g/mol (e.g. n is on average between about 4 and about 5), a polydisperisty index less than about 1.25, at least 85% carbonate linkages, and at least 98%—OH end groups;
Poly(ethylene carbonate) of formula Q3 having an average molecular weight number of about 2,000 g/mol (e.g. n is on average between about 10 and about 11), a polydisperisty index less than about 1.25, at least 85% carbonate linkages, and at least 98%—OH end groups;
Poly(ethylene carbonate) of formula Q3 having an average molecular weight number of about 3,000 g/mol (e.g. n is on average between about 15 and about 17), a polydisperisty index less than about 1.25, at least 85% carbonate linkages, and at least 98%—OH end groups;
Poly(ethylene carbonate) of formula Q4 having an average molecular weight number of between about 500 g/mol and about 3,000 g/mol (e.g. each n is between about 4 and about 16), a polydisperisty index less than about 1.25, at least 85% carbonate linkages, and at least 98%—OH end groups;
Poly(ethylene carbonate) of formula Q4 having an average molecular weight number of about 500 g/mol (e.g. n is on average between about 4 and about 5), a polydisperisty index less than about 1.25, at least 85% carbonate linkages, and at least 98%—OH end groups;
Poly(ethylene carbonate) of formula Q4 having an average molecular weight number of about 1,000 g/mol (e.g. n is on average between about 4 and about 5), a polydisperisty index less than about 1.25, at least 85% carbonate linkages, and at least 98%—OH end groups;
Poly(ethylene carbonate) of formula Q4 having an average molecular weight number of about 2,000 g/mol (e.g. n is on average between about 10 and about 11), a polydisperisty index less than about 1.25, at least 85% carbonate linkages, and at least 98%—OH end groups; and
Poly(ethylene carbonate) of formula Q4 having an average molecular weight number of about 3,000 g/mol (e.g. n is on average between about 15 and about 17), a polydisperisty index less than about 1.25, at least 85% carbonate linkages, and at least 98%—OH end groups.

In certain embodiments, the reagent having a plurality of isocyanate groups utilized in step (b) is selected from the group consisting of: aliphatic diisocyanates, aromatic diisocyanates, oligomeric diisocyanates, and difunctional isocyanate prepolymers.

In certain embodiments, the reagent having a plurality of isocyanate groups utilized in step (b) comprises one or more aliphatic diisocyanates. In certain embodiments, the reagent having a plurality of isocyanate groups utilized in step (b) is selected from the group consisting of: HDI, IPDI, H₁₂MDI, H6-XDI, TMDI, 1,4-cyclohexyl diisocyanate, 1,4-tetramethylene diisocyanate, trimethylhexane diisocyanate, and mixtures of any two or more of these. In certain embodiments, the reagent having a plurality of isocyanate groups utilized in step (b) is selected from the group consisting of: HDI, IPDI, H₁₂MDI and mixtures of two or more of these. In certain embodiments, the reagent having a plurality of isocyanate groups utilized in step (b) comprises HDI. In certain embodiments, the reagent having a plurality of isocyanate groups utilized in step (b) comprises IPDI. In certain embodiments, the reagent having a plurality of isocyanate groups utilized in step (b) comprises H12MDI. In certain embodiments, the reagent having a plurality of isocyanate groups utilized in step (b) comprises H6-XDI. In certain embodiments, the reagent having a plurality of isocyanate groups utilized in step (b) comprises TMDI. In certain embodiments, the reagent having a plurality of isocyanate groups utilized in step (b) comprises oligomers or derivatives of any of the above aliphatic isocyanates. In certain embodiments, the reagent having a plurality of isocyanate groups utilized in step (b) comprises biurets of any of the above aliphatic isocyanates.

In certain embodiments, the reagent having a plurality of isocyanate groups utilized in step (b) comprises one or more aromatic diisocyanates. In certain embodiments, the reagent having a plurality of isocyanate groups utilized in step (b) is selected from the group consisting of: 2,4-TDI, 2,6-TDI, MDI, XDI, TMXDI, and mixtures of any two or more of these. In certain embodiments, the reagent having a plurality of isocyanate groups utilized in step (b) is selected from the group consisting of: TDI and MDI. In certain embodiments, the reagent having a plurality of isocyanate groups utilized in step (b) comprises TDI. In certain embodiments, the reagent having a plurality of isocyanate groups utilized in step (b) comprises 2,4-TDI. In certain embodiments, the reagent having a plurality of isocyanate groups utilized in step (b) comprises 2,6-TDI. In certain embodiments, the reagent having a plurality of isocyanate groups utilized in step (b) comprises H6-XDI. In certain embodiments, the reagent having a plurality of isocyanate groups utilized in step (b) comprises MDI. In certain embodiments, the reagent having a plurality of isocyanate groups utilized in step (b) comprises XDI. In certain embodiments, the reagent having a plurality of isocyanate groups utilized in step (b) comprises TMXDI. In certain embodiments, the reagent having a plurality of isocyanate groups utilized in step (b) comprises oligomers or derivatives of any of the above aromatic isocyanates. In certain embodiments, the reagent having a plurality of isocyanate groups utilized in step (b) comprises biurets of any of the above aromatic isocyanates.

In certain embodiments, the reagent having a plurality of isocyanate groups utilized in step (b) comprises any one or more of the materials in Table 1. In certain embodiments, the reagent having a plurality of isocyanate groups utilized in step (b) comprises any one or more of the materials in Table 2. In certain embodiments, the reagent having a plurality of isocyanate groups utilized in step (b) comprises any one or more of the materials in Table 3. In certain embodiments, the reagent having a plurality of isocyanate groups utilized in step (b) is selected from the group consisting of: Easaqua™ WAT; Easaqua™ WAT-1; Easaqua™ WT 1000; Easaqua™ WT 2102; Easaqua™ X D 401; Easaqua™ X D 803; Easaqua™ X M 501; Easaqua™ X M 502; Easaqua™ X WAT-3; and Easaqua™ X WAT-4.

In certain embodiments, the method further includes controlling the ratio of the aliphatic polycarbonate polyol and, if present, the one or more coreactants, to the reagents having a plurality of isocyanate groups such that there is a molar excess of isocyanate groups.

In certain embodiments, the step of contacting aliphatic polycarbonate polyol with the reagent having a plurality of isocyanate groups is performed in the presence of a solvent. In certain embodiments, the step is performed in a non-protic polar organic solvent. In certain embodiments, the step is performed in acetone. In certain embodiments, the step is performed in NMP.

In certain embodiments, where the prepolymer is formed in an organic solvent, the method further comprises mixing the solution of prepolymer thus formed with water and then distilling off at least a portion of the organic solvent.

In certain embodiments, step (b) further includes providing one or more catalysts. In certain embodiments, catalysts provided in step (b) include tin based materials. In certain embodiments, catalysts provided in step (b) are selected from the group consisting of di-butyl tin dilaurate, dibutylbis(laurylthio)stannate, dibutyltinbis(isooctylmercapto acetate) and dibutyltinbis(isooctylmaleate), tin octaoate and mixtures of any of these. In certain embodiments, catalysts provided in step (b) include tertiary amines. In certain embodiments, catalysts provided in step (b) are selected from the group consisting of: DABCO, pentamethyldipropylenetriamine, bis(dimethylamino ethyl ether), pentamethyldiethylenetriamine, DBU phenol salt, dimethylcyclohexylamine, 2,4,6-tris(N,N-dimethylaminomethyl)phenol (DMT-30), 1,3,5-tris(3-dimethylaminopropyl)hexahydro-s-triazine, ammonium salts and combinations of any of these.

In certain embodiments, one or more coreactants are provided in step (b). In certain embodiments, the coreactant provided is selected from the group consisting of: other types of polyols (e.g. polyether polyols, polyester polyols, acrylics, or other polycarbonate polyols), and small molecules with functional groups reactive toward isocyanates such as hydroxyl groups, amino groups, thiol groups, and the like. In certain embodiments, coreactants, comprise molecules with two or more functional groups reactive toward isocyanates.

In certain embodiments, a coreactant provided in step (b) comprises a polyhydric alcohol. In certain embodiments, a coreactant provided in step (b) comprises a dihydric alcohol. In certain embodiments, the dihydric alcohol provided in step (b) comprises a C₂₋₄₀ diol. In certain embodiments, the dihydric alcohol provided in step (b) is selected from the group consisting of: 1,2-ethanediol, 1,2-propanediol, 1,3-propanediol, 1,2-butanediol, 1,3-butanediol, 1,4-butanediol, 1,5-pentanediol, 2,2-dimethylpropane-1,3-diol, 2-butyl-2-ethylpropane-1,3-diol, 2-methyl-2,4-pentane diol, 2-ethyl-1,3-hexane diol, 2-methyl-1,3-propane diol, 1,5-hexanediol, 1,6-hexanediol, 1,8-octanediol, 1,10-decanediol, 1,12-dodecanediol, 2,2,4,4-tetramethylcyclobutane-1,3-diol, 1,3-cyclopentanediol, 1,2-cyclohexanediol, 1,3-cyclohexanediol, 1,4-cyclohexanediol, 1,2-cyclohexanedimethanol, 1,3-cyclohexanedimethanol, 1,4-cyclohexanedimethanol, 1,4-cyclohexanediethanol, isosorbide, glycerol monoesters, glycerol monoethers, trimethylolpropane monoesters, trimethylolpropane monoethers, pentaerythritol diesters, pentaerythritol diethers, and alkoxylated derivatives of any of these.

In certain embodiments, a coreactant provided in step (b) comprises a dihydric alcohol selected from the group consisting of: diethylene glycol, triethylene glycol, tetraethylene glycol, higher poly(ethylene glycol), such as those having number average molecular weights of from 220 to about 2000 g/mol, dipropylene glycol, tripropylene glycol, and higher poly(propylene glycols) such as those having number average molecular weights of from 234 to about 2000 g/mol.

In certain embodiments, a coreactant provided in step (b) comprises an alkoxylated derivative of a compound selected from the group consisting of: a diacid, a diol, or a hydroxy acid. In certain embodiments, the alkoxylated derivatives comprise ethoxylated or propoxylated compounds.

In certain embodiments, a coreactant provided in step (b) comprises a polymeric diol. In certain embodiments, the polymeric diol provided in step (b) is selected from the group consisting of polyethers, polyesters, hydroxy-terminated polyolefins, polyether-copolyesters, polyether polycarbonates, polycarbonate-copolyesters, and alkoxylated analogs of any of these. In certain embodiments, the polymeric diol has an average molecular weight less than about 2000 g/mol

In some embodiments, a coreactant provided in step (b) comprises a triol or higher polyhydric alcohol. In certain embodiments, a coreactant provided in step (b) is selected from the group consisting of: glycerol, 1,2,4-butanetriol, 2-(hydroxymethyl)-1,3-propanediol; hexane triols, trimethylol propane, trimethylol ethane, trimethylolhexane, 1,4-cyclohexanetrimethanol, pentaerythritol mono esters, pentaerythritol mono ethers, and alkoxylated analogs of any of these. In certain embodiments, alkoxylated derivatives comprise ethoxylated or propoxylated compounds.

In some embodiments, a coreactant provided in step (b) comprises a polyhydric alcohol with four to six hydroxy groups. In certain embodiments, a coreactant present in step (b) comprises dipentaerithrotol or an alkoxylated analog thereof. In certain embodiments, coreactant present in step (b) comprises sorbitol or an alkoxylated analog thereof.

In certain embodiments, a functional coreactant provided in step (b) comprises a polyhydric alcohol containing one or more moieties that can be converted to an ionic functional group. In certain embodiments, the moiety that can be converted to an ionic functional group is selected from the group consisting of: carboxylic acids, esters, anhydrides, sulfonic acids, sulfamic acids, phosphates, and amino groups.

In certain embodiments, a coreactant provided in step (b) comprises a hydroxy-carboxylic acid having the general formula (HO)ₓQ(COOH)_{y}, wherein Q is a straight or branched hydrocarbon radical containing 1 to 12 carbon atoms, and x and y are each integers from 1 to 3. In certain embodiments, a coreactant provided in step (b) comprises a diol carboxylic acid. In certain embodiments, a coreactant provided in step (b) comprises a bis(hydroxylalkyl)alkanoic acid. In certain embodiments, a coreactant provided in step (b) comprises a bis(hydroxylmethyl)alkanoic acid. In certain embodiments the diol carboxylic acid provided in step (b) is selected from the group consisting of 2,2 bis-(hydroxymethyl)-propanoic acid (dimethylolpropionic acid, DMPA) 2,2-bis(hydroxymethyl) butanoic acid (dimethylolbutanoic acid; DMBA), dihydroxysuccinic acid (tartaric acid), and 4,4′-bis(hydroxyphenyl) valeric acid. In certain embodiments, a coreactant comprises an N,N-bis(2-hydroxyalkyl)carboxylic acid.

In certain embodiments, a coreactant provided in step (b) comprises a polyhydric alcohol containing a sulfonic acid functional group. In certain embodiments, a coreactant comprises a diol sulfonic acid. In certain embodiments, a polyhydric alcohol containing a sulfonic acid is selected from the group consisting of: 2-hydroxymethyl-3-hydroxypropane sulfonic acid, 2-Butene-1,4-diol-2-sulfonic acid, and materials disclosed in U.S. Pat. No. 4,108,814 and US Pat. App. Pub. No. 2010/0273029 the entirety of each of which is incorporated herein by reference.

In certain embodiments, a coreactant provided in step (b) comprises a polyhydric alcohol containing a sulfamic acid functional group. In certain embodiments, a polyhydric alcohol containing a sulfamic acid is selected from the group consisting of: [N,N-bis(2-hydroxyalkyl)sulfamic acid (where each alkyl group is independently a C₂₋₆ straight chain, branched or cyclic aliphatic group) or epoxide adducts thereof (the epoxide being ethylene oxide or propylene oxide for instance, the number of moles of epoxide added being 1 to 6) also epoxide adducts of sulfopolycarboxylic acids [e.g. sulfoisophthalic acid, sulfosuccinic acid, etc.], and aminosulfonic acids [e.g. 2-aminoethanesulfonic acid, 3-aminopropanesulfonic acid, etc.].

In certain embodiments, a coreactant a coreactant provided in step (b) comprises a polyhydric alcohol containing a phosphate group. In certain embodiments, a coreactant comprises a bis(2-hydroxalkyl) phosphate (where each alkyl group is independently a C₂₋₆ straight chain, branched or cyclic aliphatic group). In certain embodiments, a coreactant a coreactant provided in step (b) comprises bis(2-hydroxethyl) phosphate.

In certain embodiments, a coreactant a coreactant provided in step (b) comprises a polyhydric alcohol comprising one or more amino groups. In certain embodiments, a coreactant a coreactant provided in step (b) comprises an amino diol. In certain embodiments, a coreactant a coreactant provided in step (b) comprises a diol containing a tertiary amino group. In certain embodiments, a coreactant provided in step (b) is selected from the group consisting of: diethanolamine (DEA), N-methyldiethanolamine (MDEA), N-ethyldiethanolamine (EDEA), N-butyldiethanolamine (BDEA), N,N-bis(hydroxyethyl)-α-amino pyridine, dipropanolamine, diisopropanolamine (DIPA), N-methyldiisopropanolamine, Diisopropanol-p-toluidine, N,N-Bis(hydroxyethyl)-3-chloroaniline, 3-diethylaminopropane-1,2-diol, 3-dimethylaminopropane-1,2-diol and N-hydroxyethylpiperidine. In certain embodiments, a coreactant a coreactant provided in step (b) comprises a diol containing a quaternary amino group. In certain embodiments, a coreactant a coreactant provided in step (b) is an acid salt or quaternized derivative of any of the amino alcohols described above.

Compounds having at least one crosslinkable functional group can also be provided in step (b), if desired. Examples of such compounds include those having carbonyl, amine, epoxy, acetoacetoxy, urea-formaldehyde, auto-oxidative groups that crosslink via oxidization, ethylenically unsaturated groups optionally with UV light activation, olefinic and hydrazide groups, blocked isocyanates, and the like, and mixtures of such groups and the same groups in protected forms.

In certain embodiments, a functional coreactant is provided in step (b), wherein the functional coreactant provides hydrophilic characteristics to the resulting chain-extended composition.

In certain embodiments, a functional coreactant is provided in step (b) comprises hydrophilic groups, ionic groups, or precursors to ionic groups any of which may act as internal emulsifiers and thereby aid in the formation of stable aqueous dispersions of the inventive compositions. In certain embodiments, such functional coreactants comprise precursors of ionic groups. In certain embodiments, functional coreactants comprise precursors of cationic groups. In certain embodiments, functional coreactants comprise precursors of anionic groups.

In certain embodiments, where a coreactant provided in step (b) contains a precursor of an ionic group, the method further comprises a step after step (c) of treating the prepolymer with a reagent to convert the precursor of an ionic group into an ionic group.

In certain embodiments, a coreactant provided in step (b) comprises a carboxylic acid moiety and the method further comprises a step of treating the prepolymer with a base to form a carboxylate salt.

In certain embodiments, a coreactant provided in step (b) comprises an amine moiety and the method further comprises a step of treating the prepolymer with an acid or an alkylating agent to form an ammonium salt.

In certain embodiments, methods of the present invention further comprise the step of dispersing the prepolymer from step (c) in water.

In certain embodiments, the step of dispersing the prepolymer is performed in the presence of one or more chain-extending reagents wherein the chain extending reagents have a plurality of functional groups reactive toward isocyanates. In certain embodiments, the chain extending reagent is dissolved in the aqueous phase prior to or during the step of dispersing the prepolymer.

In certain embodiments, the method includes dispersing the prepolymer from step (c) into water in the presence of a polyamine compound.

In certain embodiments, the method includes dispersing the prepolymer from step (c) into water in the presence of a compound selected from the group consisting of: mono-, bis- or polyalkoxylated aliphatic, cycloaliphatic, aromatic or heterocyclic primary amines, N-methyl diethanolamine, N-ethyl diethanolamine, N-propyl diethanolamine, N-isopropyl diethanolamine, N-butyl diethanolamine, N-isobutyl diethanolamine, N-oleyl diethanolamine, N-stearyl diethanolamine, ethoxylated coconut oil fatty amine, N-allyl diethanolamine, N-methyl diisopropanolamine, N-ethyl diisopropanolamine, N-propyl diisopropanolamine, N-butyl diisopropanolamine, cyclohexyl diisopropanolamine, N,N-diethoxylaniline, N,N-diethoxyl toluidine, N,N-diethoxyl-1-aminopyridine, N,N′-diethoxyl piperazine, dimethyl-bis-ethoxyl hydrazine, N,N′-bis-(2-hydroxyethyl)-N,N′-diethylhexahydrop-phenylenediamine, N-12-hydroxyethyl piperazine, polyalkoxylated amines, propoxylated methyl diethanolamine, N-methyl-N,N-bis-3-aminopropylamine, N-(3-aminopropyl)-N,N′-dimethyl ethylenediamine, N-(3-aminopropyl)-N-methyl ethanolamine, N,N′-bis-(3-aminopropyl)-N,N′-dimethyl ethylenediamine, N,N′-bis-(3-aminopropyl)-piperazine, N-(2-aminoethyl)-piperazine, N,N′-bisoxyethyl propylenediamine, 2,6-diaminopyridine, diethanolaminoacetamide, diethanolamidopropionamide, N,N-bisoxyethylphenyl thiosemicarbazide, N,N-bis-oxyethylmethyl semicarbazide, p,p′-bis-aminomethyl dibenzyl methylamine, 2,6-diaminopyridine, 2-dimethylaminomethyl-2-methylpropanel, 3-diol. In certain embodiments, chain-extending agents are compounds that contain two amino groups. In certain embodiments, chain-extending agents are selected from the group consisting of: ethylene diamine, 1,6-hexamethylene diamine, and 1,5-diamino-1-methyl-pentane.

In certain embodiments, the method includes dispersing the prepolymer from step (c) into water in the presence of a compound selected from the group consisting of: diethylene triamine (DETA), ethylene diamine (EDA), meta-xylylenediamine (MXDA), aminoethyl ethanolamine (AEEA), 2-methyl pentane diamine, and mixtures thereof.

In certain embodiments, the method includes dispersing the prepolymer from step (c) into water in the presence of a compound selected from the group consisting of: propylene diamine, butylene diamine, hexamethylene diamine, cyclohexylene diamine, phenylene diamine, tolylene diamine, 3,3-dichlorobenzidene, 4,4′-methylene-bis-(2-chloroaniline), 3,3-dichloro-4,4-diamino diphenylmethane, and sulfonated primary and/or secondary amines.

In certain embodiments, the method includes dispersing the prepolymer from step (c) into water in the presence of a polyalcohol. In certain embodiments, the polyalcohol has from 2 to 12 carbon atoms. In certain embodiments, the polyalcohol has from 2 to 8 carbon atoms. In certain embodiments, the method includes dispersing the prepolymer from step (c) into water in the presence of a compound selected from the group consisting of: ethylene glycol, diethylene glycol, neopentyl glycol, butanediols, hexanediol, and the like, and mixtures thereof.

In certain embodiments, the methods include a step of providing a chain extending reagent that contains blocked functional groups that are liberated on contact with water and which once liberated will react with isocyanates. In certain embodiments, methods of the present invention include combining the prepolymer with a blocked chain extending reagent. In certain embodiments the methods include a step of dispersing the combination of prepolymer and blocked chain extending reagent into water. In certain embodiments, the method includes dispersing the prepolymer from step (c) into water in the presence of a compound selected from the group consisting of: hydrazine, substituted hydrazines, hydrazine reaction products, and the like, and mixtures thereof.

In certain embodiments, methods of the present invention comprise the step of applying any of the above described polyurethane compositions to a surface. In certain embodiments, such methods further include the step of allowing the water to evaporate from the dispersion.

The complete disclosures of all patents, patent applications including provisional patent applications, and publications, and electronically available material cited herein are incorporated by reference. The foregoing detailed description and examples have been provided for clarity of understanding only. No unnecessary limitations are to be understood therefrom. The invention is not limited to the exact details shown and described; many variations will be apparent to one skilled in the art and are intended to be included within the invention defined by the claims.

### APPENDIX I

### Polycarbonate Polyols

This section describes some of the aliphatic polycarbonate polyols that have utility in producing compositions of the present invention. In certain embodiments, compositions of the present invention comprise aliphatic polycarbonate polyols derived from the copolymerization of one or more epoxides and carbon dioxide. Examples of suitable polyols, as well as methods of making them are disclosed in PCT publication WO2010/028362 the entirety of which is incorporated herein by reference.

It is advantageous for many of the embodiments described herein that the aliphatic polycarbonate polyols used have a high percentage of reactive end groups. In certain embodiments, at least 90% of the end groups of the polycarbonate polyol used are —OH groups. In certain embodiments, at least 95%, at least 96%, at least 97% or at least 98% of the end groups of the polycarbonate polyol used are —OH groups. In certain embodiments, more than 99%, more than 99.5%, more than 99.7%, or more than 99.8% of the end groups of the polycarbonate polyol used are —OH groups. In certain embodiments, more than 99.9% of the end groups of the polycarbonate polyol used are —OH groups.

Another way of expressing the —OH end-group content of a polyol composition is by reporting its OH# which is measured using methods well known in the art. In certain embodiments, the aliphatic polycarbonate polyols used in the present invention have an OH# greater than about 20. In certain embodiments, the aliphatic polycarbonate polyols utilized in the present invention have an OH# greater than about 40. In certain embodiments, the aliphatic polycarbonate polyols have an OH# greater than about 50, greater than about 75, greater than about 100, or greater than about 120.

In certain embodiments, it is advantageous if the aliphatic polycarbonate polyol compositions have a substantial proportion of primary hydroxyl end groups. These are the norm for compositions comprising poly(ethylene carbonate), but for polyols derived copolymerization of substituted epoxides with CO₂, it is common for some or most of the chain ends to consist of secondary hydroxyl groups. In certain embodiments, such polyols are treated to increase the proportion of primary —OH end groups. This may be accomplished by reacting the secondary hydroxyl groups with reagents such as ethylene oxide, reactive lactones, and the like. In certain embodiments, the aliphatic polycarbonate polyols are treated with beta lactones, caprolactone and the like to introduce primary hydroxyl end groups. In certain embodiments, the aliphatic polycarbonate polyols are treated with ethylene oxide to introduce primary hydroxyl end groups.

In certain embodiments, aliphatic polycarbonate chains comprise a copolymer of carbon dioxide and one or more epoxides. In certain embodiments, aliphatic polycarbonate chains comprise a copolymer of carbon dioxide and ethylene oxide. In certain embodiments, aliphatic polycarbonate chains comprise a copolymer of carbon dioxide and propylene oxide. In certain embodiments, aliphatic polycarbonate chains comprise a copolymer of carbon dioxide and 1,2-butene oxide and/or 1,2-hexene oxide. In certain embodiments, aliphatic polycarbonate chains comprise a copolymer of carbon dioxide and cyclohexene oxide. In certain embodiments, aliphatic polycarbonate chains comprise a copolymer of carbon dioxide and cyclopentene oxide. In certain embodiments, aliphatic polycarbonate chains comprise a copolymer of carbon dioxide and 3-vinyl cyclohexene oxide. In certain embodiments, aliphatic polycarbonate chains comprise a copolymer of carbon dioxide and 3-ethyl cyclohexene oxide.

In certain embodiments, aliphatic polycarbonate chains comprise a terpolymer of carbon dioxide and ethylene oxide along with one or more additional epoxides selected from the group consisting of propylene oxide, 1,2-butene oxide, 2,3-butene oxide, cyclohexene oxide, 3-vinyl cyclohexene oxide, 3-ethyl cyclohexene oxide, cyclopentene oxide, epichlorohydrin, glicydyl esters, glycidyl ethers, styrene oxides, and epoxides of higher alpha olefins. In certain embodiments, such terpolymers contain a majority of repeat units derived from ethylene oxide with lesser amounts of repeat units derived from one or more additional epoxides. In certain embodiments, terpolymers contain about 50% to about 99.5% ethylene oxide-derived repeat units. In certain embodiments, terpolymers contain greater than about 60% ethylene oxide-derived repeat units. In certain embodiments, terpolymers contain greater than 75% ethylene oxide-derived repeat units. In certain embodiments, terpolymers contain greater than 80% ethylene oxide-derived repeat units. In certain embodiments, terpolymers contain greater than 85% ethylene oxide-derived repeat units. In certain embodiments, terpolymers contain greater than 90% ethylene oxide-derived repeat units. In certain embodiments, terpolymers contain greater than 95% ethylene oxide-derived repeat units.

In embodiments, the aliphatic polycarbonate chains comprise a copolymer of carbon dioxide and propylene oxide along with one or more additional epoxides selected from the group consisting of ethylene oxide, 1,2-butene oxide, 2,3-butene oxide, cyclohexene oxide, 3-vinyl cyclohexene oxide, cyclopentene oxide, epichlorohydrin, glicydyl esters, glycidyl ethers, styrene oxides, and epoxides of higher alpha olefins. In certain embodiments, such terpolymers contain a majority of repeat units derived from propylene oxide with lesser amounts of repeat units derived from one or more additional epoxides. In certain embodiments, terpolymers contain about 50% to about 99.5% propylene oxide-derived repeat units. In certain embodiments, terpolymers contain greater than 60% propylene oxide-derived repeat units. In certain embodiments, terpolymers contain greater than 75% propylene oxide-derived repeat units. In certain embodiments, terpolymers contain greater than 80% propylene oxide-derived repeat units. In certain embodiments, terpolymers contain greater than 85% propylene oxide-derived repeat units. In certain embodiments, terpolymers contain greater than 90% propylene oxide-derived repeat units. In certain embodiments, terpolymers contain greater than 95% propylene oxide-derived repeat units.

In certain embodiments, in the polymer compositions described hereinabove, aliphatic polycarbonate chains have a number average molecular weight (Mₙ) in the range of 500 g/mol to about 250,000 g/mol.

In certain embodiments, aliphatic polycarbonate chains have an Mₙ less than about 100,000 g/mol. In certain embodiments, aliphatic polycarbonate chains have an Mₙ less than about 70,000 g/mol. In certain embodiments, aliphatic polycarbonate chains have an Mₙ less than about 50,000 g/mol. In certain embodiments, aliphatic polycarbonate chains have an Mₙ between about 500 g/mol and about 40,000 g/mol. In certain embodiments, aliphatic polycarbonate chains have an Mₙ less than about 25,000 g/mol. In certain embodiments, aliphatic polycarbonate chains have an Mₙ between about 500 g/mol and about 20,000 g/mol. In certain embodiments, aliphatic polycarbonate chains have an Mₙ between about 500 g/mol and about 10,000 g/mol. In certain embodiments, aliphatic polycarbonate chains have an Mₙ between about 500 g/mol and about 5,000 g/mol. In certain embodiments, aliphatic polycarbonate chains have an Mₙ between about 1,000 g/mol and about 5,000 g/mol. In certain embodiments, aliphatic polycarbonate chains have an Mₙ between about 5,000 g/mol and about 10,000 g/mol. In certain embodiments, aliphatic polycarbonate chains have an Mₙ between about 500 g/mol and about 1,000 g/mol. In certain embodiments, aliphatic polycarbonate chains have an Mₙ between about 1,000 g/mol and about 3,000 g/mol. In certain embodiments, aliphatic polycarbonate chains have an Mₙ of about 5,000 g/mol. In certain embodiments, aliphatic polycarbonate chains have an Mₙ of about 4,000 g/mol. In certain embodiments, aliphatic polycarbonate chains have an Mₙ of about 3,000 g/mol. In certain embodiments, aliphatic polycarbonate chains have an Mₙ of about 2,500 g/mol. In certain embodiments, aliphatic polycarbonate chains have an Mₙ of about 2,000 g/mol. In certain embodiments, aliphatic polycarbonate chains have an Mₙ of about 1,500 g/mol. In certain embodiments, aliphatic polycarbonate chains have an Mₙ of about 1,000 g/mol. In certain embodiments, aliphatic polycarbonate chains have an Mₙ of about 750 g/mol. In certain embodiments, aliphatic polycarbonate chains have an Mₙ of about 500 g/mol.

In certain embodiments, the aliphatic polycarbonate polyols used are characterized in that they have a narrow molecular weight distribution. This can be indicated by the polydispersity indices (PDI) of the aliphatic polycarbonate polymers. In certain embodiments, aliphatic polycarbonate compositions have a PDI less than 3. In certain embodiments, aliphatic polycarbonate compositions have a PDI less than 2. In certain embodiments, aliphatic polycarbonate compositions have a PDI less than 1.8. In certain embodiments, aliphatic polycarbonate compositions have a PDI less than 1.5. In certain embodiments, aliphatic polycarbonate compositions have a PDI less than 1.4. In certain embodiments, aliphatic polycarbonate compositions have a PDI between about 1.0 and 1.2. In certain embodiments, aliphatic polycarbonate compositions have a PDI between about 1.0 and 1.1.

In certain embodiments, the aliphatic polycarbonate polyols used do not have a narrow PDI, this can be the case if, for example, a polydisperse chain transfer agent is used to initiate an epoxide CO₂ copolymerization, or if a plurality of aliphatic polycarbonate polyol compositions with different PDIs are blended. In certain embodiments, aliphatic polycarbonate compositions have a PDI greater than 3. In certain embodiments, aliphatic polycarbonate compositions have a PDI greater than 2. In certain embodiments, aliphatic polycarbonate compositions have a PDI greater than 1.8. In certain embodiments, aliphatic polycarbonate compositions have a PDI greater than 1.5. In certain embodiments, aliphatic polycarbonate compositions have a PDI greater than 1.4.

In certain embodiments, aliphatic polycarbonate compositions of the present invention comprise substantially alternating polymers containing a high percentage of carbonate linkages and a low content of ether linkages.

In certain embodiments, aliphatic polycarbonate compositions of the present invention are characterized in that, on average in the composition, the percentage of carbonate linkages is 85% or greater. In certain embodiments, aliphatic polycarbonate compositions of the present invention are characterized in that, on average in the composition, the percentage of carbonate linkages is 90% or greater. In certain embodiments, aliphatic polycarbonate compositions of the present invention are characterized in that, on average in the composition, the percentage of carbonate linkages is 91% or greater. In certain embodiments, aliphatic polycarbonate compositions of the present invention are characterized in that, on average in the composition, the percentage of carbonate linkages is 92% or greater. In certain embodiments, aliphatic polycarbonate compositions of the present invention are characterized in that, on average in the composition, the percentage of carbonate linkages is 93% or greater. In certain embodiments, aliphatic polycarbonate compositions of the present invention are characterized in that, on average in the composition, the percentage of carbonate linkages is 94% or greater. In certain embodiments, aliphatic polycarbonate compositions of the present invention are characterized in that, on average in the composition, the percentage of carbonate linkages is 95% or greater. In certain embodiments, aliphatic polycarbonate compositions of the present invention are characterized in that, on average in the composition, the percentage of carbonate linkages is 96% or greater. In certain embodiments, aliphatic polycarbonate compositions of the present invention are characterized in that, on average in the composition, the percentage of carbonate linkages is 97% or greater. In certain embodiments, aliphatic polycarbonate compositions of the present invention are characterized in that, on average in the composition, the percentage of carbonate linkages is 98% or greater. In certain embodiments, aliphatic polycarbonate compositions of the present invention are characterized in that, on average in the composition, the percentage of carbonate linkages is 99% or greater. In certain embodiments, aliphatic polycarbonate compositions of the present invention are characterized in that, on average in the composition, the percentage of carbonate linkages is 99.5% or greater. In certain embodiments, the percentages above exclude ether linkages present in polymerization initiators or chain transfer agents and refer only to the linkages formed during epoxide CO₂ copolymerization.

In certain embodiments, aliphatic polycarbonate compositions of the present invention are characterized in that they contain essentially no ether linkages either within the polymer chains derived from epoxide CO₂ copolymerization or within any polymerization intiators, chain transfer agents or end groups that may be present in the polymer. In certain embodiments, aliphatic polycarbonate compositions of the present invention are characterized in that they contain, on average, less than one ether linkage per polymer chain within the composition. In certain embodiments, aliphatic polycarbonate compositions of the present invention are characterized in that they contain essentially no ether linkages.

In certain embodiments where an aliphatic polycarbonate is derived from mono-substituted epoxides (e.g. such as propylene oxide, 1,2-butylene oxide, epichlorohydrin, epoxidized alpha olefins, or a glycidol derivative), the aliphatic polycarbonate is characterized in that it is regioregular. Regioregularity may be expressed as the percentage of adjacent monomer units that are oriented in a head-to-tail arrangement within the polymer chain. In certain embodiments, aliphatic polycarbonate chains in the inventive polymer compositions have a head-to-tail content higher than about 80%. In certain embodiments, the head-to-tail content is higher than about 85%. In certain embodiments, the head-to-tail content is higher than about 90%. In certain embodiments, the head-to-tail content is greater than about 91%, greater than about 92%, greater than about 93%, greater than about 94%, or greater than about 95%. In certain embodiments, the head-to-tail content of the polymer is as determined by proton or carbon-13 NMR spectroscopy.

In certain embodiments, compositions of the present invention comprise aliphatic polycarbonate polyols having a structure P1:

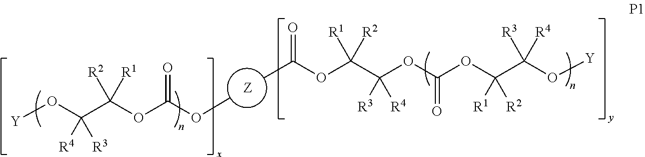

wherein,

R¹, R², R³, and R⁴ are, at each occurrence in the polymer chain, independently selected from the group consisting of —H, fluorine, an optionally substituted C₁₋₃₀ aliphatic group, and an optionally substituted C₁₋₄₀ heteroaliphatic group, and an optionally substituted aryl group, where any two or more of R¹, R², R³, and R⁴ may optionally be taken together with intervening atoms to form one or more optionally substituted rings optionally containing one or more heteroatoms;

Y is, at each occurrence, independently —H, a reactive group (as defined hereinabove), or a site of attachment to any of the chain-extending moieties or isocyanates described in the classes and subclasses herein;

n is at each occurrence, independently an integer from about 2 to about 50;

[symbol] is a bond or a multivalent moiety; and

x and y are each independently an integer from 0 to 6, where the sum of x and y is between 2 and 6.

In certain embodiments, the multivalent moiety [symbol] embedded within the aliphatic polycarbonate chain is derived from a polyfunctional chain transfer agent having two or more sites from which epoxide/CO₂ copolymerization can occur. In certain embodiments, such copolymerizations are performed in the presence of polyfunctional chain transfer agents as exemplified in published PCT application WO/2009056220. In certain embodiments, such copolymerizations are performed as exemplified in US 2011/0245424. In certain embodiments, such copolymerizations are performed as exemplified in Green Chem. 2011, 13, 3469-3475.

In certain embodiments, a polyfunctional chain transfer agent has a formula:

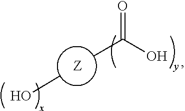

wherein each of [symbol] , x, and y is as defined above and described in classes and subclasses herein.

In certain embodiments, aliphatic polycarbonate chains in the inventive polymer compositions are derived from the copolymerization of one or more epoxides with carbon dioxide in the presence of such polyfunctional chain transfer agents as shown in Scheme 2:

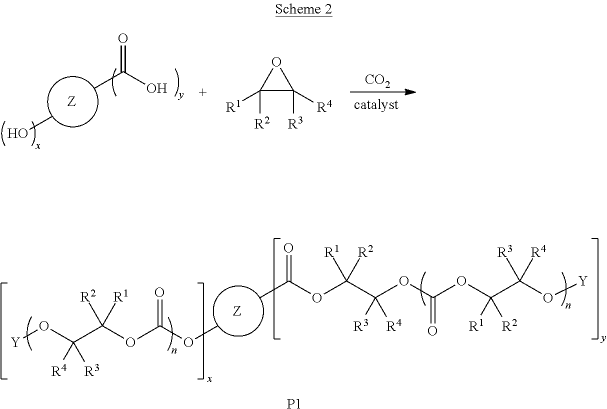

In certain embodiments, aliphatic polycarbonate chains in polymer compositions of the present invention comprise chains with a structure P2:

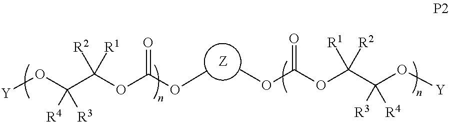

wherein each of R¹, R², R³, R⁴, Y, [symbol] and n is as defined above and described in the classes and subclasses herein.

In certain embodiments where aliphatic polycarbonate chains have a structure P2, [symbol] is derived from a dihydric alcohol. In such instances [symbol] represents the carbon-containing backbone of the dihydric alcohol, while the two oxygen atoms adjacent to [symbol] are derived from the —OH groups of the diol. For example, if the polyfunctional chain transfer agent were ethylene glycol, then [symbol] would be —CH₂CH₂— and P2 would have the following structure:

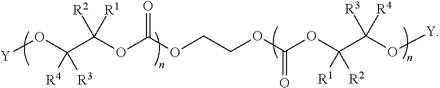

In certain embodiments where [symbol] is derived from a dihydric alcohol, the dihydric alcohol comprises a C₂₋₄₀ diol. In certain embodiments, the dihydric alcohol is selected from the group consisting of: 1,2-ethanediol, 1,2-propanediol, 1,3-propanediol, 1,2-butanediol, 1,3-butanediol, 1,4-butanediol, 1,5-pentanediol, 2,2-dimethylpropane-1,3-diol, 2-butyl-2-ethylpropane-1,3-diol, 2-methyl-2,4-pentane diol, 2-ethyl-1,3-hexane diol, 2-methyl-1,3-propane diol, 1,5-hexanediol, 1,6-hexanediol, 1,8-octanediol, 1,10-decanediol, 1,12-dodecanediol, 2,2,4,4-tetramethylcyclobutane-1,3-diol, 1,3-cyclopentanediol, 1,2-cyclohexanediol, 1,3-cyclohexanediol, 1,4-cyclohexanediol, 1,2-cyclohexanedimethanol, 1,3-cyclohexanedimethanol, 1,4-cyclohexanedimethanol, 1,4-cyclohexanediethanol, isosorbide, glycerol monoesters, glycerol monoethers, trimethylolpropane monoesters, trimethylolpropane monoethers, pentaerythritol diesters, pentaerythritol diethers, and alkoxylated derivatives of any of these.

In certain embodiments where [symbol] is derived from a dihydric alcohol, the dihydric alcohol is selected from the group consisting of: diethylene glycol, triethylene glycol, tetraethylene glycol, higher poly(ethylene glycol), such as those having number average molecular weights of from 220 to about 2000 g/mol, dipropylene glycol, tripropylene glycol, and higher poly(propylene glycol) such as those having number average molecular weights of from 234 to about 2000 g/mol.

In certain embodiments where [symbol] is derived from a dihydric alcohol, the dihydric alcohol comprises an alkoxylated derivative of a compound selected from the group consisting of: a diacid, a diol, or a hydroxy acid. In certain embodiments, the alkoxylated derivatives comprise ethoxylated or propoxylated compounds.

In certain embodiments where [symbol] is derived from a dihydric alcohol, the dihydric alcohol comprises a polymeric diol. In certain embodiments, a polymeric diol is selected from the group consisting of polyethers, polyesters, hydroxy-terminated polyolefins, polyether-copolyesters, polyether polycarbonates, polycarbonate-copolyesters, polyoxymethylene polymers, and alkoxylated analogs of any of these. In certain embodiments, the polymeric diol has an average molecular weight less than about 2000 g/mol.

In certain embodiments, [symbol] is derived from a polyhydric alcohol with more than two hydroxy groups. In embodiments in which [symbol] is derived from a polyhydric alcohol with more than two hydroxyl groups, these >2 functional polyols are a component of a polyol mixture containing predominantly polyols with two hydroxyl groups. In certain embodiments, these >2 functional polyols are less than 20% of the total polyol mixture by weight. In certain embodiments, these >2 functional polyols are less than 10% of the total polyol mixture. In certain embodiments, these >2 functional polyols are less than 5% of the total polyol mixture. In certain embodiments, these >2 functional polyols are less than 2% of the total polyol mixture. In certain embodiments, the aliphatic polycarbonate chains in polymer compositions of the present invention comprise aliphatic polycarbonate chains where the moiety [symbol] is derived from a triol. In certain embodiments, such aliphatic polycarbonate chains have the structure P3:

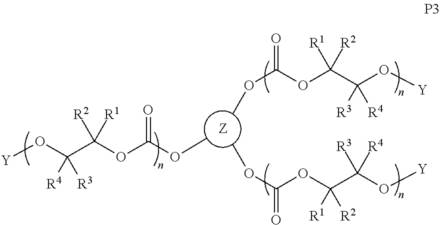

wherein each of R¹, R², R³, R⁴, Y, [symbol] and n is as defined above and described in classes and subclasses herein.

In certain embodiments where [symbol] is derived from a triol, the triol is selected from the group consisting of: glycerol, 1,2,4-butanetriol, 2-(hydroxymethyl)-1,3-propanediol; hexane triols, trimethylol propane, trimethylol ethane, trimethylolhexane, 1,4-cyclohexanetrimethanol, pentaerythritol mono esters, pentaerythritol mono ethers, and alkoxylated analogs of any of these. In certain embodiments, such alkoxylated derivatives comprise ethoxylated or propoxylated compounds.

In certain embodiments, [symbol] is derived from an alkoxylated derivative of a trifunctional carboxylic acid or trifunctional hydroxy acid. In certain embodiments, alkoxylated derivatives comprise ethoxylated or propoxylated compounds.

In certain embodiments, where [symbol] is derived from a polymeric triol, the polymeric triol is selected from the group consisting of polyethers, polyesters, hydroxy-terminated polyolefins, polyether-copolyesters, polyether polycarbonates, polyoxymethylene polymers, polycarbonate-copolyesters, and alkoxylated analogs of any of these. In certain embodiments, the alkoxylated polymeric triols comprise ethoxylated or propoxylated compounds.

In certain embodiments, [symbol] is derived from a polyhydric alcohol with four hydroxy groups. In certain embodiments, aliphatic polycarbonate chains in polymer compositions of the present invention comprise aliphatic polycarbonate chains where the moiety [symbol] is derived from a tetraol. In certain embodiments, aliphatic polycarbonate chains in polymer compositions of the present invention comprise chains with the structure P4:

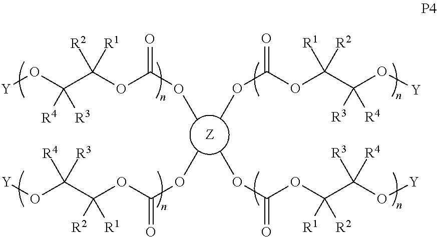

wherein each of R¹, R², R³, R⁴, Y, [symbol] and n is as defined above and described in classes and subclasses herein.

In certain embodiments, [symbol] is derived from a polyhydric alcohol with more than four hydroxy groups. In certain embodiments, [symbol] is derived from a polyhydric alcohol with six hydroxy groups. In certain embodiments, a polyhydric alcohol is dipentaerithrotol or an alkoxylated analog thereof. In certain embodiments, a polyhydric alcohol is sorbitol or an alkoxylated analog thereof. In certain embodiments, aliphatic polycarbonate chains in polymer compositions of the present invention comprise chains with the structure P5:

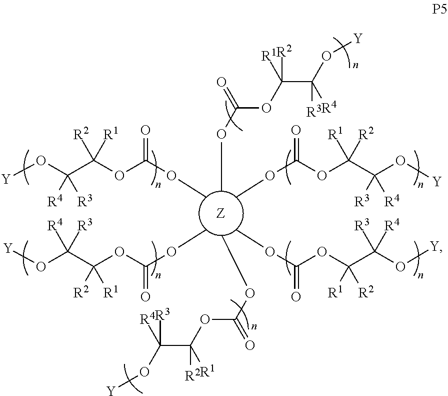

wherein each of R¹, R², R³, R⁴, Y, [symbol] and n is as defined above and described in classes and subclasses herein.

In certain embodiments, aliphatic polycarbonates of the present invention comprise a combination of bifunctional chains (e.g. polycarbonates of formula P2) in combination with higher functional chains (e.g. one or more polycarbonates of formulae P3 to P5).

In certain embodiments, [symbol] is derived from a hydroxy acid. In certain embodiments, aliphatic polycarbonate chains in polymer compositions of the present invention comprise chains with the structure P6:

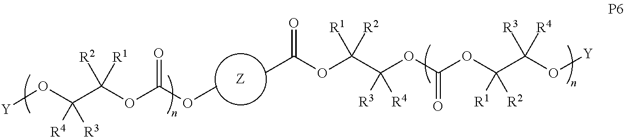

wherein each of R¹, R², R³, R⁴, Y, [symbol] and n is as defined above and described in classes and subclasses herein. In such instances, [symbol] represents the carbon-containing backbone of the hydroxy acid, while ester and carbonate linkages adjacent to [symbol] are derived from the —CO₂H group and the hydroxy group of the hydroxy acid. For example, if [symbol] were derived from 3-hydroxy propanoic acid, then [symbol] would be —CH₂CH₂— and P6 would have the following structure:

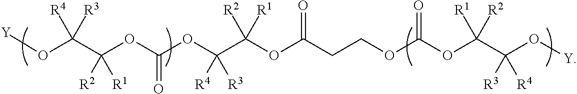

In certain embodiments, [symbol] is derived from an optionally substituted C₂₋₄₀ hydroxy acid. In certain embodiments, [symbol] is derived from a polyester. In certain embodiments, such polyesters have a molecular weight less than about 2000 g/mol.

In certain embodiments, a hydroxy acid is an alpha-hydroxy acid. In certain embodiments, a hydroxy acid is selected from the group consisting of: glycolic acid, DL-lactic acid, D-lactic acid, L-lactic, citric acid, and mandelic acid.

In certain embodiments, a hydroxy acid is a beta-hydroxy acid. In certain embodiments, a hydroxy acid is selected from the group consisting of: 3-hydroxypropionic acid, DL 3-hydroxybutryic acid, D-3 hydroxybutryic acid, L-3-hydroxybutyric acid, DL-3-hydroxy valeric acid, D-3-hydroxy valeric acid, L-3-hydroxy valeric acid, salicylic acid, and derivatives of salicylic acid.

In certain embodiments, a hydroxy acid is a α-ω hydroxy acid. In certain embodiments, a hydroxy acid is selected from the group consisting of: of optionally substituted C₃₋₂₀ aliphatic α-ω hydroxy acids and oligomeric esters.

In certain embodiments, a hydroxy acid is selected from the group consisting of:

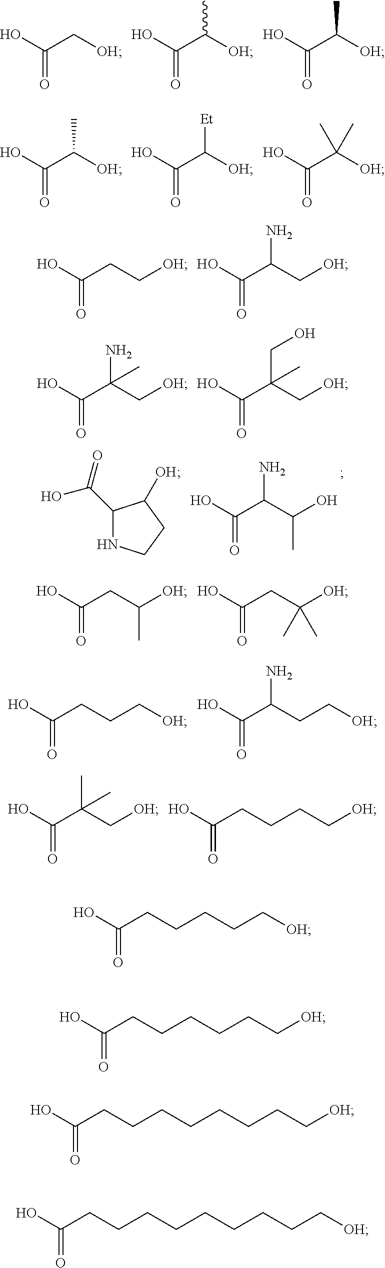

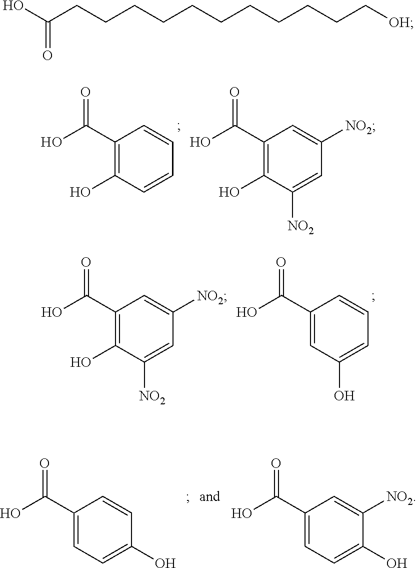

In certain embodiments, \textcircled{Z} is derived from a polycarboxylic acid. In certain embodiments, aliphatic polycarbonate chains in polymer compositions of the present invention comprise chains with the structure P7:

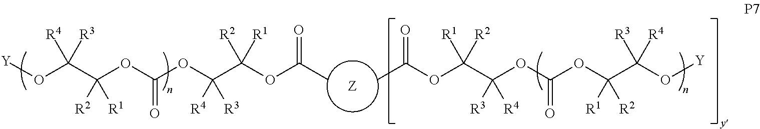

wherein each of R¹, R², R³, R⁴, Y, [symbol] and n is as defined above and described in classes and subclasses herein, and y′ is an integer from 1 to 5 inclusive.

In embodiments where the aliphatic polycarbonate chains have a structure P7, [symbol] represents the carbon-containing backbone (or a bond in the case of oxalic acid) of a polycarboxylic acid, while ester groups adjacent to [symbol] are derived from —CO₂H groups of the polycarboxylic acid. For example, if [symbol] were derived from succinic acid (HO₂CCH₂CH₂CO₂H), then [symbol] would be —CH₂CH₂— and P7 would have the following structure:

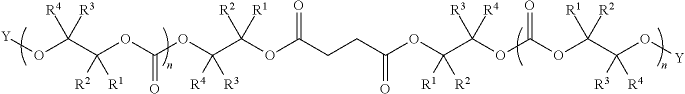

wherein each of R¹, R², R³, R⁴, Y, and n is as defined above and described in classes and subclasses herein.

In certain embodiments, [symbol] is derived from a dicarboxylic acid. In certain embodiments, aliphatic polycarbonate chains in polymer compositions of the present invention comprise chains with the structure P8:

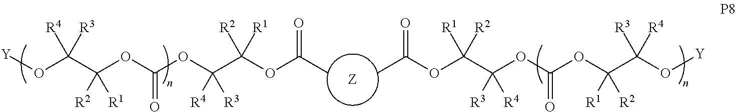

In certain embodiments, [symbol] is selected from the group consisting of: phthalic acid, isophthalic acid, terephthalic acid, maleic acid, succinic acid, malonic acid, glutaric acid, adipic acid, pimelic acid, suberic acid, and azelaic acid.

In certain embodiments, [symbol] is derived from a diacid selected from the group consisting of:

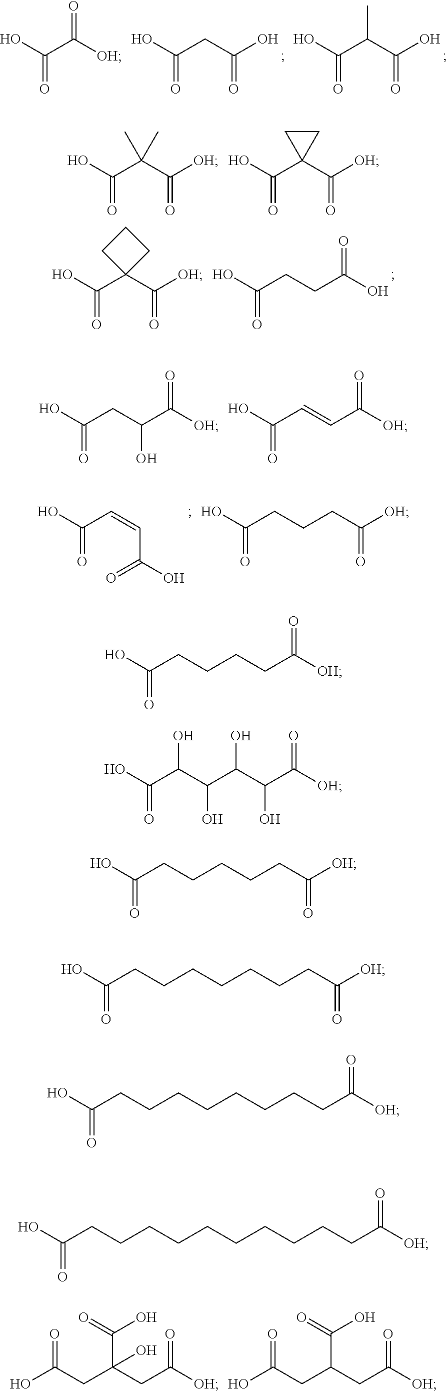

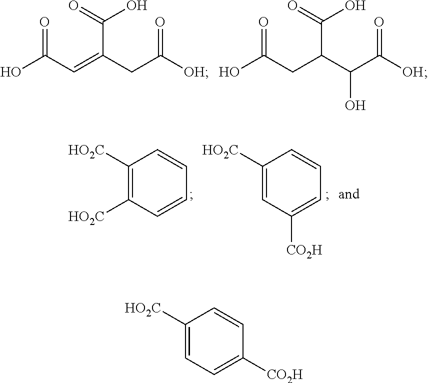

In certain embodiments, [symbol] is derived from a phosphorous-containing molecule. In certain embodiments, [symbol] has a formula —P(O)(OR)ₖ— where each R is independently an optionally substituted C1-20 aliphatic group or an optionally substituted aryl group and k is 0, 1, or 2.

For example, if [symbol] were derived from phenyl phosphite (PhO-P(O)(OH)₂), then [symbol] would be —P(O)(OPh)— and P7 would have the following structure:

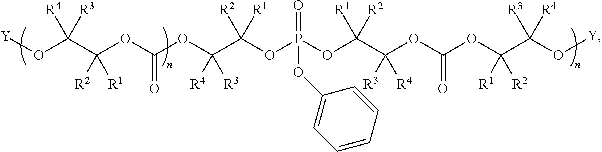

wherein each of R¹, R², R³, R⁴, Y, and n is as defined above and described in classes and subclasses herein.

In certain embodiments, [symbol] is derived from a phosphorous-containing molecule selected from the group consisting of:

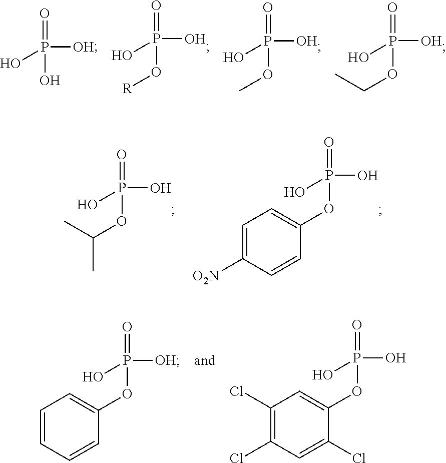

In certain embodiments, [symbol] has a formula —P(O)(R)— where R is an optionally substituted C₁₋₂₀ aliphatic group or an optionally substituted aryl group and k is 0, 1, or 2. In certain embodiments, [symbol] is derived from a phosphorous-containing molecule selected from the group consisting of:

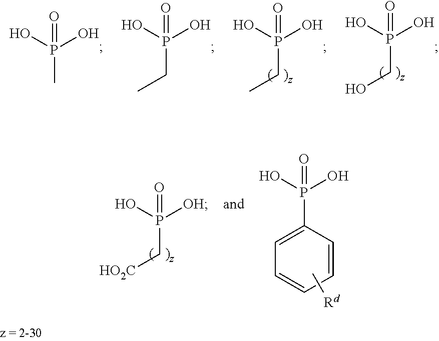

where R^{d} is as defined above.
In certain embodiments, [symbol] has a formula —PR— where R is an optionally substituted C₁₋₂₀ aliphatic group or an optionally substituted aryl group.

In certain embodiments, each R

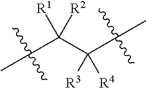

in the structures herein is independently selected from the group consisting of:

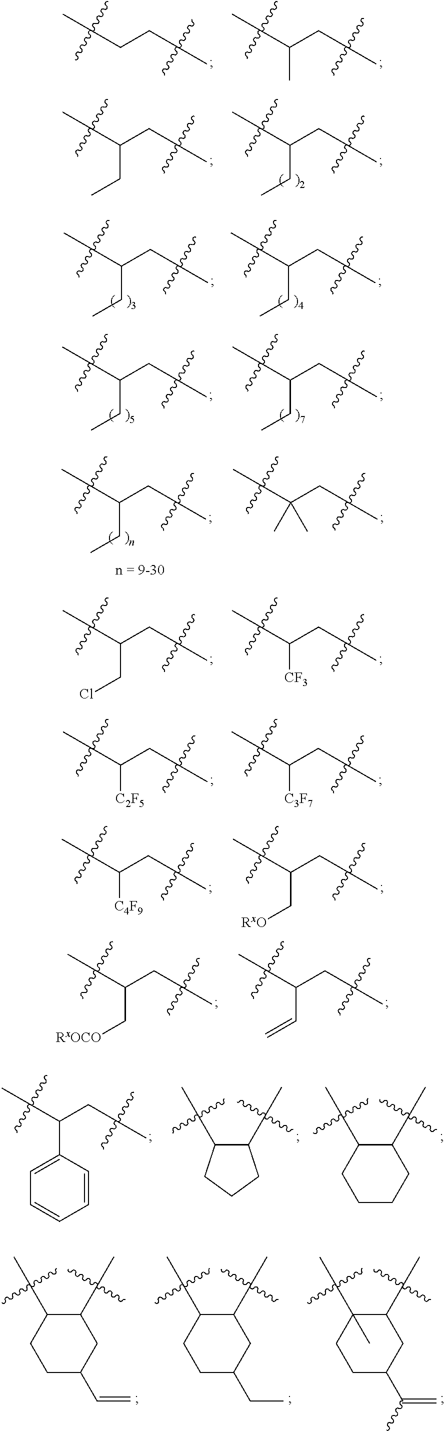

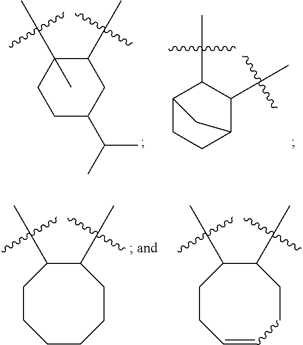

wherein each R^{x} is independently an optionally substituted moiety selected from the group consisting of C₂₋₂₀ aliphatic, C₂₋₂₀ heteroaliphatic, 3- to 14-membered carbocyclic, 6- to 10-membered aryl, 5- to 10-membered heteroaryl, and 3- to 12-membered heterocyclic.

In certain embodiments, each

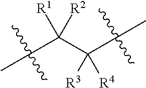

in the structures herein is independently selected from the group consisting of:

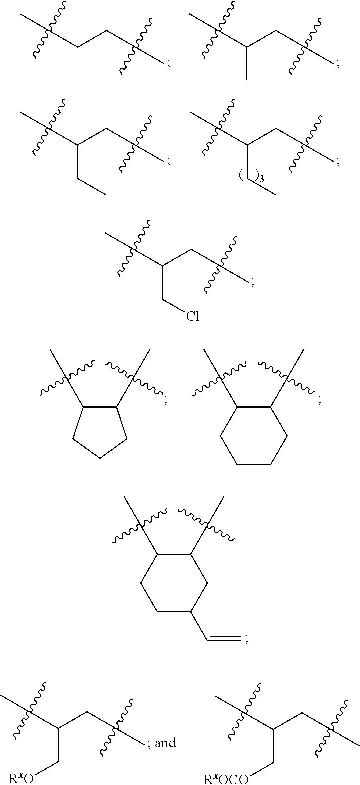

wherein R^{x} is as defined above and described in classes and subclasses herein.

In certain embodiments, aliphatic polycarbonate chains comprise:

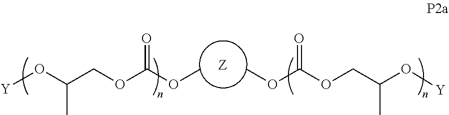

wherein each of [symbol] , —Y, and n is as defined above and described in classes and subclasses herein.

In certain embodiments, aliphatic polycarbonate chains comprise

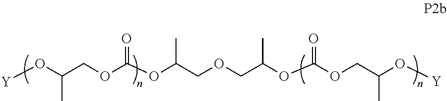

wherein each of —Y and n is as defined above and described in classes and subclasses herein.

In certain embodiments, aliphatic polycarbonate chains comprise

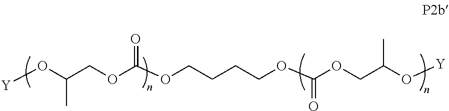

wherein each of —Y and n is as defined above and described in classes and subclasses herein.

In certain embodiments, aliphatic polycarbonate chains comprise

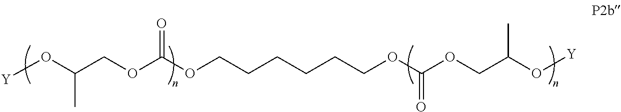

wherein each of —Y and n is as defined above and described in classes and subclasses herein.

In certain embodiments, aliphatic polycarbonate chains comprise

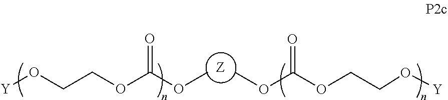

wherein each of [symbol] , —Y, and n is as defined above and described in classes and subclasses herein.

In certain embodiments, aliphatic polycarbonate chains comprise

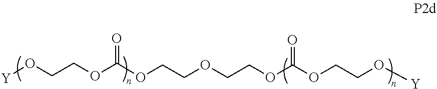

wherein each of —Y and n is as defined above and described in classes and subclasses herein.

In certain embodiments, aliphatic polycarbonate chains comprise

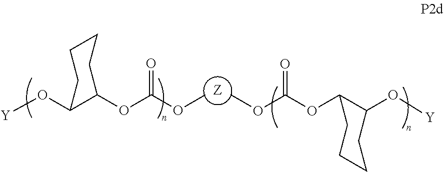

wherein each of [symbol] , —Y, and n is as defined above and described in classes and subclasses herein.

In certain embodiments, aliphatic polycarbonate chains comprise

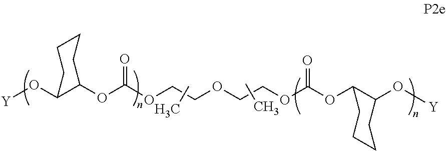

wherein each of —Y and n are is as defined above and described in classes and subclasses herein.

In certain embodiments, aliphatic polycarbonate chains comprise

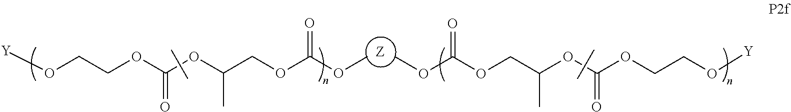

wherein each of [symbol] , —Y, and n is as defined above and described in classes and subclasses herein.

In certain embodiments, aliphatic polycarbonate chains comprise

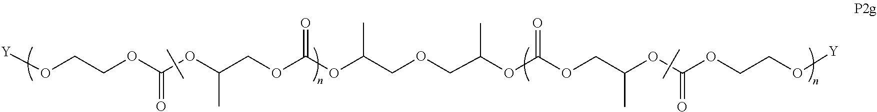

wherein each of —Y and n is as defined above and described in classes and subclasses herein.

In certain embodiments, aliphatic polycarbonate chains comprise

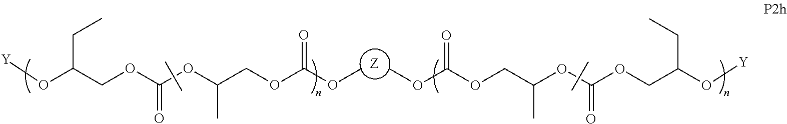

wherein each of [symbol] , —Y, and n is as defined above and described in classes and subclasses herein.

In certain embodiments, aliphatic polycarbonate chains comprise

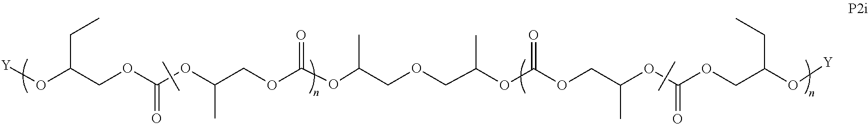

wherein each of —Y and n is as defined above and described in classes and subclasses herein.

In certain embodiments, aliphatic polycarbonate chains comprise

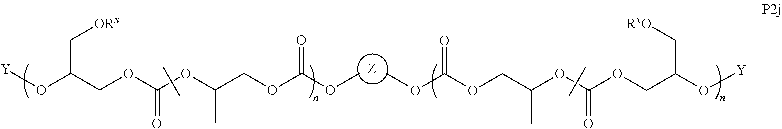

wherein each of [symbol] , —Y, R^{x}, and n is as defined above and described in classes and subclasses herein.

In certain embodiments, aliphatic polycarbonate chains comprise

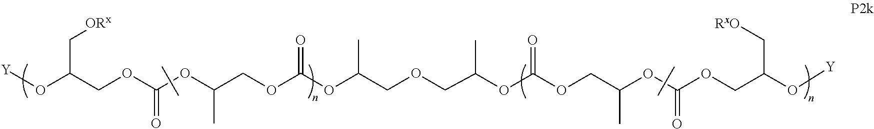

wherein each of —Y, R^{x}, and n is as defined above and described in classes and subclasses herein.

In certain embodiments, aliphatic polycarbonate chains comprise

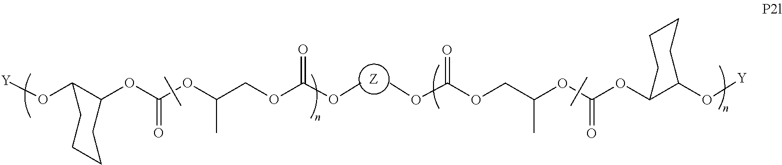

wherein each of [symbol] , —Y, and n is as defined above and described in classes and subclasses herein.

In certain embodiments, aliphatic polycarbonate chains comprise

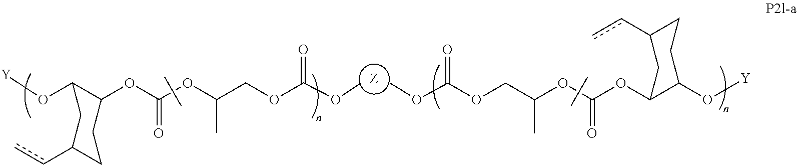

wherein each of [symbol] , —Y, and n are is as defined above and described in classes and subclasses herein; and each [symbol] independently represents a single or double bond.

In certain embodiments, aliphatic polycarbonate chains comprise

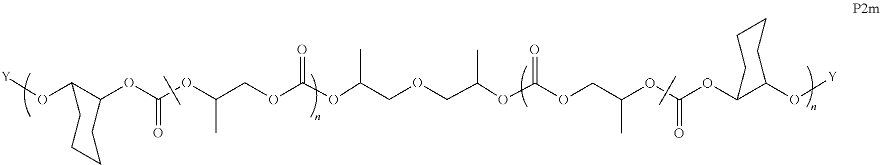

wherein each of —Y and n is as defined above and described in classes and subclasses herein.

In certain embodiments, aliphatic polycarbonate chains comprise

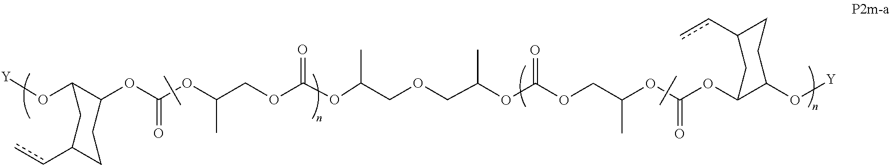

wherein each of —Y, [symbol] , and n is as defined above and described in classes and subclasses herein.

In certain embodiments, aliphatic polycarbonate chains comprise

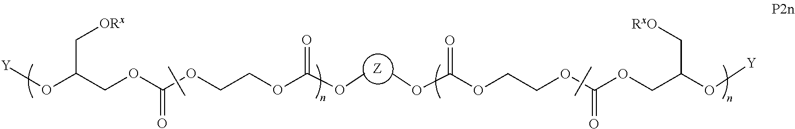

wherein each of [symbol] , R^{x}, —Y and n is as defined above and described in classes and subclasses herein.

In certain embodiments, aliphatic polycarbonate chains comprise

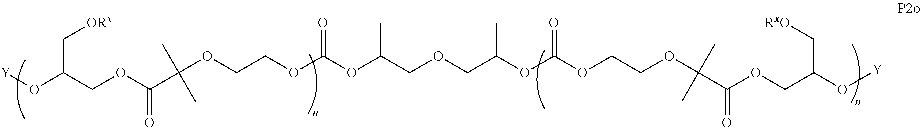

wherein each of —Y, R^{x}, and n is as defined above and described in classes and subclasses herein.

In certain embodiments, aliphatic polycarbonate chains comprise

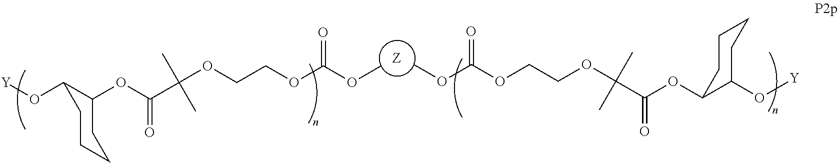

wherein each of [symbol] —Y, and n is as defined above and described in classes and subclasses herein.

In certain embodiments, aliphatic polycarbonate chains comprise

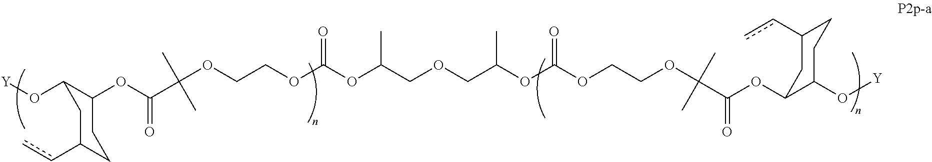

wherein each of —Y, [symbol] , and n is as defined above and described in classes and subclasses herein.

In certain embodiments, aliphatic polycarbonate chains comprise

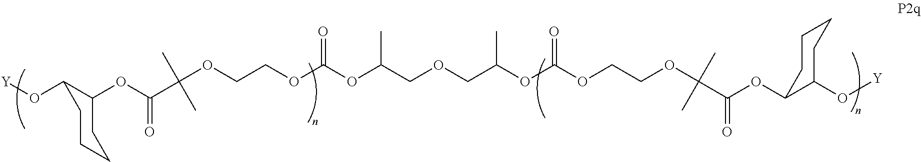

wherein each of —Y and n is as defined above and described in classes and subclasses herein.

In certain embodiments, aliphatic polycarbonate chains comprise

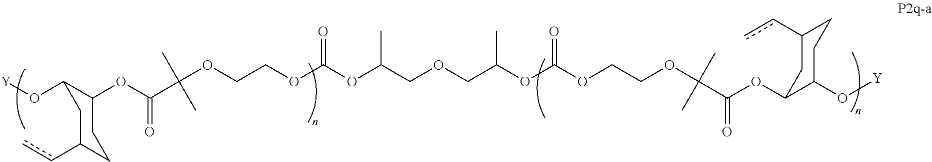

wherein each of —Y, [symbol] , and n is as defined above and described in classes and subclasses herein.

In certain embodiments, aliphatic polycarbonate chains comprise

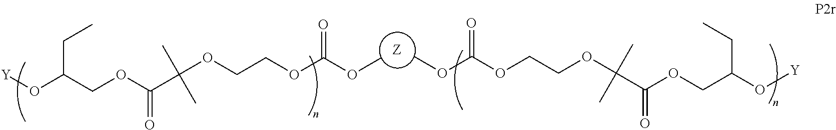

wherein each of [symbol] , —Y, and n is as defined above and described in classes and subclasses herein.

In certain embodiments, aliphatic polycarbonate chains comprise

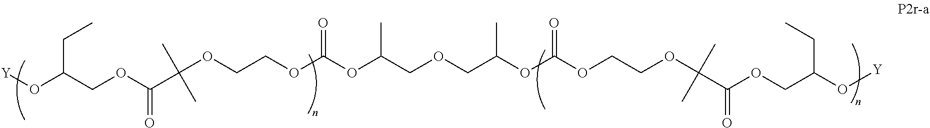

wherein each of —Y and n is as defined above and described in classes and subclasses herein.

In certain embodiments, in polycarbonates of structures P2a, P2c, P2d, P2f, P2h, P2j, P2l, P2l-a, P2n, P2p, and P2r, [symbol] is selected from the group consisting of: ethylene glycol; diethylene glycol, triethylene glycol, 1,3 propane diol; 1,4 butane diol, hexylene glycol, 1,6 hexane diol, propylene glycol, dipropylene glycol, tripopylene glycol, and alkoxylated derivatives of any of these.

For polycarbonates comprising repeat units derived from two or more epoxides, such as those represented by structures P2f through P2r, depicted above, it is to be understood that the structures drawn may represent mixtures of positional isomers or regioisomers that are not explicitly depicted. For example, the polymer repeat unit adjacent to either end group of the polycarbonate chains can be derived from either one of the two epoxides comprising the copolymers. Thus, while the polymers may be drawn with a particular repeat unit attached to an end group, the terminal repeat units might be derived from either of the two epoxides and a given polymer composition might comprise a mixture of all of the possibilities in varying ratios. The ratio of these end-groups can be influenced by several factors including the ratio of the differ rent epoxides used in the polymerization, the structure of the catalyst used, the reaction conditions used (i.e temperature pressure, etc.) as well as by the timing of addition of reaction components. Similarly, while the drawings above may show a defined regiochemistry for repeat units derived from substituted epoxides, the polymer compositions will, in some cases, contain mixtures of regioisomers. The regioselectivity of a given polymerization can be influenced by numerous factors including the structure of the catalyst used and the reaction conditions employed. To clarify, this means that the composition represented by structure P2r above, may contain a mixture of several compounds as shown in the diagram below. This diagram shows the isomers graphically for polymer P2r, where the structures below the depiction of the chain show each regio- and positional isomer possible for the monomer unit adjacent to the chain transfer agent and the end groups on each side of the main polymer chain. Each end group on the polymer may be independently selected from the groups shown on the left or right while the central portion of the polymer including the chain transfer agent and its two adjacent monomer units may be independently selected from the groups shown. In certain embodiments, the polymer composition comprises a mixture of all possible combinations of these. In other embodiments, the polymer composition is enriched in one or more of these.

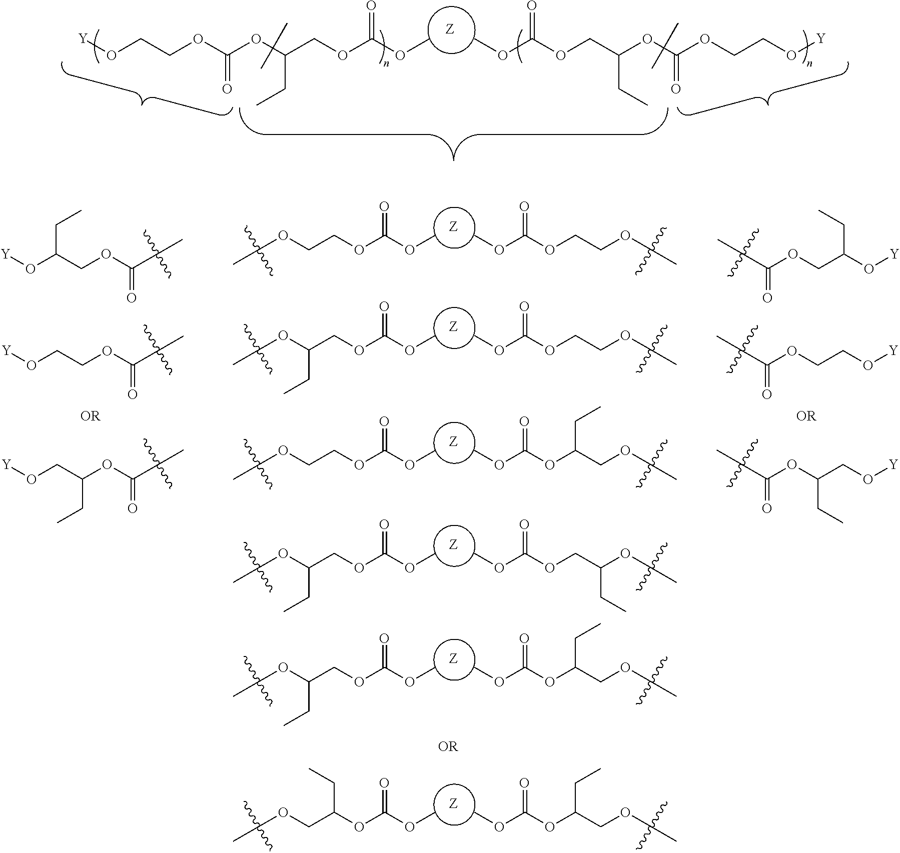

In certain embodiments, the aliphatic polycarbonate polyol is selected from the group consisting of QA1, QA2, QA3, QA4, QA5, QA6, and mixtures of any two or more of these.

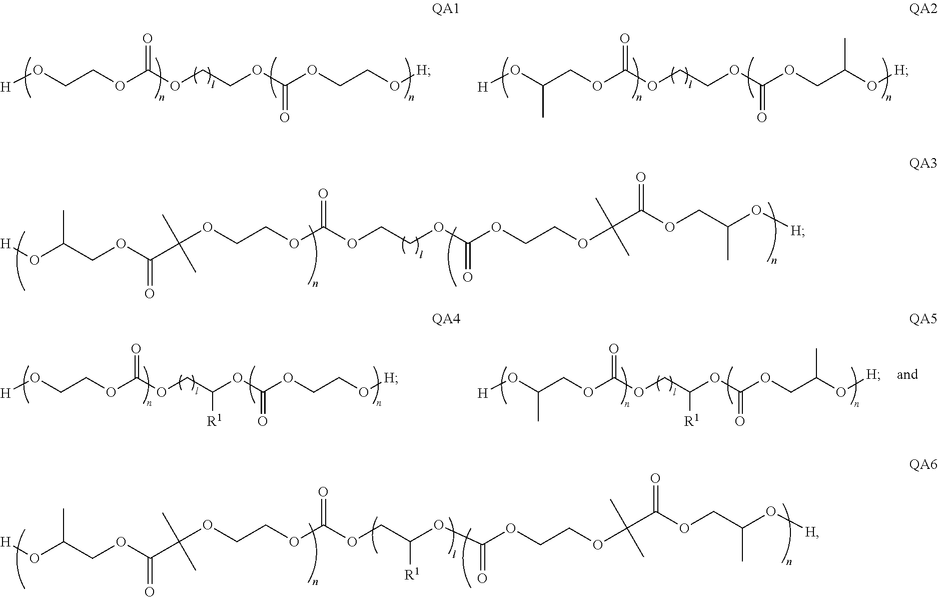

wherein, t is an integer from 1 to 12 inclusive, and R^{t} is independently at each occurrence —H, or —CH₃.

In certain embodiments, the aliphatic polycarbonate polyol is selected from the group consisting of:

Poly(ethylene carbonate) of formula QA1 having an average molecular weight number of between about 500 g/mol and about 3,000 g/mol, a polydisperisty index less than about 1.25, at least 85% carbonate linkages, and at least 98%—OH end groups;

Poly(ethylene carbonate) of formula QA1 having an average molecular weight number of about 500 g/mol, a polydisperisty index less than about 1.25, at least 85% carbonate linkages, and at least 98%—OH end groups;

Poly(ethylene carbonate) of formula QA1 having an average molecular weight number of about 1,000 g/mol, a polydisperisty index less than about 1.25, at least 85% carbonate linkages, and at least 98%—OH end groups;

Poly(ethylene carbonate) of formula QA1 having an average molecular weight number of about 2,000 g/mol, a polydisperisty index less than about 1.25, at least 85% carbonate linkages, and at least 98%—OH end groups;

Poly(ethylene carbonate) of formula QA1 having an average molecular weight number of about 3,000 g/mol, a polydisperisty index less than about 1.25, at least 85% carbonate linkages, and at least 98%—OH end groups;

Poly(propylene carbonate) of formula QA2 having an average molecular weight number of between about 500 g/mol and about 3,000 g/mol, a polydisperisty index less than about 1.25, at least 95% carbonate linkages, and at least 98%—OH end groups;

Poly(propylene carbonate) of formula QA2 having an average molecular weight number of about 500 g/mol, a polydisperisty index less than about 1.25, at least 95% carbonate linkages, and at least 98%—OH end groups;

Poly(propylene carbonate) of formula QA2 having an average molecular weight number of about 1,000 g/mol, a polydisperisty index less than about 1.25, at least 95% carbonate linkages, and at least 98%—OH end groups;

Poly(propylene carbonate) of formula QA2 having an average molecular weight number of about 2,000 g/mol, a polydisperisty index less than about 1.25, at least 95% carbonate linkages, and at least 98%—OH end groups;

Poly(propylene carbonate) of formula QA2 having an average molecular weight number of about 3,000 g/mol, a polydisperisty index less than about 1.25, at least 95% carbonate linkages, and at least 98%—OH end groups;

Poly(ethylene-co-propylene carbonate) of formula QA3 having an average molecular weight number of between about 500 g/mol and about 3,000 g/mol, a polydisperisty index less than about 1.25, at least 90% carbonate linkages, and at least 98%—OH end groups;

Poly(ethylene-co-propylene carbonate) of formula QA3 having an average molecular weight number of about 500 g/mol, a polydisperisty index less than about 1.25, at least 90% carbonate linkages, and at least 98%—OH end groups;

Poly(ethylene-co-propylene carbonate) of formula QA3 having an average molecular weight number of about 1,000 g/mol, a polydisperisty index less than about 1.25, at least 90% carbonate linkages, and at least 98%—OH end groups;

Poly(ethylene-co-propylene carbonate) of formula QA3 having an average molecular weight number of about 2,000 g/mol (e.g. n is on average between about 10 and about 11), a polydisperisty index less than about 1.25, at least 90% carbonate linkages, and at least 98%—OH end groups;

Poly(ethylene-co-propylene carbonate) of formula QA3 having an average molecular weight number of about 3,000 g/mol, a polydisperisty index less than about 1.25, at least 95% carbonate linkages, and at least 98%—OH end groups;

Poly(ethylene carbonate) of formula QA4 having an average molecular weight number of between about 500 g/mol and about 3,000 g/mol (e.g. each n is between about 4 and about 16), a polydisperisty index less than about 1.25, at least 95% carbonate linkages, and at least 98%—OH end groups;

Poly(ethylene carbonate) of formula QA4 having an average molecular weight number of about 500 g/mol, a polydisperisty index less than about 1.25, at least 85% carbonate linkages, and at least 98%—OH end groups;

Poly(ethylene carbonate) of formula QA4 having an average molecular weight number of about 1,000 g/mol, a polydisperisty index less than about 1.25, at least 85% carbonate linkages, and at least 98%—OH end groups;

Poly(ethylene carbonate) of formula QA4 having an average molecular weight number of about 2,000 g/mol, a polydisperisty index less than about 1.25, at least 85% carbonate linkages, and at least 98%—OH end groups;

Poly(ethylene carbonate) of formula QA4 having an average molecular weight number of about 3,000 g/mol, a polydisperisty index less than about 1.25, at least 85% carbonate linkages, and at least 98%—OH end groups.

Poly(propylene carbonate) of formula QA5 having an average molecular weight number of between about 500 g/mol and about 3,000 g/mol, a polydisperisty index less than about 1.25, at least 95% carbonate linkages, and at least 98%—OH end groups;

Poly(propylene carbonate) of formula QA5 having an average molecular weight number of about 500 g/mol, a polydisperisty index less than about 1.25, at least 95% carbonate linkages, and at least 98%—OH end groups;

Poly(propylene carbonate) of formula QA5 having an average molecular weight number of about 1,000 g/mol, a polydisperisty index less than about 1.25, at least 95% carbonate linkages, and at least 98%—OH end groups;

Poly(propylene carbonate) of formula QA5 having an average molecular weight number of about 2,000 g/mol, a polydisperisty index less than about 1.25, at least 95% carbonate linkages, and at least 98%—OH end groups;

Poly(propylene carbonate) of formula QA5 having an average molecular weight number of about 3,000 g/mol, a polydisperisty index less than about 1.25, at least 95% carbonate linkages, and at least 98%—OH end groups;

Poly(ethylene-co-propylene carbonate) of formula QA6 having an average molecular weight number of between about 500 g/mol and about 3,000 g/mol, a polydisperisty index less than about 1.25, at least 90% carbonate linkages, and at least 98%—OH end groups;

Poly(ethylene-co-propylene carbonate) of formula QA6 having an average molecular weight number of about 500 g/mol, a polydisperisty index less than about 1.25, at least 90% carbonate linkages, and at least 98%—OH end groups;

Poly(ethylene-co-propylene carbonate) of formula QA6 having an average molecular weight number of about 1,000 g/mol, a polydisperisty index less than about 1.25, at least 90% carbonate linkages, and at least 98%—OH end groups;

Poly(ethylene-co-propylene carbonate) of formula QA6 having an average molecular weight number of about 2,000 g/mol (e.g. n is on average between about 10 and about 11), a polydisperisty index less than about 1.25, at least 90% carbonate linkages, and at least 98%—OH end groups;

Poly(ethylene-co-propylene carbonate) of formula QA6 having an average molecular weight number of about 3,000 g/mol, a polydisperisty index less than about 1.25, at least 95% carbonate linkages, and at least 98%—OH end groups; and

Mixtures of any two or more of these.

In certain embodiments, the embedded chain transfer agent [symbol] is a moiety derived from a polymeric diol or higher polyhydric alcohol. In certain embodiments, such polymeric alcohols are polyether or polyester polyols. In certain embodiments [symbol] is a polyether polyol comprising ethylene glycol or propylene glycol repeating units (—OCH₂CH₂O—, or —OCH₂CH(CH₃)O—) or combinations of these. In certain embodiments, [symbol] is a polyester polyol comprising the reaction product of a diol and a diacid, or a material derived from ring-opening polymerization of one or more lactones.

In certain embodiments where [symbol] comprises a polyether diol, the aliphatic polycarbonate polyol has a structure Q7:

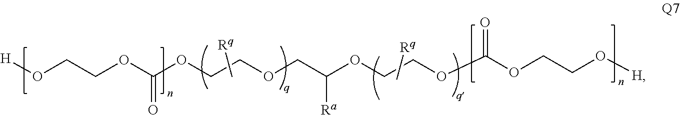

wherein,

R^{q} is at each occurrence in the polymer chain independently —H or —CH₃,

R^{a} is —H, or —CH₃;

q and q′ are independently an integer from about 0 to about 40; and

and n is as defined above and in the examples and embodiments herein.

In certain embodiments, an aliphatic polycarbonate polyol is selected from the group consisting of:

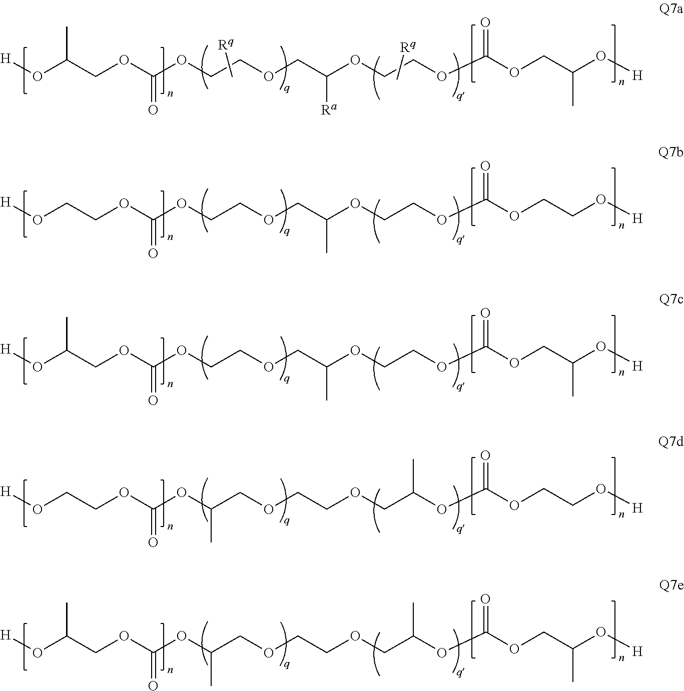

In certain embodiments, where aliphatic polycarbonate polyols comprise compounds conforming to structure Q7, the moiety [symbol] is derived from a commercially available polyether polyol such as those typically used in the formulation of polyurethane compositions.

In certain embodiments where [symbol] comprises a polyether diol, the aliphatic polycarbonate polyol has a structure Q8:

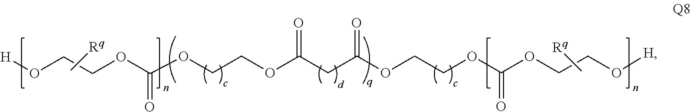

wherein,

c is at each occurrence in the polymer chain independently an integer from 0 to 6;

d is at each occurrence in the polymer chain independently an integer from 1 to 11; and

each of R^{q}, n q and q′ is as defined above and in the examples and embodiments herein.

In certain embodiments, an aliphatic polycarbonate polyol is selected from the group consisting of:

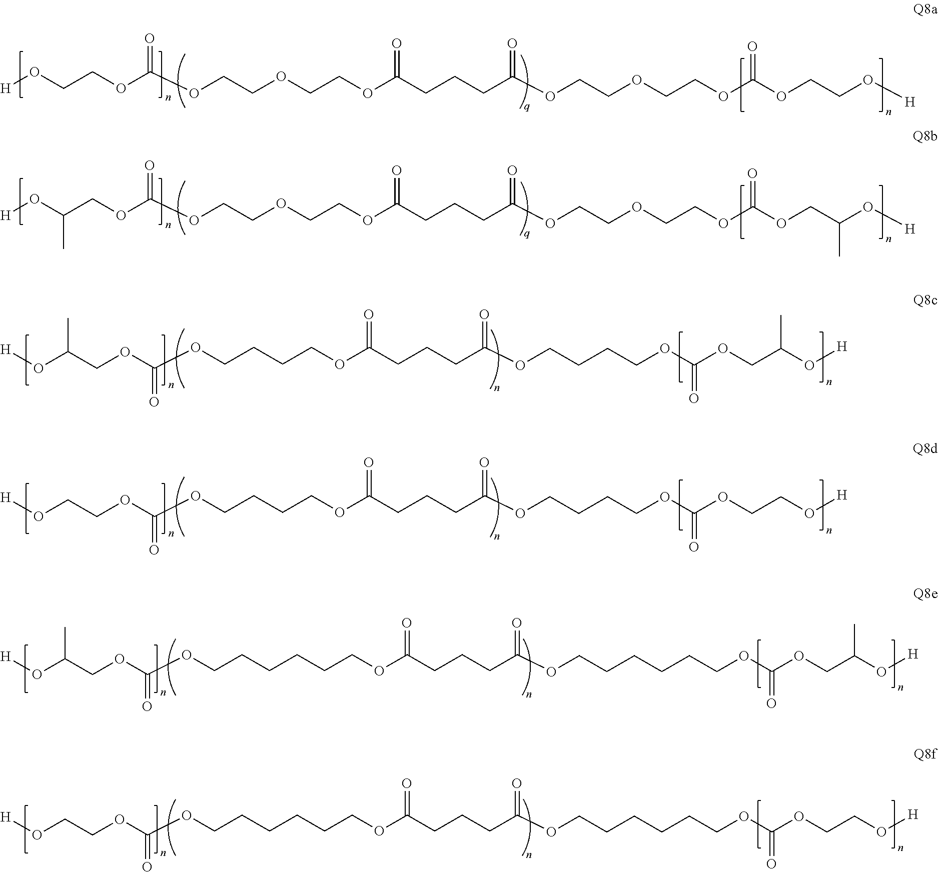

In certain embodiments, where aliphatic polycarbonate polyols comprise compounds conforming to structure Q8, the moiety [symbol] derived from a commercially available polyester polyol such as those typically used in the formulation of polyurethane compositions.

### APPENDIX II

### Isocyanate Reagents

As described above, certain compositions of the present invention comprise higher polymers derived from reactions with polyisocyanate reagents. The purpose of these isocyanate reagents is to react with the reactive end groups on the aliphatic polycarbonate polyols to form higher molecular weight structures through chain extension and/or cross-linking.

The art of polyurethane synthesis is well advanced and a very large number of isocyanates and related polyurethane precursors are known in the art. While this section of the specification describes isocyanates suitable for use in certain embodiments of the present invention, it is to be understood that it is within the capabilities of one skilled in the art of polyurethane formulation to use alternative isocyanates along with the teachings of this disclosure to formulate additional compositions of matter within the scope of the present invention. Descriptions of suitable isocyanate compounds and related methods can be found in: Chemistry and Technology of Polyols for Polyurethanes Ionescu, Mihail 2005 (ISBN 978-1-84735-035-0), and H. Ulrich, “Urethane Polymers,” Kirk-Othmer Encyclopedia of Chemical Technology, 1997 the entirety of each of which is incorporated herein by reference.

In certain embodiments, the isocyanate reagents comprise two or more isocyanate groups per molecule. In certain embodiments the isocyanate reagents are diisocyanates. In other embodiments, the isocyanate reagents are higher polyisocyanates such as triisocyanates, tetraisocyanates, isocyanate polymers or oligomers, and the like, which are typically a minority component of a mix of predominanetly diisocyanates. In certain embodiments, the isocyanate reagents are aliphatic polyisocyanates or derivatives or oligomers of aliphatic polyisocyanates. In other embodiments, the isocyanates are aromatic polyisocyanates or derivatives or oligomers of aromatic polyisocyanates. In certain embodiments, the compositions may comprise mixtures of any two or more of the above types of isocyanates.

In certain embodiments, isocyanate reagents usable for the production of the polyurethane adhesive include aliphatic, cycloaliphatic and aromatic diisocyanate compounds.

Suitable aliphatic and cycloaliphatic isocyanate compounds include, for example, 1,3-trimethylene diisocyanate, 1,4-tetramethylene diisocyanate, 1,6-hexamethylene diisocyanate, 2,2,4-trimethylhexamethylene diisocyanate, 2,4,4-trimethylhexamethylene diisocyanate, 1,9-nonamethylene diisocyanate, 1,10-decamethylene diisocyanate, 1,4-cyclohexane diisocyanate, isophorone diisocyanate, 4,4′-dicyclohexylmethane diisocyanate, 2,2′-diethylether diisocyanate, hydrogenated xylylene diisocyanate, and hexamethylene diisocyanate-biuret.

The aromatic isocyanate compounds include, for example, p-phenylene diisocyanate, tolylene diisocyanate, xylylene diisocyanate, 4,4′-diphenyl diisocyanate, 2,4′-diphenylmethane diisocyanate, 1,5-naphthalene diisocyanate, 4,4′-diphenylmethane diisocyanate (MDI), 3,3′-methyleneditolylene-4,4′-diisocyanate, tolylenediisocyanate-trimethylolpropane adduct, triphenylmethane triisocyanate, 4,4′-diphenylether diisocyanate, tetrachlorophenylene diisocyanate, 3,3′-dichloro-4,4′-diphenylmethane diisocyanate, and triisocyanate phenylthiophosphate.

In certain embodiments, the isocyanate compound employed comprises one or more of: 4,4′-diphenylmethane diisocyanate, 1,6-hexamethylene hexamethylene diisocyanate and isophorone diisocyanate. In certain embodiments, the isocyanate compound employed is 4,4′-diphenylmethane diisocyanate. The above-mentioned diisocyanate compounds may be employed alone or in mixtures of two or more thereof.

In certain embodiments, an isocyanate reagent is selected from the group consisting of: 1,6-hexamethylaminediisocyanate (HDI), isophorone diisocyanate (IPDI), 4,4′ methylene-bis(cyclohexyl isocyanate) (H₁₂MDI), 2,4-toluene diisocyanate (TDI), 2,6-toluene diisocyanate (TDI), diphenylmethane-4,4′-diisocyanate (MDI), diphenylmethane-2,4′-diisocyanate (MDI), xylylene diisocyanate (XDI), 1,3-Bis(isocyanatomethyl)cyclohexane (H6-XDI), 2,2,4-trimethylhexamethylene diisocyanate, 2,4,4-trimethylhexamethylene diisocyanate (TMDI), m-tetramethylxylylene diisocyanate (TMXDI), p-tetramethylxylylene diisocyanate (TMXDI), isocyanatomethyl-1,8-ictane diisocyanate (TIN), triphenylmethane-4,4′,4″ triisocyanate, Tris(p-isocyanatomethyl)thiosulfate, 1,3-Bis(isocyanatomethyl)benzene, 1,4-tetramethylene diisocyanate, trimethylhexane diisocyanate, 1,6-hexamethylene diisocyanate, 1,4-cyclohexyl diisocyanate, lysine diisocyanate, HDI allophonate trimer, HDI urethdione and HDI-trimer and mixtures of any two or more of these.

In certain embodiments, an isocyanate reagent is selected from the group consisting of 4,4′-diphenylmethane diisocyanate, 1,6-hexamethylene diisocyanate and isophorone diisocyanate. In certain embodiments, an isocyanate reagent is 4,4′-diphenylmethane diisocyanate. certain embodiments, an isocyanate reagent is 1,6-hexamethylene diisocyanate. certain embodiments, an isocyanate reagent is isophorone diisocyanate.

Isocyanates suitable for certain embodiments of the present invention are available commercially under various trade names. Examples of suitable commercially available isocyanates include materials sold under trade names: Desmodur® (Bayer Material Science), Tolonate® (Perstorp), Takenate® (Takeda), Vestanat® (Evonik), Desmotherm® (Bayer Material Science), Bayhydur® (Bayer Material Science), Mondur (Bayer Material Science), Suprasec (Huntsman Inc.), Lupranate® (BASF), Trixene (Baxenden), Hartben® (Benasedo), Ucopol® (Sapici), and Basonat® (BASF). Each of these trade names encompasses a variety of isocyanate materials available in various grades and formulations. The selection of suitable commercially-available isocyanate materials as reagents to produce polyurethane compositions for a particular application is within the capability of one skilled in the art of polyurethane coating technology using the teachings and disclosure of this patent application along with the information provided in the product data sheets supplied by the above-mentioned suppliers.

Additional isocyanates suitable for certain embodiments of the present invention are sold under the trade name Lupranate® (BASF). In certain embodiments, the isocyanates are selected from the group consisting of the materials shown in Table 1, and typically from the subset of this list that are between 1.95 and 2.1 functional isocyanates:

TABLE 1

| | | | Nomi- |
|---|---|---|---|
| | | % | nal |
| Products | Description | NCO | Funct. |
| Lupranate M | 4,4′ MDI | 33.5 | 2 |
| Lupranate MS | 4,4′ MDI | 33.5 | 2 |
| Lupranate MI | 2,4′ and 4,4′ MDI Blend | 33.5 | 2 |
| Lupranate LP30 | Liquid Pure 4,4′ MDI | 33.1 | 2 |
| Lupranate 227 | Monomeric/Modified MDI Blend | 32.1 | 2 |

Carbodiimide Modified MDI

| | | | |
|---|---|---|---|
| Lupranate 5143 | Carbodiimide Modified 4,4′ MDI | 29.2 | 2.2 |
| Lupranate MM103 | Carbodiimide Modified 4,4′ MDI | 29.5 | 2.2 |
| Lupranate 219 | Carbodiimide Modified 4,4′ MDI | 29.2 | 2.2 |
| Lupranate 81 | Carbodiimide Modified MDI | 29.5 | 2.2 |
| Lupranate 218 | Carbodiimide Modified MDI | 29.5 | 2.2 |

Polymeric MDI (PMDI)

| | | | |
|---|---|---|---|
| Lupranate M10 | Low Funct. Polymeric | 31.7 | 2.2 |
| Lupranate R2500U | Polymeric MDI Variant | 31.5 | 2.7 |
| Lupranate M20S | Mid-Functionality Polymeric | 31.5 | 2.7 |
| Lupranate M20FB | Mid-Functionality Polymeric | 31.5 | 2.7 |
| Lupranate M70L | High-Functionality Polymeric | 31 | 3 |
| Lupranate M200 | High-Functionality Polymeric | 30 | 3.1 |

Polymeric MDI Blends and Derivatives

| | | | |
|---|---|---|---|
| Lupranate 241 | Low Functionality Polymeric | 32.6 | 2.3 |
| Lupranate 230 | Low Viscosity Polymeric | 32.5 | 2.3 |
| Lupranate 245 | Low Viscosity Polymeric | 32.3 | 2.3 |
| Lupranate TF2115 | Mid Functionality Polymeric | 32.3 | 2.4 |
| Lupranate 78 | Mid Functionality Polymeric | 32 | 2.3 |
| Lupranate 234 | Low Functionality Polymeric | 32 | 2.4 |
| Lupranate 273 | Low Viscosity Polymeric | 32 | 2.5 |
| Lupranate 266 | Low Viscosity Polymeric | 32 | 2.5 |
| Lupranate 261 | Low Viscosity Polymeric | 32 | 2.5 |
| Lupranate 255 | Low Viscosity Polymeric | 31.9 | 2.5 |
| Lupranate 268 | Low Viscosity Polymeric | 30.6 | 2.4 |

Select MDI Prepolymers

| | | | |
|---|---|---|---|
| Lupranate 5010 | Higher Functional Prepolymer | 28.6 | 2.3 |
| Lupranate 223 | Low Visc. Derivative of Pure MDI | 27.5 | 2.2 |
| Lupranate 5040 | Mid Functional, Low Viscosity | 26.3 | 2.1 |
| Lupranate 5110 | Polymeric MDI Prepolymer | 25.4 | 2.3 |
| Lupranate MP102 | 4,4′ MDI Prepolymer | 23 | 2 |
| Lupranate 5090 | Special 4,4′ MDI Prepolymer | 23 | 2.1 |
| Lupranate 5050 | Mid Functional, Mid NCO Prepol | 21.5 | 2.1 |
| Lupranate 5030 | Special MDI Prepolymer | 18.9 | NA |
| Lupranate 5080 | 2,4′-MDI Enhanced Prepolymer | 15.9 | 2 |
| Lupranate 5060 | Low Funct, Higher MW Prepol | 15.5 | 2 |
| Lupranate 279 | Low Funct, Special Prepolymer | 14 | 2 |
| Lupranate 5070 | Special MDI Prepolymer | 13 | 2 |
| Lupranate 5020 | Low Functionality, Low NCO | 9.5 | 2 |

Toluene Diisocyanate (TDI)

| | | | |
|---|---|---|---|
| Lupranate T80- | 80/20:2,4/2,6 TDI | 48.3 | 2 |
| Lupranate T80- | High Acidity TDI | 48.3 | 2 |
| Lupranate 8020 | 80/20:TDI/Polymeric MDI | 44.6 | 2.1 |

Other isocyanates suitable for certain embodiments of the present invention are sold under the trade name Desmodur® available from Bayer Material Science. In certain embodiments, the isocyanates are selected from the group consisting of the materials shown in Table 2, and typically from the subset of this list that are between 1.95 and 2.1 functional isocyanates:

TABLE 2

| Trade Name | Description |
|---|---|
| Desmodur ® 2460 M | Monomeric diphenylmethane diisocyanate with high 2,4′- |
| | isomer content |
| Desmodur ® 44 M | A monomeric diphenylmethane-4,4′-diisocyanate (MDI). |
| Desmodur ® 44 MC | Desmodur 44 MC Flakes is a monomeric diphenylmethane- |
| | 4,4′-diisocyanate (MDI). |
| Desmodur ® BL 1100/1 | Blocked aromatic polyisocyanate based on TDI |
| Desmodur ® BL 1265 MPA/X | Blocked aromatic polyisocyanate based on TDI |
| Desmodur ® BL 3175 SN | Blocked, aliphatic polyisocyanate based on HDI |
| Desmodur ® BL 3272 MPA | Blocked aliphatic polyisocyanate based on HDI |
| Desmodur ® BL 3370 MPA | Blocked aliphatic polyisocyanate based on HDI |
| Desmodur ® BL 3475 BA/SN | Aliphatic crosslinking stoving urethane resin based on HDI/ |
| | IPDI |
| Desmodur ® BL 3575/1 MPA/SN | Blocked aliphatic polyisocyanate based on HDI |
| Desmodur ® BL 4265 SN | Blocked, aliphatic polyisocyanate based on IPDI |
| Desmodur ® BL 5375 | Blocked aliphatic polyisocyanate based on H 12 MDI |
| Desmodur ® CD-L | Desmodur CD-L is a modified isocyanate based on |
| | diphenylmethane-4,4′-diisocyanate. |
| Desmodur ® CD-S | Desmodur CD-S is a modified isocyanate based on |
| | diphenylmethane-4,4′-diisocyanate. |
| Desmodur ® DXP 2725 | Hydrophilically modified polyisocyanate |
| Desmodur ® DA-L | Hydrophilic aliphatic polyisocyanate based on |
| | hexamethylene diisocyanate |
| Desmodur ® DN | Aliphatic polyisocyanate of low volatility |
| Desmodur ® E 1160 | Aromatic polyisocyanate prepolymer based on toluene |
| | diisocyanate |
| Desmodur ® E 1361 BA | Aromatic polyisocyanate prepolymer based on toluylene |
| | diisocyanate |
| Desmodur ® E 1361 MPA/X | Aromatic polyisocyanate prepolymer based on toluene |
| | diisocyanate |
| Desmodur ® E 14 | Aromatic polyisocyanate prepolymer based on toluene |
| | diisocyanate |
| Desmodur ® E 15 | Aromatic polyisocyanate prepolymer based on toluene |
| | diisocyanate. |
| Desmodur ® E 1660 | Aromatic polyisocyanate prepolymer based on toluene |
| | diisocyanate. |
| Desmodur ® E 1750 PR | Polyisocyanate prepolymer based on toluene diisocyanate |
| Desmodur ® E 20100 | Modified polyisocyanate prepolymer based on |
| | diphenylmethane diisocyanate. |
| Desmodur ® E 21 | Aromatic polyisocyanate prepolymer based on |
| | diphenylmethane diisocyanate (MDI). |
| Desmodur ® E 2190 X | Aromatic polyisocyanate prepolymer based on |
| | diphenylmethane diisocyanate (MDI) |
| Desmodur ® E 22 | Aromatic polyisocyanate prepolymer based on |
| | diphenylmethane diisocyanate. |
| Desmodur ® E 2200/76 | Desmodur E 2200/76 is a prepolymer based on (MDI) with |
| | isomers. |
| Desmodur ® E 23 | Aromatic polyisocyanate prepolymer based on |
| | diphenylmethane diisocyanate (MDI). |
| Desmodur ® E 29 | Polyisocyanate prepolymer based on diphenylmethane |
| | diisocyanate. |
| Desmodur ® E 305 | Desmodur E 305 is a largely linear aliphatic NCO prepolymer |
| | based on hexamethylene diisocyanate. |
| Desmodur ® E 3265 MPA/SN | Aliphatic polyisocyanate prepolymer based on |
| | hexamethylene diisocyanate (HDI) |
| Desmodur ® E 3370 | Aliphatic polyisocyanate prepolymer based on |
| | hexamethylene diisocyanate |
| Desmodur ® E XP 2605 | Polyisocyanate prepolymer based on toluene diisocyanate |
| | and diphenylmethan diisocyanate |
| Desmodur ® E XP 2605 | Polyisocyanate prepolymer based on toluene diisocyanate |
| | and diphenylmethan diisocyanate |
| Desmodur ® E XP 2715 | Aromatic polyisocyanate prepolymer based on 2,4′- |
| | diphenylmethane diisocyanate (2,4′-MDI) and a hexanediol |
| Desmodur ® E XP 2723 | Aromatic polyisocyanate prepolymer based on |
| | diphenylmethane diisocyanate (MDI). |
| Desmodur ® E XP 2726 | Aromatic polyisocyanate prepolymer based on 2,4′- |
| | diphenylmethane diisocyanate (2,4′-MDI) |
| Desmodur ® E XP 2727 | Aromatic polyisocyanate prepolymer based on |
| | diphenylmethane diisocyanate. |
| Desmodur ® E XP 2762 | Aromatic polyisocyanate prepolymer based on |
| | diphenylmethane diisocyanate (MDI). |
| Desmodur ® H | Monomeric aliphatic diisocyanate |
| Desmodur ® HL | Aromatic/aliphatic polyisocyanate based on toluylene |
| | diisocyanate/hexamethylene diisocyanate |
| Desmodur ® I | Monomeric cycloaliphatic diisocyanate. |
| Desmodur ® IL 1351 | Aromatic polyisocyanate based on toluene diisocyanate |
| Desmodur ® IL 1451 | Aromatic polyisocyanate based on toluene diisocyanate |
| Desmodur ® IL BA | Aromatic polyisocyanate based on toluene diisocyanate |
| Desmodur ® IL EA | Aromatic polyisocyante resin based on toluylene |
| | diisocyanate |
| Desmodur ® L 1470 | Aromatic polyisocyanate based on toluene diisocyanate |
| Desmodur ® L 67 BA | Aromatic polyisocyanate based on tolulene diisocyanate |
| Desmodur ® L 67 MPA/X | Aromatic polyisocyanate based on tolulene diisocyanate |
| Desmodur ® L75 | Aromatic polyisocyanate based on tolulene diisocyanate |
| Desmodur ® LD | Low-functionality isocyanate based on hexamethylene |
| | diisocyanate (HDI) |
| Desmodur ® LS 2424 | Monomeric diphenylmethane diisocyanate with high 2,4′- |
| | isomer content |
| Desmodur ® MT | Polyisocyanate prepolymer based on diphenylmethane |
| | diisocyanate |
| Desmodur ® N 100 | Aliphatic polyisocyanate (HDI biuret) |
| Desmodur ® N 3200 | Aliphatic polyisocyanate (low-viscosity HDI biuret) |
| Desmodur ® N 3300 | Aliphatic polyisocyanate (HDI trimer) |
| Desmodur ® N 3368 BA/SN | Aliphatic polyisocyanate (HDI trimer) |
| Desmodur ® N 3368 SN | Aliphatic polyisocyanate (HDI trimer) |
| Desmodur ® N 3386 BA/SN | Aliphatic polyisocyanate (HDI trimer) |
| Desmodur ® N 3390 BA | Aliphatic polyisocyanate (HDI trimer) |
| Desmodur ® N 3390 BA/SN | Aliphatic polyisocyanate (HDI trimer) |
| Desmodur ® N 3400 | Aliphatic polyisocyanate (HDI uretdione) |
| Desmodur ® N 3600 | Aliphatic polyisocyanate (low-viscosity HDI trimer) |
| Desmodur ® N 3790 BA | Aliphatic polyisocyanate (high functional HDI trimer) |
| Desmodur ® N 3800 | Aliphatic polyisocyanate (flexibilizing HDI trimer) |
| Desmodur ® N 3900 | Low-viscosity, aliphatic polyisocyanate resin based on |
| | hexamethylene diisocyanate |
| Desmodur ® N 50 BA/MPA | Aliphatic polyisocyanate (HDI biuret) |
| Desmodur ® N 75 BA | Aliphatic polyisocyanate (HDI biuret) |
| Desmodur ® N 75 MPA | Aliphatic polyisocyanate (HDI biuret) |
| Desmodur ® N 75 MPA/X | Aliphatic polyisocyanate (HDI biuret) |
| Desmodur ® NZ 1 | Aliphatic polyisocyanate |
| Desmodur ® PC-N | Desmodur PC-N is a modified diphenyl-methane-4,4′- |
| | diisocyanate (MDI). |
| Desmodur ® PF | Desmodur PF is a modified diphenyl-methane-4,4′- |
| | diisocyanate (MDI). |
| Desmodur ® PL 340, 60% BA/SN | Blocked aliphatic polyisocyanate based on IPDI |
| Desmodur ® PL 350 | Blocked aliphatic polyisocyanate based on HDI |
| Desmodur ® RC | Solution of a polyisocyanurate of toluene diisocyanate (TDI) |
| | in ethyl acetate. |
| Desmodur ® RE | Solution of triphenylmethane-4,4′,4″-triisocyanate in ethyl |
| | acetate |
| Desmodur ® RFE | Solution of tris(p-isocyanatophenyl) thiophosphate in ethyl |
| | acetate |
| Desmodur ® RN | Solution of a polyisocyanurate with aliphatic and aromatic |
| | NCO groups in ethyl acetate. |
| Desmodur ® T 100 | Pure 2,4′-toluene diisocyanate (TDI) |
| Desmodur ® T 65 N | 2,4- and 2,6-toluene diisocyanate (TDI) in the ratio 67:33 |
| Desmodur ® T 80 | 2,4- and 2,6-toluene diisocyanate (TDI) in the ratio 80:20 |
| Desmodur ® T 80 P | 2,4- and 2,6-toluene diisocyanate (TDI) in the ratio 80:20 |
| | with an increased content of hydrolysable chlorine |
| Desmodur ® VH 20 N | Polyisocyanate based on diphenylmethane diisocyanate |
| Desmodur ® VK | Desmodur VK products re mixtures of diphenylmethane-4,4′- |
| | diisocyanate (MDI) with isomers and higher functional |
| Desmodur ® VKP 79 | Desmodur VKP 79 is a modified diphenylmethane-4,4′- |
| | diisocyanate (MDI) with isomers and homologues. |
| Desmodur ® VKS 10 | Desmodur VKS 10 is a mixture of diphenylmethane-4,4′- |
| | diisocyanate (MDI) with isomers and higher functional |
| Desmodur ® VKS 20 | Desmodur VKS 20 is a mixture of diphenylmethane-4,4′- |
| | diisocyanate (MDI) with isomers and higher functional |
| Desmodur ® VKS 20 F | Desmodur VKS 20 F is a mixture of diphenylmethane-4,4′- |
| | diisocyanate (MDI) with isomers and higher functional |
| Desmodur ® VKS 70 | Desmodur VKS 70 is a mixture of diphenylmethane-4,4′- |
| | diisocyanate (MDI) with isomers and homologues. |
| Desmodur ® VL | Aromatic polyisocyanate based on diphenylmethane |
| | diisocyanate |
| Desmodur ® VP LS 2078/2 | Blocked aliphatic polyisocyanate based on IPDI |
| Desmodur ® VP LS 2086 | Aromatic polyisocyanate prepolymer based on |
| | diphenylmethane diisocyanate |
| Desmodur ® VP LS 2257 | Blocked aliphatic polyisocyanate based on HDI |
| Desmodur ® VP LS 2371 | Aliphatic polyisocyanate prepolymer based on isophorone |
| | diisocyanate. |
| Desmodur ® VP LS 2397 | Desmodur VP LS 2397 is a linear prepolymer based on |
| | polypropylene ether glycol and diphenylmethane |
| Desmodur ® W | Monomeric cycloaliphatic diisocyanate |
| Desmodur ® W/1 | Monomeric cycloaliphatic diisocyanate |
| Desmodur ® XP 2404 | Desmodur XP 2404 is a mixture of monomeric |
| | polyisocyanates |
| Desmodur ® XP 2406 | Aliphatic polyisocyanate prepolymer based on isophorone |
| | diisocyanate |
| Desmodur ® XP 2489 | Aliphatic polyisocyanate |
| Desmodur ® XP 2505 | Desmodur XP 2505 is a prepolymer containing ether groups |
| | based on diphenylmethane-4,4 ′-diisocyanates (MDI) with |
| Desmodur ® XP 2551 | Aromatic polyisocyanate based on diphenylmethane |
| | diisocyanate |
| Desmodur ® XP 2565 | Low-viscosity, aliphatic polyisocyanate resin based on |
| | isophorone diisocyanate. |
| Desmodur ® XP 2580 | Aliphatic polyisocyanate based on hexamethylene |
| | diisocyanate |
| Desmodur ® XP 2599 | Aliphatic prepolymer containing ether groups and based on |
| | hexamethylene-1,6-diisocyanate (HDI) |
| Desmodur ® XP 2617 | Desmodur XP 2617 is a largely linear NCO prepolymer based |
| | on hexamethylene diisocyanate. |
| Desmodur ® XP 2665 | Aromatic polyisocyanate prepolymer based on |
| | diphenylmethane diisocyanate (MDI). |
| Desmodur ® XP 2675 | Aliphatic polyisocyanate (highly functional HDI trimer) |
| Desmodur ® XP 2679 | Aliphatic polyisocyanate (HDI allophanate trimer) |
| Desmodur ® XP 2714 | Silane-functional aliphatic polyisocyanate based on |
| | hexamethylene diisocyanate |
| Desmodur ® XP 2730 | Low-viscosity, aliphatic polyisocyanate (HDI uretdione) |
| Desmodur ® XP 2731 | Aliphatic polyisocyanate (HDI allophanate trimer) |
| Desmodur ® XP 2742 | Modified aliphatic Polyisocyanate (HDI-Trimer), contains |
| | SiO2 -nanoparticles |

Additional isocyanates suitable for certain embodiments of the present invention are sold under the trade name Tolonate® (Perstorp). In certain embodiments, the isocyanates are selected from the group consisting of the materials shown in Table 3, and typically from the subset of this list that are between 1.95 and 2.1 functional isocyanates:

TABLE 3

| | |
|---|---|
| Tolonate ™ D2 | a blocked aliphatic polyisocyanate, supplied at |
| | 75% solids in aromatic solvent |
| Tolonate ™ HDB | a viscous solvent-free aliphatic polyisocyanate |
| Tolonate ™ HDB-LV | a solvent free low viscosity aliphatic |
| | polyisocyanate |
| Tolonate ™ HDB 75 B | an aliphatic polyisocyanate, supplied at 75% |
| | solids in methoxy propyl acetate |
| Tolonate ™ HDB 75 BX | an aliphatic polyisocyanate, supplied at 75% |
| | solids |
| Tolonate ™ HDT | a medium viscosity, solvent-free aliphatic |
| | polyisocyanate |
| Tolonate ™ HDT-LV | is a solvent free low viscosity aliphatic |
| | polyisocyanate |
| Tolonate ™ HDT-LV2 | a solvent free, very low viscosity aliphatic |
| | polyisocyanate |
| Tolonate ™ HDT 90 | an aliphatic polyisocyanate, based on HDI- |
| | trimer (isocyanurate), supplied at 90% solids |
| Tolonate ™ HDT 90 B | an aliphatic polyisocyanate, based on HDI- |
| | trimer (isocyanurate), supplied at 90% solids |
| Tolonate ™ IDT 70 B | an aliphatic polyisocyanate, based on HDI- |
| | trimer (isocyanurate), supplied at 70% solids |
| Tolonate ™ IDT 70 S | an aliphatic polyisocyanate, based on HDI- |
| | trimer (isocyanurate), supplied at 70% solids |
| Tolonate ™ X FD 90 B | a high functionality, fast drying aliphatic |
| | polyisocyanate based on HDI-trimer, supplied |
| | at 90% solids |

Other isocyanates suitable for certain embodiments of the present invention are sold under the trade name Mondur® available from Bayer Material Science. In certain embodiments, the isocyanates are selected from the group consisting of the materials shown in Table 4, and typically from the subset of this list that are between 1.95 and 2.1 functional isocyanates:

TABLE 4

| Trade Name | Description |
|---|---|
| MONDUR 445 | TDI/MDI blend polyisocyanate; blend of toluene diisocyanate and polymeric |
| | diphenylmethane diisocyanate; NCO weight 44.5-45.2% |
| MONDUR 448 | modified polymeric diphenylmethane diisocyanate (pMDI) prepolymer; NCO weight |
| | 27.7%; viscosity 140 mPa · s @ 25° C.; equivalent weight 152; functionality 2.2 |
| MONDUR 489 | modified polymeric diphenylmethane diisocyanate (pMDI); NCO weight 31.5%; viscosity |
| | 700 mPa · s @ 25° C.; equivalent weight 133; functionality 3.0 |
| MONDUR 501 | modified monomeric diphenylmethane diisocyanate (mMDI); isocyanate-terminated |
| | polyester prepolymer; NCO weight 19.0%; viscosity 1,100 mPa · s @ 25° C.; equivalent |
| | weight 221; functionality 2 |
| MONDUR 541 | polymeric diphenylmethane diisocyanate (pMDI); binder for composite wood products |
| | and as a raw material in adhesive formulations; NCO weight 31.5%; viscosity 200 mPa · s @ |
| | 25° C. |
| MONDUR 582 | polymeric diphenylmethane diisocyanate (pMDI); binder for composite wood products |
| | and as a raw material in adhesive formulations; NCO weight 31.0%; viscosity 200 mPa · s @ |
| | 25° C. |
| MONDUR 541-Light | polymeric diphenylmethane diisocyanate (pMDI); NCO weight 32.0%; viscosity 70 mPa · s @ |
| | 25° C.; equivalent weight 131; functionality 2.5 |
| MONDUR 841 | modified polymeric MDI prepolymer; NCO, Wt 30.5%; Acidity, Wt 0.02%; Amine |
| | Equivalent 132; Viscosity at 25° C., mPa · s 350; Specific gravity at 25° C. 1.24; Flash Point, |
| | PMCC, ° F. >200 |
| MONDUR 1437 | modified diphenylmethane diisocyanate (mMDI); isocyanate-terminated polyether |
| | prepolymer; NCO weight 10.0%; viscosity 2,500 mPa · s @ 25° C.; equivalent weight 420; |
| | functionality 2 |
| MONDUR 1453 | modified diphenylmethane diisocyanate (mMDI); isocyanate-terminated polyether |
| | prepolymer based on polypropylene ether glycol (PPG); NCO weight 16.5%; viscosity 600 |
| | mPa · s @ 25° C.; equivalent weight 254; functionality 2 |
| MONDUR 1515 | modified polymeric diphenylmethane diisocyanate (pMDI) prepolymer; used in the |
| | production of rigid polyurethane foams, especially for the appliance industry; NCO weight |
| | 30.5%; viscosity 350 mPa · s @ 25° C. |
| MONDUR 1522 | modified monomeric 4,4-diphenylmethane diisocyanate (mMDI); NCO weight 29.5%; |
| | viscosity 50 mPa · s @ 25° C.; equivalent weight 143; functionality 2.2 |
| MONDUR MA-2300 | modified monomeric MDI, allophanate-modified 4,4′-diphenylmethane diisocyanate |
| | (mMDI); NCO weight 23.0%; viscosity 450 mPa · s @ 25° C.; equivalent weight 183; |
| | functionality 2.0 |
| MONDUR MA 2600 | modified monomeric MDI, allophanate-modified 4,4′-diphenylmethane diisocyanate |
| | (mMDI); NCO weight 26.0%; viscosity 100 mPa · s @ 25° C.; equivalent weight 162; |
| | functionality 2.0 |
| MONDUR MA 2601 | aromatic diisocyanate blend, allophanate-modified 4,4′-diphenylmethane diisocyanate |
| | (MDI) blended with polymeric diphenylmethane diisocyanate (pMDI) containing 2,4′- |
| | isomer; NCO weight 29.0%; viscosity 60 mPa · s @ 25° C.; equivalent weight 145; |
| | functionality 2.2 |
| MONDUR MA 2603 | MDI prepolymer; isocyanate-terminated (MDI) prepolymer blended with an allophanate- |
| | modified 4,4′-diphenylmethane diisocyanate (MDI); NCO weight 16.0%; viscosity 1,050 |
| | mPa · s @ 25° C.; equivalent weight 263; functionality 2.0 |
| MONDUR MA-2902 | modified monomeric MDI, allophanate-modified 4,4′-diphenylmethane diisocyanate |
| | (mMDI); NCO weight 29.0%; viscosity 40 mPa · s @ 25° C.; equivalent weight 145; |
| | functionality 2.0 |
| MONDUR MA-2903 | modified monomeric MDI; isocyanate-terminated (MDI) prepolymer; NCO weight 19.0%; |
| | viscosity 400 mPa · s @ 25° C.; equivalent weight 221; functionality 2.0 |
| MONDUR MA-2904 | Allophanate-modified MDI polyether prepolymer; NCO weight 12.0%; viscosity 1,800 mPa- · |
| | s @ 25° C.; equivalent weight 350; functionality of 2.0 |
| MONDUR MB | high-purity grade difunctional isocyanante, diphenylmethane 4,4′-diiscocyanate; used in |
| | production of polyurethane elastomers, adhesives, coatings and intermediate |
| | polyurethane products; appearance colorless solid or liquid; specific gravity @ 50° C. ± 15.5 |
| | 1.19; flash point 202° C. PMCC; viscosity (in molten form) 4.1 mPa · s; bult density 10 lb/gal |
| | (fused) or 9.93 lb/gal (molten); freezing temperature 39° C. |
| MONDUR MLQ | monomeric diphenylmethan diisocyanate; used in a foams, cast elastomers, coatings and |
| | ahdesives; appearance light yellow clear liquid, NCO 33.4% wt; 1.19 specific gravity at |
| | 25° C., 196° C. flash point, DIN 51758; 11-15° C. freezing temperature |
| MONDUR MQ | high-purity-grade difunctional isocyanate, diphenylmethane 4,4′-diisocyanate (MDI); used |
| | in production of solid polyurethane elastomers, adhesives, coatings and in intermediate |
| | polyurethane products; appearance colorless solid or liquid; specific gravity 1.19 @ 50° C.; |
| | flash point 202° C. PMCC; viscosity 4.1 mPa · s; bulk density 10 lb./gal (fused) or 9.93 lb./gal |
| | (molten); freezing temperature 39° C. |
| MONDUR MR | polymeric diphenylmethane diisocyanate (pMDI); NCO weight 31.5%; viscosity 200 mPa · s |
| | @ 25° C.; equivalent weight 133; functionality 2.8 |
| MONDUR MR LIGHT | polymeric diphenylmethane diisocyanate (pMDI); NCO weight 31.5%; viscosity 200 mPa · s |
| | @ 25° C.; equivalent weight 133; functionality 2.8 |
| MONDUR MR-5 | polymeric diphenylmethane diisocyanate (pMDI); NCO weight 32.5%; viscosity 50 mPa · s @ |
| | 25° C.; equivalent weight 129; functionality 2.4 |
| MONDUR MRS | 2,4′ rich polymeric diphenylmethane diisocyanate (pMDI); NCO weight 31.5%; viscosity |
| | 200 mPa · s @ 25° C.; equivalent weight 133; functionality2.6 |
| MONDUR MRS 2 | 2,4′ rich polymeric diphenylmethane diisocyanate (pMDI); NCO weight 33.0%; viscosity 25 |
| | mPa · s @ 25° C.; equivalent weight 127; functionality2.2 |
| MONDUR MRS-4 | 2,4′ rich polymeric diphenylmethane diisocyanate (pMDI); NCO weight 32.5%; viscosity 40 |
| | mPa · s @ 25° C.; equivalent weight 129; functionality 2.4 |
| MONDUR MRS-5 | 2,4′ rich polymeric diphenylmethane diisocyanate (pMDI); NCO weight 32.3%; viscosity 55 |
| | mPa · s @ 25° C.; equivalent weight 130; functionality 2.4 |
| MONDUR PC | modified 4,4′ diphenylmethane diisocyanate (mMDI); NCO weight 25.8%; viscosity 145 |
| | mPa · s @ 25° C.; equivalent weight 163; functionality 2.1 |
| MONDUR PF | modified 4,4′ diphenylmethane diisocyanate (mMDI) prepolymer; NCO weight 22.9%; |
| | viscosity 650 mPa · s @ 25° C.; equivalent weight 183; functionality 2 |
| MONDUR TD-65 | monomeric toluene diisocyanate (TDI); 65/35 mixture of 2,4 and 2.6 TDI; NCO weight 48%; |
| | viscosity 3 mPa · s @ 25° C.; equivalent weight 87.5; functionality 2 |
| MONDUR TD-80 | monomeric toluene diisocyanate (TDI); 80/20 mixture of the 2,4 and 2,6 isomer; NCO |
| GRADE A | weight 48%; viscosity 5 mPa · s @ 25° C.; equivalent weight 87.5; functionality 2 |
| MONDUR TD-80 | monomeric toluene diisocyanate (TDI); 80/20 mixture of the 2,4 and 2,6 isomer; NCO |
| GRADE A/GRADE B | weight 48%; viscosity 5 mPa · s @ 25° C.; equivalent weight 87.5; functionality 2 |

In certain embodiments, one or more of the above-described isocyanate compositions is provided in a formulation typical of a mixture known in the art of polyurethane manufacture. Such mixtures may comprise prepolymers formed by the reaction of a molar excess of one or more isocyanates with reactive molecules comprising reactive functional groups such as alcohols, amines, thiols, carboxylates and the like. These mixtures may also comprise solvents, surfactants, stabilizers, and other additives known in the art.

### APPENDIX III

### Coreactants

In addition to the aliphatic polycarbonate polyols and isocyanate reagents described above, some compositions of the present invention may comprise optional coreactants. Coreactants can include other types of polyols (e.g. polyether polyols, polyester polyols, acrylics, or other classes of polycarbonate polyols), or small molecules with functional groups reactive toward isocyanates such as hydroxyl groups, amino groups, thiol groups, and the like. In certain embodiments, such coreactants comprise molecules with two or more functional groups reactive toward isocyanates.

In certain embodiments, a coreactant comprises a polyhydric alcohol. In certain embodiments, a coreactant comprises a dihydric alcohol. In certain embodiments, the dihydric alcohol comprises a C₂₋₄₀ diol. In certain embodiments, the dihydric alcohol is selected from the group consisting of: 1,2-ethanediol, 1,2-propanediol, 1,3-propanediol, 1,2-butanediol, 1,3-butanediol, 1,4-butanediol, 1,5-pentanediol, 2,2-dimethylpropane-1,3-diol, 2-butyl-2-ethylpropane-1,3-diol, 2-methyl-2,4-pentane diol, 2-ethyl-1,3-hexane diol, 2-methyl-1,3-propane diol, 1,5-hexanediol, 1,6-hexanediol, 1,8-octanediol, 1,10-decanediol, 1,12-dodecanediol, 2,2,4,4-tetramethylcyclobutane-1,3-diol, 1,3-cyclopentanediol, 1,2-cyclohexanediol, 1,3-cyclohexanediol, 1,4-cyclohexanediol, 1,2-cyclohexanedimethanol, 1,3-cyclohexanedimethanol, 1,4-cyclohexanedimethanol, 1,4-cyclohexanediethanol, isosorbide, glycerol monoesters, glycerol monoethers, trimethylolpropane monoesters, trimethylolpropane monoethers, pentaerythritol diesters, pentaerythritol diethers, and alkoxylated derivatives of any of these.

In certain embodiments, a coreactant comprises a dihydric alcohol selected from the group consisting of: diethylene glycol, triethylene glycol, tetraethylene glycol, higher poly(ethylene glycol), such as those having number average molecular weights of from 220 to about 2000 g/mol, dipropylene glycol, tripropylene glycol, and higher poly(propylene glycols) such as those having number average molecular weights of from 234 to about 2000 g/mol.

In certain embodiments, a coreactant comprises an alkoxylated derivative of a compound selected from the group consisting of: a diacid, a diol, or a hydroxy acid. In certain embodiments, the alkoxylated derivatives comprise ethoxylated or propoxylated compounds.

In certain embodiments, a coreactant comprises a polymeric diol. In certain embodiments, a polymeric diol is selected from the group consisting of polyethers, polyesters, hydroxy-terminated polyolefins, polyether-copolyesters, polyether polycarbonates, polycarbonate-copolyesters, and alkoxylated analogs of any of these. In certain embodiments, the polymeric diol has an average molecular weight less than about 2000 g/mol

In some embodiments, a coreactant comprises a triol or higher polyhydric alcohol. In certain embodiments, a coreactant is selected from the group consisting of: glycerol, 1,2,4-butanetriol, 2-(hydroxymethyl)-1,3-propanediol; hexane triols, trimethylol propane, trimethylol ethane, trimethylolhexane, 1,4-cyclohexanetrimethanol, pentaerythritol mono esters, pentaerythritol mono ethers, and alkoxylated analogs of any of these. In certain embodiments, alkoxylated derivatives comprise ethoxylated or propoxylated compounds.

In some embodiments, a coreactant comprises a polyhydric alcohol with four to six hydroxy groups. In certain embodiments, a coreactant comprises dipentaerithrotol or an alkoxylated analog thereof. In certain embodiments, coreactant comprises sorbitol or an alkoxylated analog thereof.

In certain embodiments, a functional coreactant comprises a polyhydric alcohol containing one or more moieties that can be converted to an ionic functional group. In certain embodiments, the moiety that can be converted to an ionic functional group is selected from the group consisting of: carboxylic acids, esters, anhydrides, sulfonic acids, sulfamic acids, phosphates, and amino groups.

In certain embodiments, a coreactant comprises a hydroxy-carboxylic acid having the general formula (HO)ₓΩ(COOH)_{y}, wherein Q is a straight or branched hydrocarbon radical containing 1 to 12 carbon atoms, and x and y are each integers from 1 to 3. In certain embodiments, a coreactant comprises a diol carboxylic acid. In certain embodiments, a coreactant comprises a bis(hydroxylalkyl)alkanoic acid. In certain embodiments, a coreactant comprises a bis(hydroxylmethyl)alkanoic acid. In certain embodiments the diol carboxylic acid is selected from the group consisting of 2,2 bis-(hydroxymethyl)-propanoic acid (dimethylolpropionic acid, DMPA) 2,2-bis(hydroxymethyl) butanoic acid (dimethylolbutanoic acid; DMBA), dihydroxysuccinic acid (tartaric acid), and 4,4′-bis(hydroxyphenyl) valeric acid. In certain embodiments, a coreactant comprises an N,N-bis(2-hydroxyalkyl)carboxylic acid.

In certain embodiments, a coreactant comprises a polyhydric alcohol containing a sulfonic acid functional group. In certain embodiments, a coreactant comprises a diol sulfonic acid. In certain embodiments, a polyhydric alcohol containing a sulfonic acid is selected from the group consisting of: 2-hydroxymethyl-3-hydroxypropane sulfonic acid, 2-butene-1,4-diol-2-sulfonic acid, and materials disclosed in U.S. Pat. No. 4,108,814 and US Pat. App. Pub. No. 2010/0273029 the entirety of each of which is incorporated herein by reference.

In certain embodiments, a coreactant comprises a polyhydric alcohol containing a sulfamic acid functional group. In certain embodiments, a polyhydric alcohol containing a sulfamic acid is selected from the group consisting of: [N,N-bis(2-hydroxyalkyl)sulfamic acid (where each alkyl group is independently a C₂₋₆ straight chain, branched or cyclic aliphatic group) or epoxide adducts thereof (the epoxide being ethylene oxide or propylene oxide for instance, the number of moles of epoxide added being 1 to 6) also epoxide adducts of sulfopolycarboxylic acids [e.g. sulfoisophthalic acid, sulfosuccinic acid, etc.], and aminosulfonic acids [e.g. 2-aminoethanesulfonic acid, 3-aminopropanesulfonic acid, etc.].

In certain embodiments, a coreactant comprises a polyhydric alcohol containing a phosphate group. In certain embodiments, a coreactant comprises a bis(2-hydroxalkyl) phosphate (where each alkyl group is independently a C₂₋₆ straight chain, branched or cyclic aliphatic group). In certain embodiments, a coreactant comprises bis(2-hydroxethyl) phosphate.

In certain embodiments, a coreactant comprises a polyhydric alcohol comprising one or more amino groups. In certain embodiments, a coreactant comprises an amino diol. In certain embodiments, a coreactant comprises a diol containing a tertiary amino group. In certain embodiments, an amino diol is selected from the group consisting of: diethanolamine (DEA), N-methyldiethanolamine (MDEA), N-ethyldiethanolamine (EDEA), N-butyldiethanolamine (BDEA), N,N-bis(hydroxyethyl)-α-amino pyridine, dipropanolamine, diisopropanolamine (DIPA), N-methyldiisopropanolamine, Diisopropanol-p-toluidine, N,N-Bis(hydroxyethyl)-3-chloroaniline, 3-diethylaminopropane-1,2-diol, 3-dimethylaminopropane-1,2-diol and N-hydroxyethylpiperidine. In certain embodiments, a coreactant comprises a diol containing a quaternary amino group. In certain embodiments, a coreactant comprising a quaternary amino group is an acid salt or quaternized derivative of any of the amino alcohols described above.

Compounds having at least one crosslinkable functional group can also be incorporated into the prepolymers of the present invention, if desired. Examples of such compounds include those having carbonyl, amine, epoxy, acetoacetoxy, urea-formaldehyde, auto-oxidative groups that crosslink via oxidization, ethylenically unsaturated groups optionally with U.V. activation, olefinic and hydrazide groups, blocked isocyanates, and the like, and mixtures of such groups and the same groups in protected forms (so crosslinking can be delayed until the composition is in its application (e.g., applied to a substrate) and coalescence of the particles has occurred) which can be reversed back into original groups from which they were derived (for crosslinking at the desired time).

1. A siloxy-terminated prepolymer comprising a plurality of segments derived from one or more polyols, wherein at least a portion of the polyol segments comprise an epoxide-CO₂ copolymer.

2-6. (canceled)

7. The siloxy-terminated prepolymer of claim 1, wherein the siloxy terminal groups on the prepolymer comprise: 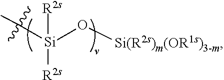
where each R^{1s} is independently H, optionally substituted C₁₋₆ aliphatic, or optionally substituted phenyl;
each R^{2s} is independently a C₁₋₆ aliphatic group,
m is 0, 1, or 2, and
v is 0 or an integer from 1 to about 20.

8. The siloxy-terminated prepolymer of claim 1, wherein the siloxy terminal groups on the prepolymer comprise: 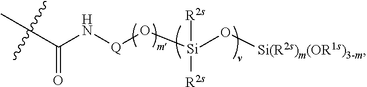
wherein
m′ is 0 or 1; and
Q is an optionally substituted bifunctional C₁₋₂₀ aliphatic or heteroaliphatic group.

9. The siloxy-terminated prepolymer of claim 8, wherein the siloxy terminal groups on the prepolymer comprise:

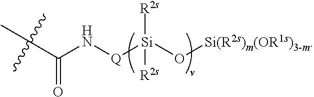

10. The siloxy-terminated prepolymer of claim 9, wherein the siloxy terminal groups on the prepolymer comprise:

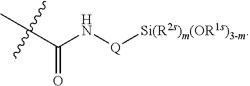

11. The siloxy-terminated prepolymer of claim 10, wherein the siloxy terminal groups on the prepolymer comprise: 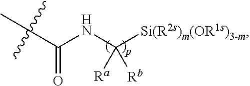
wherein,
each R^{a} and R^{b} are independently selected from the group consisting of: —H, halogen, optionally substituted C₁₋₈ aliphatic, optionally substituted C₁₋₈ heteroaliphatic, where two or more R^{a} and/or R^{b} groups (whether on the same or different carbon atoms) may be taken together with intervening atoms to form one or more optionally substituted, optionally unsaturated rings, optionally containing one or more heteroatoms, and where two R^{a} and R^{b} groups on the same carbon atom or on adjacent carbon atoms may optionally be taken together to form an alkene or, if on the same carbon atom, a ketone, and
p is an integer from 2 to 20.

12. The siloxy-terminated prepolymer of claim 11, wherein the siloxy terminal groups on the prepolymer comprise:

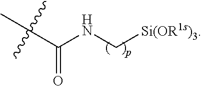

13. The siloxy-terminated prepolymer of claim 12, wherein the siloxy terminal groups on the prepolymer are selected from the group consisting of:

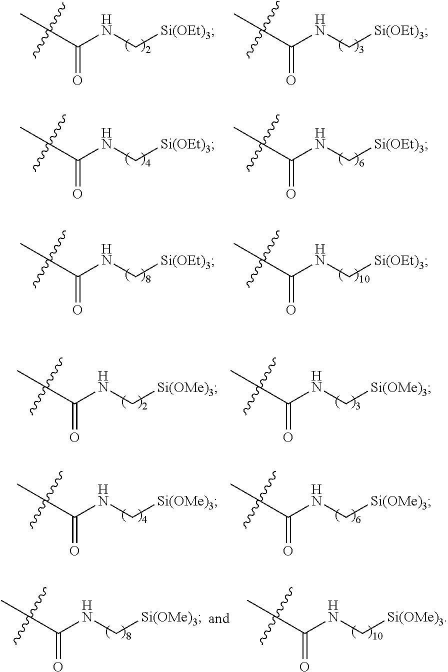

14. The siloxy-terminated prepolymer of claim 10, wherein the siloxy terminal groups on the prepolymer are selected from the group consisting of:

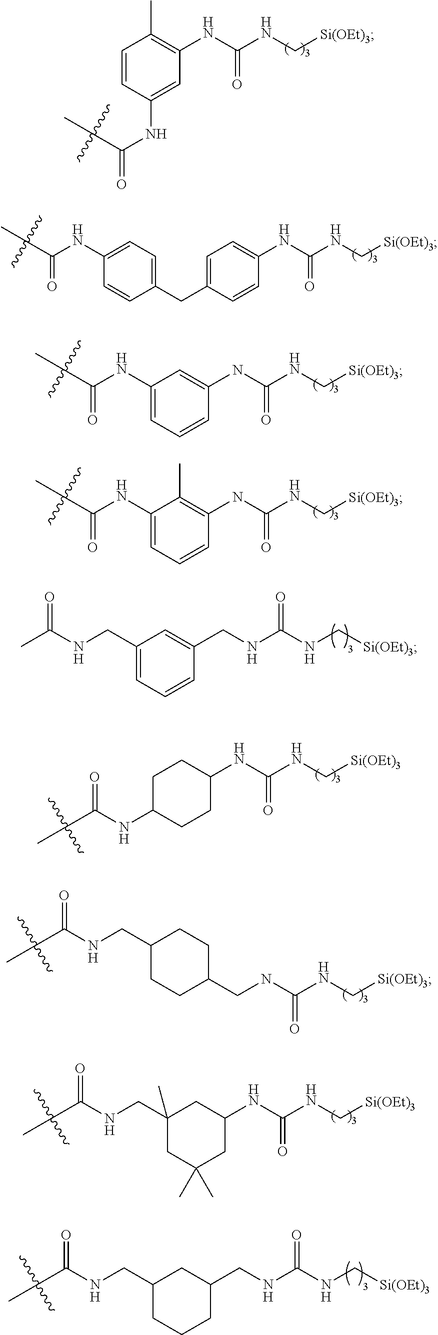

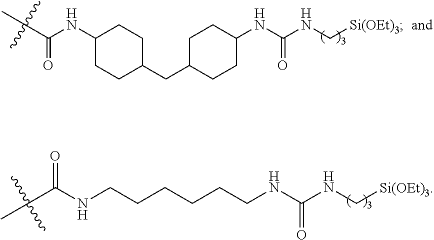

15. The siloxy-terminated prepolymer of claim 10, wherein the siloxy terminal groups on the prepolymer are selected from the group consisting of:

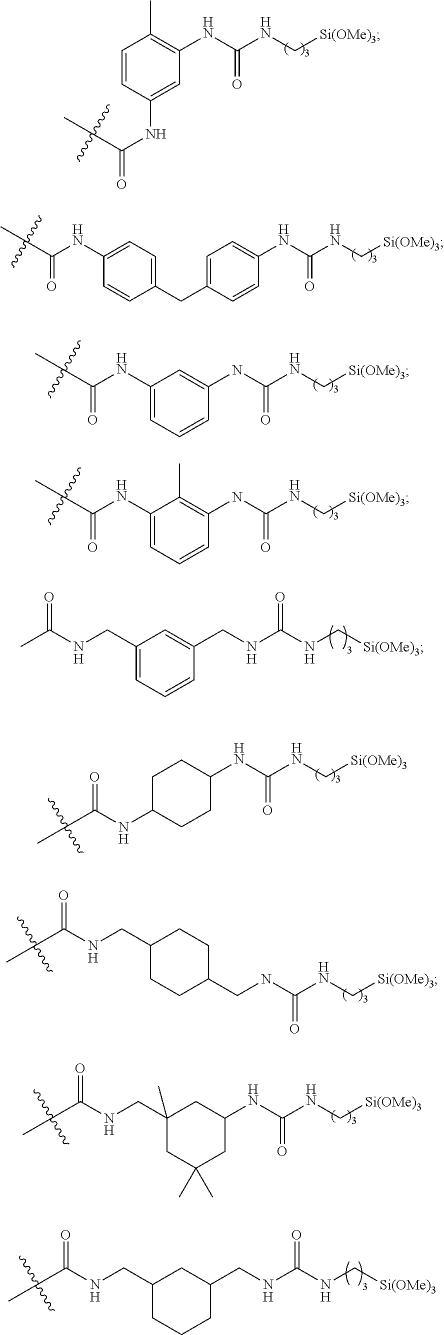

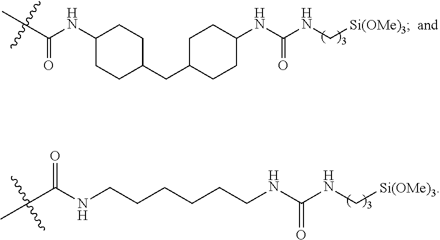

16. The siloxy-terminated prepolymer of claim 1, comprising: 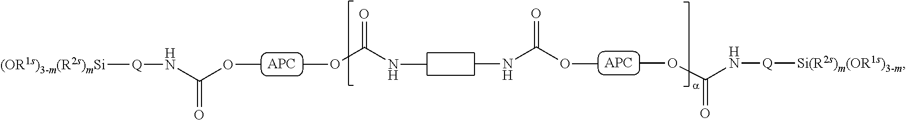
wherein R^{1s} is independently at each occurrence selected from the group consisting of: —H, C₁₋₆ aliphatic, and optionally substituted phenyl;
R^{2s} is, at each occurrence, a C₁₋₆ aliphatic group and each R^{2s} may be the same or different;
Q, is a difunctional organic group; and
m is 0, 1, or 2;
α is an integer from 1 to aboout 50;
each 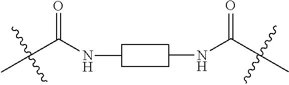
moiety is derived from a corresponding aliphatic, or aromatic diisocyanate 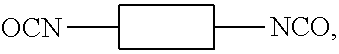
where [symbol] represents the carbon-containing skeleton of a difunctionalal isocyanate;
each 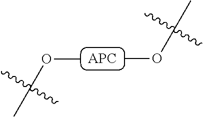
Moiety has a formula: 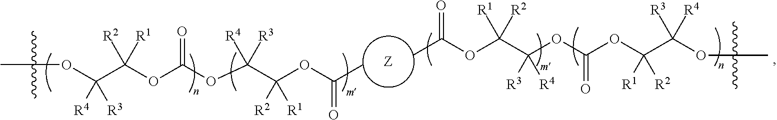
where m′ is independently at each occurrence either 0 or 1,
R¹, R², R³, and R⁴ are, at each occurrence in the polymer chain, independently selected from the group consisting of —H, fluorine, an optionally substituted C₁₋₃₀ aliphatic group, an optionally substituted C₁₋₂₀ heteroaliphatic group, and an optionally substituted C₆₋₁₀ aryl group, where any two or more of R¹, R², R³, and R⁴ may optionally be taken together with intervening atoms to form one or more optionally substituted rings optionally containing one or more heteroatoms;
n is, independently at each occurrence, an integer from about 2 to about 200; and [symbol]
is a bond or a multivalent moiety.

17. The siloxy-terminated prepolymer of claim 1, wherein the prepolymer has a a formula selected from the group consisting of: 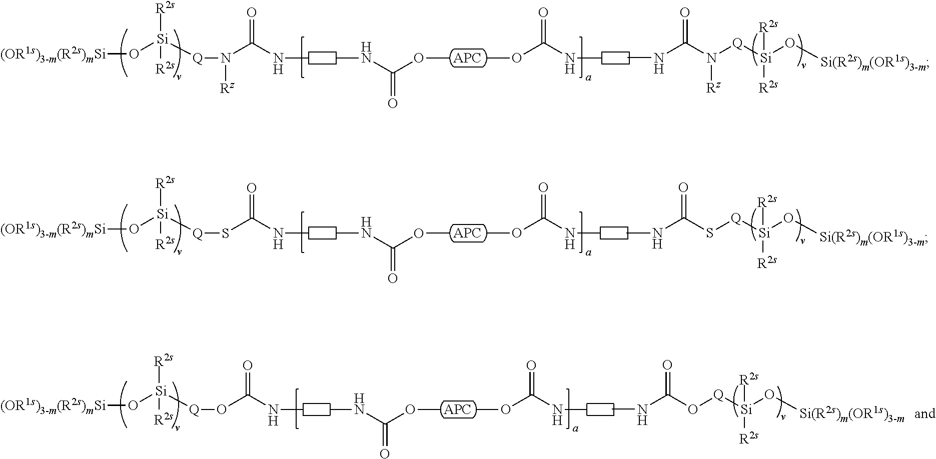
wherein R^{1s} is independently at each occurrence selected from the group consisting of: —H, C₁₆ aliphatic, and optionally substituted phenyl;
R^{2s} is, at each occurrence a C₁₋₆ aliphatic group and any two R^{2s} groups may be the same or different;
Q, is a difunctional organic group; and
m is 0, 1, or 2;
v is 0, or an integer from 1 to about 50;
α is an integer from 1 to about 50;
each 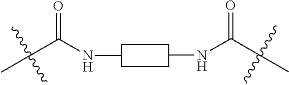
moiety is derived from a corresponding aliphatic, or aromatic isocyanate 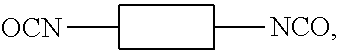
where [symbol] represents the carbon-containing skeleton of a difunctionalal isocyanate;
each 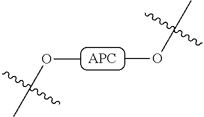
moiety has a formula: 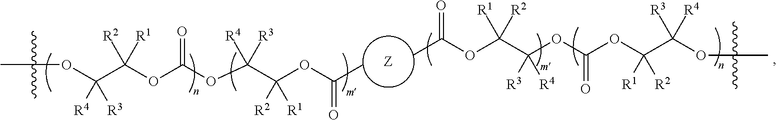
where m′ is independently at each occurrence either 0 or 1,
R¹, R², R³, and R⁴ are, at each occurrence in the polymer chain, independently selected from the group consisting of —H, fluorine, an optionally substituted C₁₋₃₀ aliphatic group, an optionally substituted C₁₋₂₀ heteroaliphatic group, and an optionally substituted C₆₋₁₀ aryl group, where any two or more of R¹, R², R³, and R⁴ may optionally be taken together with intervening atoms to form one or more optionally substituted rings optionally containing one or more heteroatoms;
n is, independently at each occurrence, an integer from about 2 to about 200; and [symbol]
is a bond or a multivalent moiety.

18. The siloxy-terminated prepolymer of claim 16, wherein [symbol] comprises the carbon skeleton of a molecule selected from the group consisting of: a polyhydric alcohol, a polyacid, a hydroxyacid, a phosphorous-containing functional group, and a mixture of any two or more of these.

19. The siloxy-terminated prepolymer of claim 18, wherein [symbol] comprises the carbon skeleton of a diol.

20. The siloxy-terminated prepolymer of claim 17, wherein each 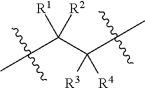
in the prepolymer is independently selected from the group consisting of: 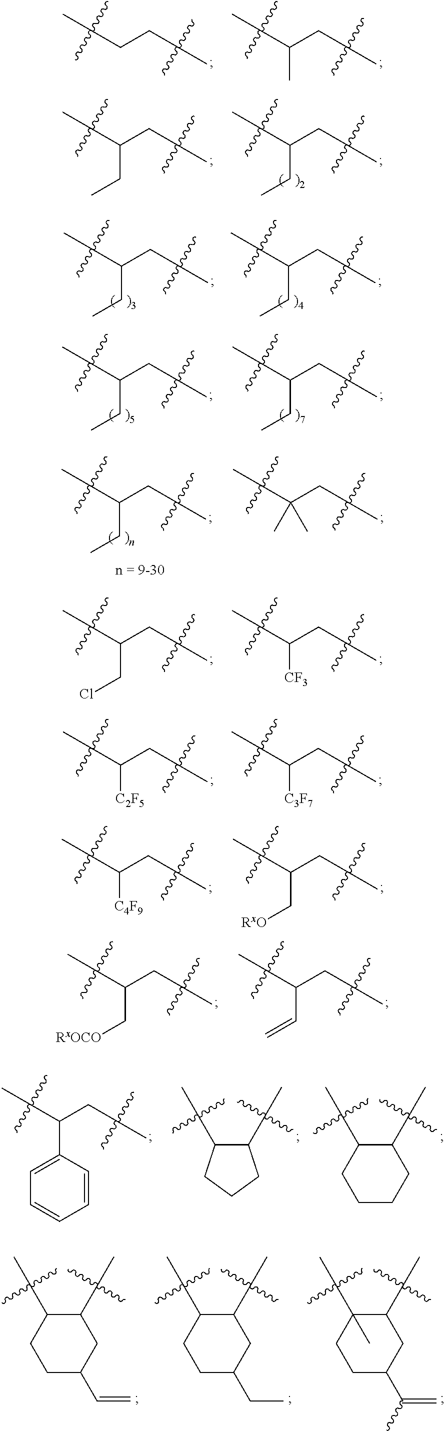 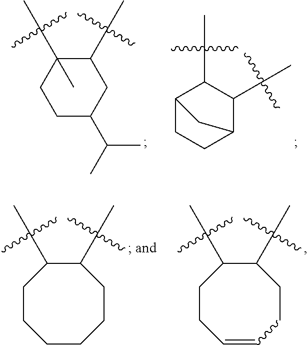
where each R^{x} is independently an optionally substituted group selected from the group consisting of C₂₋₂₀ aliphatic, C₂₋₂₀ heteroaliphatic, 3- to 14-membered carbocyclic, 6- to 10-membered aryl, 5- to 10-membered heteroaryl, and 3- to 12-membered heterocyclic.

21. (canceled)

22. The siloxy-terminated prepolymer of claim 1, comprising polyol segments of formula c12: 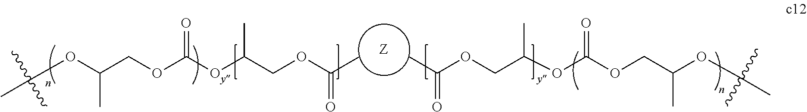
where each y″ is independently 0 or 1.

23. The siloxy-terminated prepolymer of claim 22, wherein the polyol segments of formula c12, are derived from poly(propylene carbonate)polyol having an average molecular weight number of between about 500 g/mol and about 3,000 g/mol.

24. The siloxy-terminated prepolymer of claim 22, wherein the polyol segments of formula c12, are derived from poly(propylene carbonate)polyol having a polydisperisty index less than about 1.25.

25. The siloxy-terminated prepolymer of claim 22, wherein the polyol segments of formula c12, are derived from poly(propylene carbonate)polyol having at least 95% carbonate linkages.

26. The siloxy-terminated prepolymer of claim 22, wherein the polyol segments of formula c12, are derived from poly(propylene carbonate)polyol having at least 98%—OH end groups.

27-29. (canceled)

30. The siloxy-terminated prepolymer of claim 1, comprising polyol segments of formula c13: 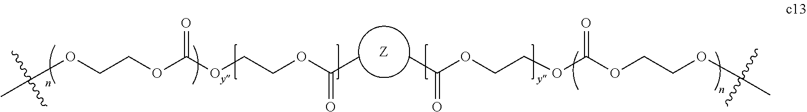
where each y″ is independently 0 or 1.

31. The siloxy-terminated prepolymer of claim 30, wherein the polyol segments of formula c13, are derived from poly(ethylene carbonate)polyol having an average molecular weight number of between about 500 g/mol and about 3,000 g/mol.

32. The siloxy-terminated prepolymer of claim 30, wherein the polyol segments of formula c13, are derived from poly(ethylene carbonate)polyol having a polydisperisty index less than about 1.25.

33. The siloxy-terminated prepolymer of claim 30, wherein the polyol segments of formula c13, are derived from poly(ethylene carbonate)polyol having at least 85% carbonate linkages.

34. The siloxy-terminated prepolymer of claim 30, wherein the polyol segments of formula c13, are derived from poly(ethylene carbonate)polyol having at least 98%—OH end groups.

35-37. (canceled)

38. The siloxy-terminated prepolymer of claim 16, wherein the [symbol] moieties represent the carbon skeleton of a commercially-available aliphatic diisocyanate.

39. The siloxy-terminated prepolymer of claim 38, wherein the aliphatic diisocyanate is selected from the group consisting of: HDI, IPDI, H₁₂MDI, H6-XDI, TMDI, 1,4-cyclohexyl diisocyanate, 1,4-tetramethylene diisocyanate, trimethylhexane diisocyanate, and mixtures of any two or more of these.

40-45. (canceled)

46. A composition of matter comprising a higher polymer formed by the reaction of a prepolymer composition of claim 16 with a chain extending reagent having a plurality of functional groups reactive toward siloxy groups.

47. (canceled)

48. (canceled)

49. A composition of matter comprising a higher polymer formed by the reaction of a prepolymer composition of claim 16 with a silanol condensation catalyst.

50. (canceled)

51. (canceled)

52. A method comprising the steps of:
a) providing one or more aliphatic polycarbonate polyols of formula P1, 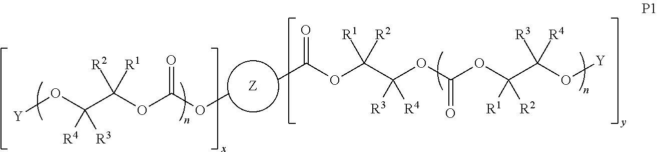
b) contacting the aliphatic polycarbonate polyol with one or more reagents having a plurality of isocyanate groups, optionally in the presence of one or more coreactants capable of reacting with isocyanate groups, where the coreactants are selected from any of those disclosed hereinabove, optionally in the presence of a catalyst;
c) allowing the polyol to react with the reagent having a plurality of isocyanate groups to form a prepolymer;
d) reacting the prepolymer from step (c) with a reagent comprising the combination of i) a functional group reactive toward the prepolymer chain ends and ii) a silicon-containing functional group,
wherein,
R¹, R², R³, and R⁴ are, at each occurrence in the polymer chain, independently selected from the group consisting of —H, fluorine, an optionally substituted C₁₋₃₀ aliphatic group, and an optionally substituted C₁₋₂₀ heteroaliphatic group, and an optionally substituted C₆₋₁₀ aryl group, where any two or more of R¹, R², R³, and R⁴ may optionally be taken together with intervening atoms to form one or more optionally substituted rings optionally containing one or more heteroatoms;
Y is —H;
n is an integer from about 3 to about 1,000; [symbol]
is a multivalent moiety; and
x and y are each independently an integer from 0 to 6, where the sum of x and y is between 2 and 6.

53. The method of claim 52, wherein the chain ends of the prepolymer formed in step (c) are —OH groups, and the functional group reactive toward the prepolymer chain ends used in step (d) comprises an isocyanate.

54. The method of claim 52, wherein the chain ends of the prepolymer formed in step (c) are isocyanate groups, and the functional group reactive toward the prepolymer chain ends used in step (d) comprises an amine.

55. (canceled)

56. The method of claim 52, wherein the aliphatic polycarbonate polyol provided in step (a) is selected from the group consisting of: P2, P3, P4, P5, P6, P7, P8 and mixtures of two or more of these.

57. The method of claim 52, wherein the aliphatic polycarbonate polyol provided in step (a) is selected from the group consisting of compounds P2a through P2r-a.

58. The method of claim 52, wherein the aliphatic polycarbonate polyol provided in step (a) is selected from the group consisting of: Q1, Q2, Q3, Q4, and mixtures of any of these.

59. The method of claim 52, wherein the aliphatic polycarbonate polyol provided in step (a) is selected from the group consisting of:
Poly(propylene carbonate) of formula Q1 having an average molecular weight number of between about 1,000 g/mol and about 3,000 g/mol, a polydisperisty index less than about 1.25, at least 95% carbonate linkages, and at least 98%—OH end groups;
Poly(propylene carbonate) of formula Q1 having an average molecular weight number of about 1,000 g/mol, a polydisperisty index less than about 1.25, at least 95% carbonate linkages, and at least 98%—OH end groups;
Poly(propylene carbonate) of formula Q1 having an average molecular weight number of about 2,000 g/mol, a polydisperisty index less than about 1.25, at least 95% carbonate linkages, and at least 98%—OH end groups;
Poly(propylene carbonate) of formula Q1 having an average molecular weight number of about 3,000 g/, a polydisperisty index less than about 1.25, at least 95% carbonate linkages, and at least 98%—OH end groups;
Poly(propylene carbonate) of formula Q2 having an average molecular weight number of between about 1,000 g/mol and about 3,000 g/mol, a polydisperisty index less than about 1.25, at least 95% carbonate linkages, and at least 98%—OH end groups;
Poly(propylene carbonate) of formula Q2 having an average molecular weight number of about 1,000 g/mol, a polydisperisty index less than about 1.25, at least 95% carbonate linkages, and at least 98%—OH end groups;
Poly(propylene carbonate) of formula Q2 having an average molecular weight number of about 2,000 g/mol, a polydisperisty index less than about 1.25, at least 95% carbonate linkages, and at least 98%—OH end groups;
Poly(propylene carbonate) of formula Q2 having an average molecular weight number of about 3,000 g/mol (e.g. n is on average between about 13 and about 15), a polydisperisty index less than about 1.25, at least 95% carbonate linkages, and at least 98%—OH end groups;
Poly(ethylene carbonate) of formula Q3 having an average molecular weight number of between about 1,000 g/mol and about 3,000 g/mol, a polydisperisty index less than about 1.25, at least 85% carbonate linkages, and at least 98%—OH end groups;
Poly(ethylene carbonate) of formula Q3 having an average molecular weight number of about 1,000 g/mol, a polydisperisty index less than about 1.25, at least 85% carbonate linkages, and at least 98%—OH end groups;
Poly(ethylene carbonate) of formula Q3 having an average molecular weight number of about 2,000 g/mol, a polydisperisty index less than about 1.25, at least 85% carbonate linkages, and at least 98%—OH end groups;
Poly(ethylene carbonate) of formula Q3 having an average molecular weight number of about 3,000 g/mol, a polydisperisty index less than about 1.25, at least 85% carbonate linkages, and at least 98%—OH end groups;
Poly(ethylene carbonate) of formula Q4 having an average molecular weight number of between about 1,000 g/mol and about 3,000 g/mol (e.g. each n is between about 4 and about 16), a polydisperisty index less than about 1.25, at least 95% carbonate linkages, and at least 98%—OH end groups;
Poly(ethylene carbonate) of formula Q4 having an average molecular weight number of about 1,000 g/mol, a polydisperisty index less than about 1.25, at least 85% carbonate linkages, and at least 98%—OH end groups;
Poly(ethylene carbonate) of formula Q4 having an average molecular weight number of about 2,000 g/mol, a polydisperisty index less than about 1.25, at least 85% carbonate linkages, and at least 98%—OH end groups; and
Poly(ethylene carbonate) of formula Q4 having an average molecular weight number of about 3,000 g/mol, a polydisperisty index less than about 1.25, at least 85% carbonate linkages, and at least 98%—OH end groups.

60. The method of claim 52, wherein the reagent having a plurality of isocyanate groups utilized in step (b) is selected from the group consisting of: aliphatic diisocyanates, aromatic diisocyanates, oligomeric diisocyanates, and difunctional isocyanate prepolymers.

61. The method of claim 52, wherein the reagent having a plurality of isocyanate groups utilized in step (b) comprises one or more diisocyanates selected from the group consisting of: HDI, IPDI, H₁₂MDI, H6-XDI, TMDI, 1,4-cyclohexyl diisocyanate, 1,4-tetramethylene diisocyanate, trimethylhexane diisocyanate, and mixtures of any two or more of these.

62. The method of claim 52, wherein the reagent having a plurality of isocyanate groups utilized in step (b) comprises one or more diisocyanates selected from the group consisting of: HDI, IPDI, H₁₂MDI and mixtures of two or more of these.

63-71. (canceled)

72. The method of claim 52, further comprising the step of providing one or more catalysts at step (b).

73. The method of claim 72, wherein the catalysts provided in step (b) comprise tin compounds.

74. The method of claim 72, wherein the catalysts provided in step (b) are selected from the group consisting of di-butyl tin dilaurate, dibutylbis(laurylthio)stannate, dibutyltinbis(isooctylmercapto acetate) and dibutyltinbis(isooctylmaleate), tin octanoate and mixtures of any of these.

75. The method of claim 52, further comprising the step of providing one or more coreactants in step (b).

76. The method of claim 75, wherein the coreactant provided is selected from the group consisting of: other types of polyols (e.g. polyether polyols, polyester polyols, acrylics, or other polycarbonate polyols), and small molecules with functional groups reactive toward isocyanates such as hydroxyl groups, amino groups, and thiol groups, the like.

77. The method of claim 75, wherein the coreactant provided is a dihydric alcohol.

78. The method of claim 77, wherein a provided dihydric alcohol is selected from the group consisting of diethylene glycol, triethylene glycol, tetraethylene glycol, higher poly(ethylene glycol), such as those having number average molecular weights of from 220 to about 2000 g/mol, dipropylene glycol, tripropylene glycol, and higher poly(propylene glycols) such as those having number average molecular weights of from 234 to about 2000 g/mol.

79-87. (canceled)
